(19) United States
(12) Patent Application Publication
(10) Pub. No.: US 2026/0129607 A1
(43) Pub. Date: May 7, 2026

(54) METHOD AND DEVICE FOR DATA TRANSMISSION AND ATOMIZATION APPARATUS

(71) Applicant: SHENZHEN GEEKVAPE TECHNOLOGY CO., LTD., Shenzhen (CN)

(72) Inventors: Hongxing DUAN, Shenzhen (CN); Gang LI, Shenzhen (CN); Mushan LI, Shenzhen (CN); Huaping LIAO, Shenzhen (CN); Jinjian XU, Shenzhen (CN); Linren GU, Shenzhen (CN); Lin ZHOU, Shenzhen (CN)

(73) Assignee: SHENZHEN GEEKVAPE TECHNOLOGY CO., LTD., Shenzhen (CN)

(21) Appl. No.: 19/378,868

(22) Filed: Nov. 4, 2025

(30) Foreign Application Priority Data
Nov. 5, 2024 (CN) 202422685989.6
Dec. 4, 2024 (CN) 202411784810.0
Apr. 8, 2025 (CN) 202510437750.3
Jun. 24, 2025 (CN) 202510855768.5
Jun. 24, 2025 (CN) 202510869140.0

(51) Int. Cl. H04W 64/00; H04W 52/02; H04W 76/10

(52) U.S. Cl. CPC H04W 64/00; H04W 52/0235; H04W 76/10

(57) ABSTRACT

The present application discloses a method and a device for data transmission, and an atomization apparatus; the method for data transmission is applied to a first control module in a first atomization apparatus, the first control module is connected to a first short-range wireless communication module, and the method for data transmission includes: detecting whether a second atomization apparatus exists within a preset distance range through the first short-range wireless communication module; and if the second atomization apparatus is existed within the preset distance range, performing data communication with the second atomization apparatus through the first short-range wireless communication module. By introducing the first short-range wireless communication module into the atomization apparatus, non-contact data transmission between apparatuses is achieved, and the problems of complex connection, vulnerable interface and unstable transmission existing in traditional wired communication methods are addressed.

### CROSS REFERENCE TO RELATED APPLICATIONS

The present application claims priorities of a Chinese application, with application No. 202510855768.5, filed on Jun. 24, 2025; a Chinese application, with application No. 202510869140.0, filed on Jun. 24, 2025; a Chinese application, with application No. 202510437750.3, filed on Apr. 8, 2025; a Chinese application, with application No. 202411784810.0, filed on Dec. 4, 2024; and a Chinese application, with application No. 202422685989.6, filed on Nov. 5, 2024; the contents of which are incorporated herein by reference.

### TECHNICAL FIELD

The present application relates to the technical field of atomization apparatuses, and more specifically to a method and a device for data transmission, and an atomization apparatus.

### BACKGROUND

At present, the development of atomization apparatus products in the direction of intelligence is accelerating. The functional linkage and data interaction among different apparatuses have gradually become one of the core demands of users. In the existing technology, data exchange between atomization apparatuses usually relies on wired connection methods, such as communication through UART serial ports. Although this method is simple to implement, it has many limitations, such as the need to lay physical connection cables, vulnerable interfaces, and inconvenient plugging and unplugging. At the same time, in practical applications, if the connection is poor or a circuit break occurs, it is easy to cause data transmission failure, affecting user experience and product stability.

### SUMMARY

The present application provides a method and a device for data transmission, and an atomization apparatus, so as to address above technical problems.

A first aspect of embodiments of the present application provides a method for data transmission, applied to a first control module in a first atomization apparatus, the first control module is connected to a first short-range wireless communication module, and the method for data transmission includes:
detecting whether a second atomization apparatus exists within a preset distance range through the first short-range wireless communication module; and
if the second atomization apparatus is existed within the preset distance range, performing data communication with the second atomization apparatus through the first short-range wireless communication module.

Optionally, the first control module includes a dormant state and an activated state, when the first control module is in the dormant state, after if the second atomization apparatus is existed within the preset distance range, the method further includes:
receiving a wake-up signal output by the first short-range wireless communication module and switching from the dormant state to the activated state.

Optionally, the first control module being in the dormant state includes:
the first control module entering the dormant state when the first control module does not receive data sent by the first short-range wireless communication module within a preset time period.

Optionally, the step of detecting whether the second atomization apparatus exists within the preset distance range through the first short-range wireless communication module includes:
periodically sending a first card-seeking signal through the first short-range wireless communication module;
determining that the second atomization apparatus exists within the preset distance range when a response signal or a second card-seeking signal sent by the second atomization apparatus is received; and
determining that the second atomization apparatus does not exist within the preset distance range when the response signal or the second card-seeking signal sent by the second atomization apparatus is not received.

Optionally, the step of performing data communication with the second atomization apparatus through the first short-range wireless communication module includes:
sending first data to the first short-range wireless communication module, causing the first short-range wireless communication module to encode the first data to obtain a first data packet frame and send the first data packet frame to the second atomization apparatus.

Optionally, the atomization apparatus further includes an user interaction module, and the step of sending the first data to the first short-range wireless communication module includes:
receiving control information output by the user interaction module and sending a first control instruction to the first short-range wireless communication module.

Optionally, the step of causing the first short-range wireless communication module to encode the first data to obtain the first data packet frame includes:
causing the first short-range wireless communication module to encode the first data based on a modulation type and an encoding type to obtain the first data packet frame.

Optionally, the first data packet frame includes a first frame start segment, a first data segment, and a first frame end segment, and the step of causing the first short-range wireless communication module to encode the first data based on the modulation type and the encoding type to obtain the first data packet frame includes:
causing the first short-range wireless communication module to set the first frame start segment based on the modulation type and the encoding type, to encode the first data according to the modulation type and the encoding type to obtain the first data segment, and to set the first frame end segment according to an encoding violation.

Optionally, after sending the first data to the first short-range wireless communication module, the method further includes:
determining that the first short-range wireless communication module has successfully received the data when a response message sent by the first short-range wireless communication module is received; and
determining that the first short-range wireless communication module has not successfully received the data when a communication timeout message sent by the first short-range wireless communication module is received.

Optionally, the step of the performing data communication with the second atomization apparatus through the first short-range wireless communication module further includes:
decoding a second data packet frame through the first short-range wireless communication module to obtain second data when the first short-range wireless communication module receives the second data packet frame sent by the second atomization apparatus.

Optionally, the second data packet frame includes a second frame start segment, a second data segment, and a second frame end segment, and the step of decoding the second data packet frame through the first short-range wireless communication module to obtain the second data includes:
causing the first short-range wireless communication module to obtain a modulation type and an encoding type based on the second frame start segment, to decode the second data segment based on the modulation type and the encoding type to obtain the second data, and to stop decoding based on the second frame end segment.

Optionally, after decoding the second data segment based on the modulation type and the encoding type to obtain the second data, the method further includes:
executing a second control instruction when the second data includes the second control instruction.

A second aspect of embodiments of the present application provides a device for data transmission, and the device for data transmission includes a first control module and a first short-range wireless communication module;
the first control module detects whether a second atomization apparatus exists within a preset distance range through the first short-range wireless communication module; if the first short-range wireless communication module determines that the second atomization apparatus exists within the preset distance range, the first control module is paired and connected to the second atomization apparatus through the first short-range wireless communication module, conducts data transmission with the second atomization apparatus, and synchronously displays the data with the second atomization apparatus.

A third aspect of embodiments of the present application provides an atomization apparatus, including: at least one processor, a memory, and a computer program stored in the memory and operable on the at least one processor, and the processor performs the computer program to implement the method as described in the first aspect.

The technical effects of the embodiments of the present application are that: by introducing the first short-range wireless communication module into the atomization apparatus, non-contact data transmission between apparatuses is achieved, and the problems of complex connection, vulnerable interface and unstable transmission existing in traditional wired communication methods are addressed. The first short-range wireless communication module automatically detects nearby target apparatuses and establishes communication connections, enhancing the convenience of use for users in multi-apparatus linkage scenes and the overall stability of the system; which has technical advantages such as simple operation, rapid response, and reliable connection; and the application experience of atomization apparatus in terms of intelligence and interconnection is effectively improved.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a structural schematic diagram of a first atomization apparatus in a method for data transmission provided in Embodiment 1 of the present application;

FIG. 2 is a flowchart of a method for data transmission provided in Embodiment 1 of the present application;

FIG. 3 is a structural schematic diagram of communication between a first atomization apparatus and a second atomization apparatus in a method for data transmission provided in Embodiment 1 of the present application.

FIG. 4 is a schematic diagram of interaction between a first atomization apparatus and a second atomization apparatus in a method for data transmission provided in Embodiment 1 of the present application.

FIG. 5 is a circuit diagram of a connection socket J1 of a first short-range wireless communication module of a first atomization apparatus in a method for data transmission provided in Embodiment 1 of the present application.

FIG. 6 is a circuit diagram of a first control module of a first atomization apparatus in a method for data transmission provided in Embodiment 1 of the present application;

FIG. 7 is a circuit diagram of a connection interface J2 of a first short-range wireless communication module of a first atomization apparatus in a method for data transmission provided in Embodiment 1 of the present application.

FIG. 8 is a specific flowchart of a step S10 in a method for data transmission provided in Embodiment 1 of the present application;

FIG. 9 is a schematic diagram of a 4-in-1 encoding mode in a method for data transmission provided in Embodiment 1 of the present application;

FIG. 10 is an encoding diagram of transmitted data in a method for data transmission provided in Embodiment 1 of the present application;

FIG. 11 is an encoding diagram decoded into logic 0 in a method for data transmission provided in Embodiment 1 of the present application;

FIG. 12 is an encoding diagram decoded into logic 1 in a method for data transmission provided in embodiment 1 of the present application;

FIG. 13 is a flowchart of a method for data transmission provided in Embodiment 2 of the present application;

FIG. 14 is a structural schematic diagram of communication between a first atomization apparatus and a second atomization apparatus in a method for data transmission provided in Embodiment 2 of the present application;

FIG. 15 is a schematic flowchart of a method for data transmission provided in Embodiment 3 of the present application;

FIG. 16 is a schematic flowchart of an optional method for data transmission provided in Embodiment 3 of the present application;

FIG. 17 is a schematic flowchart of an optional method for data transmission provided in Embodiment 3 of the present application;

FIG. 18 is a schematic flowchart of an optional method for data transmission provided in Embodiment 3 of the present application;

FIG. 19 is a schematic flowchart of an optional method for data transmission provided in Embodiment 3 of the present application;

FIG. 20 is a first structural schematic diagram of a device for data transmission of an atomization apparatus provided in Embodiment 7 of the present application;

FIG. 21 is a circuit diagram of a short-range wireless communication antenna in a device for data transmission of an atomization apparatus provided in Embodiment 7 of the present application;

FIG. 22 is a circuit interface diagram of a connection socket J1 of a short-range wireless communication module in a device for data transmission of an atomization apparatus provided in Embodiment 7 of the present application.

FIG. 23 is a circuit diagram of a short-range wireless communication module in a device for data transmission of an atomization apparatus provided in Embodiment 7 of the present application;

FIG. 24 is a second structural schematic diagram of a device for data transmission of an atomization apparatus provided in Embodiment 8 of the present application;

FIG. 25 is a third structural schematic diagram of a device for data transmission of an atomization apparatus provided in Embodiment 8 of the present application;

FIG. 26 is a circuit diagram of a power supply circuit of a display module of a device for data transmission of an atomization apparatus provided in Embodiment 8 of the present application;

FIG. 27 is a circuit diagraclaim of a connection socket of a display module of a device for data transmission of an atomization apparatus provided in embodiment 8 of the present application;

FIG. 28 is a circuit diagram of a silicon microphone detection circuit of a display module of a device for data transmission of an atomization apparatus provided in Embodiment 8 of the present application;

FIG. 29 is a structural schematic diagram of a device for data transmission provided in Embodiment 9 of the present application;

FIG. 30 is a structural schematic diagram of an atomization apparatus provided in Embodiment 10 of the present application;

FIG. 31 is an exploded schematic view of an atomization apparatus provided in Embodiment 10 of the present application;

FIG. 32 is a structural schematic view of an atomization apparatus provided in Embodiment 10 of the present application;

FIG. 33 is a structural schematic view of a liquid reservoir provided in Embodiment 10 of the present application;

FIG. 34 is a structural schematic view of a flexible circuit board provided in Embodiment 10 of the present application;

FIG. 35 is an exploded schematic view of an atomization apparatus provided in Embodiment 10 of the present application;

FIG. 36 is a schematic diagram of an internal structure of an atomization apparatus provided in Embodiment 10 of the present application; and

FIG. 37 is a structural schematic diagram of an atomization apparatus in one embodiment of the present application.

In the drawings, reference signs are listed as following:
10—first atomization apparatus; 20—second atomization apparatus; 101—first control module; 102—first short-range wireless communication module; 103—first display module; 104—short-range wireless communication antenna; 105—silicon microphone detection circuit; 151—silicon microphone; 152—signal processing chip; 201—second control module; 202—second short-range wireless communication module; 203—second display module; 100—housing; 100a—gap; 200—liquid reservoir; 300—flexible circuit board; 400—antenna; 211—first side wall; 212—second side wall; 311—electronic device; 401—polygonal pattern; 110—first shell; 120—second shell; 110a—avoidance opening; 500—display panel; 610—power supply assembly; 620—printed circuit board; 630—nozzle; 310—main body portion; and 320—connection portion.

### DETAILED DESCRIPTION OF THE EMBODIMENTS

The following will describe the technical solutions of the embodiments of the present application clearly and completely in combination with the accompanying drawings in the embodiments of the present application. Obviously, the described embodiments are part of the embodiments of the present application, not all of them. All other embodiments obtained by those skilled in the art without making creative efforts based on the embodiments of the present application fall within the protection scope of the present application.

It should be understood that the present application can be implemented in different forms and should not be interpreted as being limited to the embodiments presented here. Conversely, providing these embodiments will make the disclosure thorough and complete, and fully convey the scope of the present application to those skilled in the art. In the attached figure, for clarity, the dimensions of the layers and zones as well as their relative dimensions may be exaggerated. The same attached figure marks represent the same components throughout.

It should be understood that when a component or layer is referred to as “above . . . ”, “adjacent to . . . ”, “connected to” or “coupled to” other components or layers, it can be directly on other components or layers, adjacent to them, connected to or coupled to other components or layers, or there can be intermediate components or layers. On the contrary, when the component is called “directly above . . . ”, “directly adjacent to . . . ”, “directly connected to” or “directly coupled to” other components or layers, there are no intermediate components or layers. It should be understood that although terms such as first, second, third, etc. can be used to describe various components, parts, zones, layers and/or sections, these components, parts, zones, layers and/or sections should not be restricted by these terms. These terms are merely used to distinguish one component, part, zone, layer or section from another. Therefore, without departing from the teachings of the present application, the first component, part, zone, layer or section discussed below can be expressed as the second component, part, zone, layer or section.

The terms used herein are intended solely to describe specific embodiments and do not constitute limitations of the present application. When used here, the singular forms of “a”, “an” and “said/the” are also intended to include the plural form, unless the context clearly indicates otherwise. It should also be understood that the terms “composition” and/or “including”, when used in this specification, determine the existence of the said features, integers, steps, operations, components and/or parts, but do not exclude the existence or addition of one or more other features, integers, steps, operations, components, parts and/or groups. When used here, the term “and/or” includes any and all combinations of the relevant listed items.

In order to thoroughly understand the present application, detailed structures and steps will be presented in the following description to explain the technical solution proposed by the present application. The preferred embodiments of the present application are described in detail as follows. However, in addition to these detailed descriptions, the present application may also have other embodiments.

### Embodiment 1

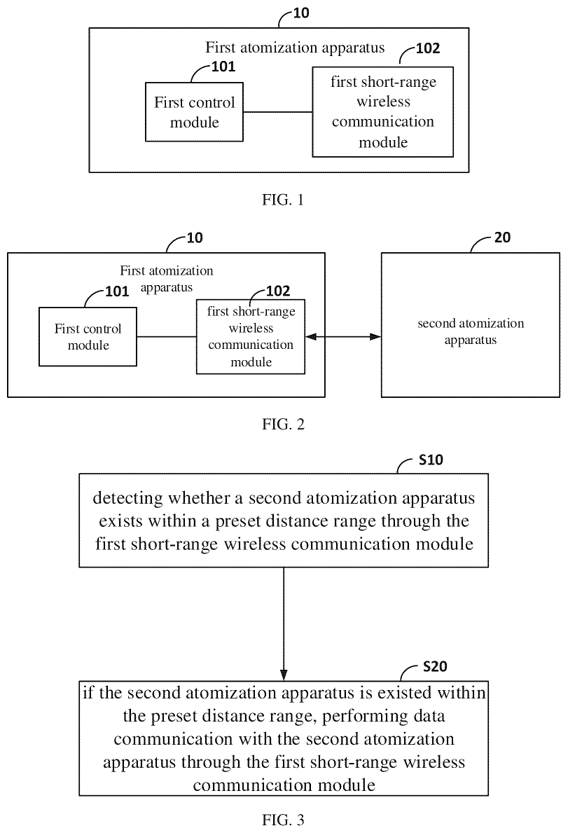

The first embodiment provides a method for data transmission, as shown in FIGS. 1 to 3, the method for data transmission is applied to the first control module 101 in the first atomization apparatus 10. The first control module 101 is connected to the first short-range wireless communication module 102, and the method for data transmission includes:

Step S10, detecting whether a second atomization apparatus 20 exists within a preset distance range through the first short-range wireless communication module 102.

Step S20, if the second atomization apparatus 20 is existed within the preset distance range, performing data communication with the second atomization apparatus 20 through the first short-range wireless communication module 102.

In the embodiment, the first control module 101 is disposed in the first atomization apparatus 10 and is used to control the overall operating state of the first atomization apparatus 10. The first short-range wireless communication module 102 is disposed in the first atomization apparatus 10 and connected to the first control module 101 for performing the near-field communication function, which specifically includes the following tasks: detecting whether there is a paired second atomization apparatus 20 nearby; receiving the connection signal sent by the second atomization apparatus 20; and establishing a short-range wireless communication connection for data transmission and reception.

In the embodiment, in the step S10, the first short-range wireless communication module 102 is periodically activated and can be used to detect whether the second atomization apparatus 20 has entered the preset communication range by sending a working field signal (such as a 13.56 MHz radio frequency field). The preset distance range can be determined based on the antenna power of the first short-range wireless communication module 102 and the matching parameters, for example, the preset distance range can be 0 to 100 centimeters. When the second atomization apparatus 20 responds to this field signal and returns an identification frame (such as an identification code or authentication information), the first short-range wireless communication module 102 determines the existence of the second atomization apparatus 20.

In the embodiment, in the step S20, once the first short-range wireless communication module 102 detects the response of the target apparatus, the first control module 101 sends the data to be transmitted (such as battery power level, voltage information, control instructions, etc.) to the first short-range wireless communication module 102 through the serial port or SPI interface. The first short-range wireless communication module 102 encodes (such as Manchester encoding) and modulates (such as ASK modulation) the data, and sends the data in radio frequency form to the second atomization apparatus 20. The second short-range wireless communication module 202 of the second atomization apparatus 20 receives the data, demodulates and decodes the data, and then transmits the data to its second control module 201. Data transmission can be carried out in both directions, when necessary, the first atomization apparatus 10 can also receive response information or control instructions from the second atomization apparatus 20. The entire communication process uses the ISO/IEC 15693 standard protocol to ensure communication stability, compatibility and security.

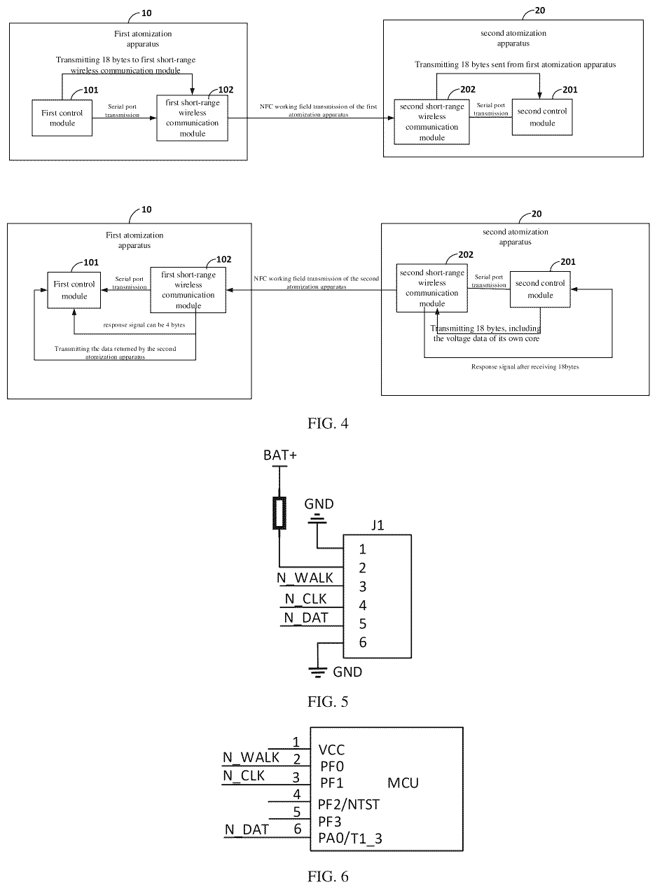

As shown in FIG. 4, for example, the first atomization apparatus 10 includes a first control module 101 and a first short-range wireless communication module 102, and the second atomization apparatus 20 includes a second control module 201 and a second short-range wireless communication module 202. After the first short-range wireless communication module 102 and the second short-range wireless communication module 202 establish a communication connection, when the first control module 101 and the second control module 201 enter the working state, the first control module 101 sends data (which can be 18 bytes) to the first short-range wireless communication module 102 through the communication serial port. After receiving the data from the first control module 101, the first short-range wireless communication module 102 will send back a string of data (the response signal can be 4 bytes) to the first control module 101, notifying that the first control module 101 has successfully received the data. At this point, the first control module 101 no longer needs to continue sending data and transitions to a state of waiting to receive data. When the first short-range wireless communication module 102 receives the data from the first control module 101, the data is encoded in Manchester encoding and sent to the second short-range wireless communication module 202 of the second atomization apparatus 20 through the workplace signal. Similarly, after receiving the data, the second short-range wireless communication module 202 decodes the received data in the decoded format. After decoding, the second short-range wireless communication module 202 sends the data to the second control module 201 through the serial port. The second atomization apparatus 20 then sends the corresponding data back based on the data format received from the first atomization apparatus 10. The process of transmitting the data back to the first atomization apparatus 10 is the same. Firstly, the second short-range wireless communication module 202 receives data from the second control module 201 (which can be 18 bytes, including its own cell voltage data), and then sends back a command indicating successful data receipt (an 18 bytes response signal) to the second control module 201. At the same time, the second control module 201 decodes the received data. Then, the data is sent to the first short-range wireless communication module 102 through the workplace signal of the second short-range wireless communication module 202. The first short-range wireless communication module 102 decodes the data returned from the second short-range wireless communication module 202, and then sends the data back to the first control module 101 through the serial port interface of the module. At this point, the data transmission process is completed. When two atomization apparatuses are close to each other, there will be a sequence of activation. The principle is that the atomization apparatus activated first will initiate data from the control module to the short-range wireless communication module. After receiving the data, the short-range wireless communication module will automatically open the working field and send the data out.

The technical effects of the embodiments of the present application are that: by introducing the first short-range wireless communication module into the atomization apparatus, non-contact data transmission between apparatuses is achieved, and the problems of complex connection, vulnerable interface and unstable transmission existing in traditional wired communication methods are addressed. The first short-range wireless communication module automatically detects nearby target apparatuses and establishes communication connections, enhancing the convenience of use for users in multi-apparatus linkage scenes and the overall stability of the system; which has technical advantages such as simple operation, rapid response, and reliable connection; and the application experience of atomization apparatus in terms of intelligence and interconnection is effectively improved.

As an embodiment, the first control module 101 includes a dormant state and an activated state. In the step S20, when the first control module is in the dormant state, if there is a second atomization apparatus within the preset distance range, the method further includes:
receiving a wake-up signal output by the first short-range wireless communication module 102 and switch from the dormant state to the activated state.

In the embodiment, the first control module 101 is used to control the overall operating state of the first atomization apparatus 10, including detecting whether it is in dormant state and controlling whether data communication is executed, etc. The first control module 101 has two working states: the dormant state and the activated state. In the dormant state, the first control module 101 does not perform main logic processing and only maintains the lowest power consumption standby state. In the activated state, the first control module 101 is fully activated and can perform functions such as communication and data processing.

In the embodiment, the first control module 101 places itself in a low-power standby mode without processing the data, avoiding unnecessary energy consumption. Once the first short-range wireless communication module 102 detects the response of the target apparatus, the first short-range wireless communication module 102 will output a wake-up signal to the first control module 101. After receiving the wake-up signal, the first control module 101 will exit from the dormant state and switch to the activated state. In the activated state, the first control module 101 has a complete instruction response capability and can handle operations such as application logic, data caching, encoding, and error checking, etc. The first control module 101 sends the data to be transmitted to the first short-range wireless communication module 102 via the serial port or SPI interface. The first short-range wireless communication module 102 encodes and modulates the data and sends the data to the second atomization apparatus 20 in the form of radio frequency.

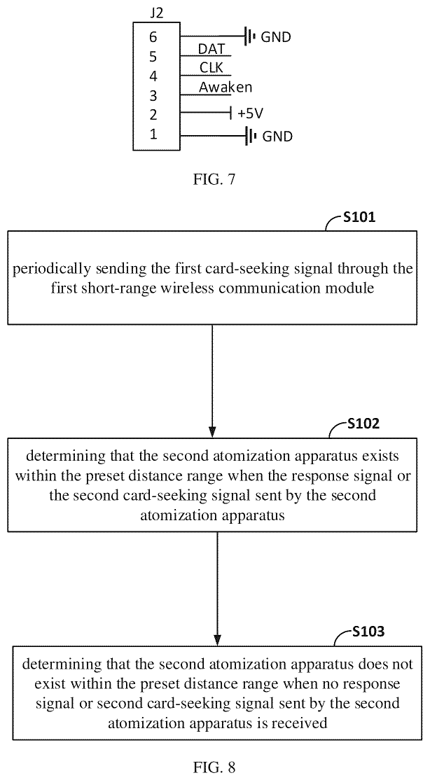

As an example, as shown in FIGS. 5 to 7, pins 3 and 6 in the connection socket J1 of the first short-range wireless communication module 102 are respectively connected to the serial communication transmitting terminal and receiving terminal of the main control MCU. Pin 3 of the connection socket J1 of the first short-range wireless communication module 102 is connected to pin 3 of interface J2. Pin 5 and pin 6 of the interface J2 are respectively connected to pin 5 and pin 6 of the connection socket J1. The transmitting port of the connection socket J1 is connected to the receiving port of the interface J2, and the receiving terminal of the connection socket J1 is connected to the transmitting terminal of the interface J2. The main control power supplies of the connection socket J1 and the interface J2 are both powered by battery cells. The pin 1 of the interface J2 is connected to the negative power supply terminal, and the pin 2 of the interface J2 is connected to the positive power supply terminal. It can be directly powered by the battery, with a power supply range of 2-5.5V The higher the voltage, the farther the communication distance. The peak current needs to be above 60 mA. The pin 3 of the interface J2 is the wake-up pin, which outputs a high level when an external field signal approaches. The pin 4 of the interface J2 is the communication clock pin (multiplexing module burning pin). The pin 5 of the interface J2 is the communication data pin (multiplexing module burning pin). The pin 6 of the interface J2 is the negative power supply terminal.

The first short-range wireless communication module 102 sends a wake-up signal “Awaken” through the pin 3 of the interface J2. The first short-range wireless communication module 102 receives the wake-up signal “Awaken” through the pin 3 of the connection socket J1. The pin 2 of the main control MCU receives the wake-up signal and enters the activated state.

The technical effect of the embodiment lies in that: by introducing control mechanisms for dormant state and the activated state, the embodiment can ensure the low-power operation of the device while achieving rapid response to close-range apparatuses. When the second atomization apparatus 20 is detected to enter the preset range, the first short-range wireless communication module 102 can send a wake-up signal, enabling the first control module 101 to switch from the dormant state to the activated state and immediately establish a communication connection, thereby enhancing the energy efficiency management capability of the apparatus.

As an embodiment, the first control module 101 is in the dormant state, including:

Entering the dormant state when the first control module 101 does not receive the data sent by the first short-range wireless communication module 102 within the preset time period.

In the embodiment, the first control module 101 is provided with an internal timer or a sleep wake-up strategy for low-power operation, such as being set to 5 seconds, 10 seconds, 30 seconds, etc. In the activated or standby state, the first control module 101 receives data from the first short-range wireless communication module 102 through a communication interface (such as UART or SPI). If within the preset time period, the first control module 101 does not receive any data frames, wake-up frames or state update signals from the first short-range wireless communication module 102, and does not detect user operations or other system wake-up conditions, the first control module 101 enters the dormant state; the first control module 101 will turn off the main frequency clock and peripheral interfaces, and only retain the minimum interrupt wake-up mechanism, entering a low-power dormant mode. In this state, the current consumption can be reduced to the microampere level, greatly extending the standby time of the apparatus. The first control module 101 will wait for the wake-up signal from the first short-range wireless communication module 102 or the system timer to wake up and then start the processing logic again.

The technical effect of the present embodiment lies in that: realizing a management mechanism of on-demand wake-up and intelligent entry into dormant mode, the endurance performance of the atomization apparatus is improved, unnecessary system load is reduced, and operational efficiency and user experience is enhanced.

As an embodiment, as shown in FIG. 8, the step S101 of detecting whether the second atomization apparatus 20 exists within the preset distance range through the first short-range wireless communication module 102, including:

Step S101, periodically sending the first card-seeking signal through the first short-range wireless communication module 102.

Step S102, determining that the second atomization apparatus 20 exists within the preset distance range when the response signal or the second card-seeking signal sent by the second atomization apparatus 20.

Step S103, determining that the second atomization apparatus 20 does not exist within the preset distance range when no response signal or second card-seeking signal sent by the second atomization apparatus 20 is received.

In the embodiment, in the step S101, the first short-range wireless communication module 102 of the first atomization apparatus 10 regularly sends the first card-seeking signal to actively detect whether there are other atomization apparatuses approaching. The first card-seeking signal can be a query command that complies with the ISO/IEC 15693 protocol; this signal is emitted through the antenna in the form of a 13.56 MHz radio frequency. The transmission frequency, such as every 1 second, 2 seconds or longer, can be flexibly adjusted according to the power consumption strategy. This step belongs to the active scanning process and is a prerequisite for establishing a point-to-point communication link.

In the embodiment, in the step S102, after the first atomization apparatus 10 sends the card-seeking signal, if the second atomization apparatus 20 is already in a work state, the first short-range wireless communication module 102 of the second atomization apparatus 20 will respond to the card-seeking signal and send a response signal (such as apparatus identification, state frame, etc.). If the second atomization apparatus 20 is also performing the same periodic card-seeking operation, the second card-seeking signal actively sent by the second atomization apparatus 20 may be detected within the receiving window of the first atomization apparatus 10. Whether the first atomization apparatus 10 receives a response signal to the card-seeking signal or the second card-seeking signal actively sent by the second atomization apparatus 20, it indicates that the second atomization apparatus 20 has entered the communication range. At this point, the first short-range wireless communication module 102 of the first atomization apparatus 10 outputs a wake-up signal to the first control module 101, thereby enabling the first control module 101 to enter the activated state and prepare for data communication.

In the embodiment, in the step S103, if the first atomization apparatus 10 does not receive any valid data frame (i.e., no response signal and no card-seeking signal from other apparatuses) within the set monitoring time window after completing one card-seeking signal transmission; then it is determined that there is no second atomization apparatus within the current communication range. The first control module 101 remains in its current state (for example, continuing to dormant or maintaining low-power standby), while the first short-range wireless communication module 102 turns off its RF output and resumes signal output in the next cycle.

The technical effect of the present embodiment lies in that: by setting up the first short-range wireless communication module 102 to periodically and actively send the card-seeking signal, and combining the recognition and detection of the response signal or active card-seeking signal of the second atomization apparatus 20, an automatic communication link is established between the two apparatuses without manual pairing or network connection. This implementation method not only enhances the communication response speed when the apparatus is approaching, but also effectively reduces the energy consumption of the apparatus in an idle state, demonstrating good practicality and scalability.

As an embodiment, the step S10 of performing the data communication between the first short-range wireless communication module 102 and the second atomization apparatus 20 includes:
sending the first data to the first short-range wireless communication module 102, causing the first short-range wireless communication module 102 to encode the first data to obtain the first data packet frame and then sends the first data packet frame to the second atomization apparatus 20.

In the embodiment, the first control module 101 of the first atomization apparatus 10 sends the data to be transmitted (i.e., the first data) to the first short-range wireless communication module 102 through the communication interface (such as UART, SPI or I² C). The first data can include an apparatus state, a battery power level, user setting parameters, identity information, control instructions, etc. The first control module 101 can organize data into protocol-compliant data frame formats, such as including State of Frames (SOF), data bodies, Cyclic Redundancy Check (CRC), etc. After receiving the first data sent by the first control module 101, the first short-range wireless communication module 102 performs encoding processing, and common encoding methods include Manchester encoding. Meanwhile, this data will be packaged using a frame structure that complies with the ISO/IEC 15693 protocol, including adding the Start of Frame (SOF), data length, identifier, etc. The encoded data is called the first data packet frame, and its format is suitable for modulation and transmission at the physical layer of short-range wireless communication. After the encoding is completed, the first short-range wireless communication module 102 converts the first data packet frame into a 13.56 MHz radio frequency signal by modulating the electromagnetic field (such as ASK modulation). This signal is transmitted through the antenna and received by the first short-range wireless communication module 102, which is in the receiving state of the second atomization apparatus 20. After receiving the first data packet frame, the second atomization apparatus 20 decodes, parses the first data packet frame and transmits the first data packet frame to the first control module 101 of the second atomization apparatus 20 for subsequent processing.

The technical effect of the present embodiment lies in that: the data to be transmitted is sent to the first short-range wireless communication module 102 through the first control module 101. Then, the first short-range wireless communication module 102 performs encoding, packaging and electromagnetic modulation and sends the data to the second atomization apparatus 20, thus realizing an efficient, low-power consumption and contactless data transmission mechanism based on short-range wireless communication. This method supports structured data frames, standardized communication protocols and reliable modulation methods, ensuring the accuracy, real-time performance and compatibility of data transmission across apparatuses.

As an embodiment, the atomization apparatus also includes an user interaction module that sends the first data to the first short-range wireless communication module 102, including:
receiving the control information output by the user interaction module and sending the first control instruction to the first short-range wireless communication module 102.

In the embodiment, the user interaction module is disposed in the atomization apparatus and is used to achieve information interaction control between the user and the apparatus. This module includes but is not limited to the following components: physical keys or touch sensors used for active user input, such as light touch, long press, double-click, etc; display interface (such as LED, OLED, etc.) used for feedback on device state or communication state; voice interaction or vibration module providing enhanced interaction methods. The function of the user interaction module is to identify the operation behavior of user and convert the operation behavior of user into the first control instruction for further processing by the first control module 101, such as starting the atomization apparatus, requesting data transmission, and switching the apparatus state, etc.

In the embodiment, users issue operation instructions through the interaction module, for example: touching a button lightly requests apparatus state synchronization; double-click the button to start the atomization apparatus, and long press the button to turn off the apparatus, etc. The user interaction module converts the above-mentioned user actions into logical signals, that is, control information. After receiving this control information, the first control module 101 generates the first control instruction. The first control module 101 sends the first control instruction to the first short-range wireless communication module 102 through the communication interface. The first short-range wireless communication module 102 then encodes, packages and sends the information to the second atomization apparatus 20 through the antenna to complete the communication control. The second short-range wireless communication module 202 in the second atomization apparatus 20 decodes and sends the first control instruction to the second control module 201, the second control module 201 then executes the first control instruction.

The technical effect of the present embodiment lies in that: by arranging the user interaction module and combining the collaborative processing of the first control module 101 and the first short-range wireless communication module 102, users can actively trigger data transmission between atomization apparatuses, enhancing the autonomy, convenience and functional controllability of interaction. It is particularly suitable for controlling the second atomization apparatus 20 through the first atomization apparatus 10 to enhance the intelligent experience of the product.

As an embodiment, the first data packet frame includes the first frame start segment, the first data segment, and the first frame end segment, enabling the first short-range wireless communication module 102 to encode the first data according to the modulation type and the encoding type to obtain the first data packet frame, including:

Causing the first short-range wireless communication module 102 to set the first frame start segment based on the modulation type and the encoding type, to encode the first data according to the modulation type and the encoding type to obtain the first data segment, and to set the first frame end segment according to an encoding violation.

In the embodiment, the first data packet frame is the data structure sent by the first short-range wireless communication module 102 during communication, which specifically includes the following three parts: the first frame start segment, the first data segment, and the first frame end segment. The first frame start segment is used to mark the starting of a data frame, facilitating accurate identification and synchronization by the receiving apparatus. The first frame start segment usually employs specific waveforms and bit sequences to mark the modulation type and the encoding type. The data segment carries the actual valid data to be transmitted and is the core content of the data packet frame. This part is also processed in accordance with certain modulation and coding rules to ensure the accuracy and anti-interference ability of the transmission process. The frame end segment is used to mark the end of the data frame, set according to the encoding violation, facilitating the receiving end to confirm the boundary of the frame, thereby completing the reception and parsing of the complete data frame. The modulation types include the first modulation type and the second modulation type. When modulating the data packet frames, the system supports two different modulation depths. For example: The first modulation type is ASK (Amplitude Shift Keying) with a modulation index of 10%, that is, the carrier amplitude has only a 10% difference between logic 1 and 0, the power consumption is lower and is suitable for short-distance or low-speed transmission. The second modulation type is ASK with a modulation index of 100%, indicating that logic 1 is represented by a complete carrier, and when logic 0, the carrier is completely turned off, the modulation intensity is high and is easy for receiving apparatuses to identify, making it suitable for situations with higher compatibility requirements. The encoding types include different multiple-choice encoding modes, such as the 4-in-1 encoding mode.

In the embodiment, causing the first short-range wireless communication module 102 to set the frame start segment according to the modulation type and the encoding type refers to, during data communication, to ensure that different types of receiving apparatuses can accurately identify and decode the transmitted content, when the first short-range wireless communication module 102 generates the start part of the data packet frame, the original data will be modulated and encoded according to the selected modulation type. Specifically, the embodiment adopts the ASK modulation mode and supports two modulation depths: the first modulation type is 10% exponential (low modulation depth), and the second modulation type is 100% exponential (high modulation depth). In actual operation, the first short-range wireless communication module 102 will select one of the modulation methods and encoding types to set the frame start segment, so that the apparatus of receiving terminal can decode according to the frame start segment.

In the embodiment, after encoding the first data according to the modulation type and the encoding type to obtain the first data segment indicates that the communication module will process the first data to be sent in accordance with the previously determined modulation and encoding methods to generate the data segment portion. The modulation type determines the physical characteristics of the signal, such as the depth of amplitude variation (10% or 100%). The encoding type determines how data is mapped to a time series, such as how much time period each bit occupies and when it is modulated, etc. For example, in 256-in-1 encoding, 1 byte of data is divided into 256 equal-length time periods, and whether each period is modulated or not represents a different value.

In the embodiment, setting the first frame end segment according to the encoding violation indicates that, in accordance with the protocol provisions, a signal pattern that does not belong to the normal encoding rules (i.e., encoding violation) will be inserted at the end of the frame as the end of flag (EOF) of the frame. The purpose of doing this is to make the receiving apparatus clearly aware that the data frame has ended. The encoding violations are usually some special modulation sequences that do not appear in the data segment, such as no modulation for a long time or modulation at an illegal time point.

The technical effect of the present embodiment lies in that: by setting the frame start segment, data segment and frame end segment according to the modulation type and the encoding type, the standardized encapsulation and transmission of data are achieved. The end of frames is marked by encoding violations, which improves the accuracy of frame boundary recognition. By adapting to different modulation and coding methods, the compatibility and reliability of communication have been effectively enhanced, ensuring that the short-range wireless communication module can stably and efficiently complete data interaction.

As an embodiment, after sending data to the first short-range wireless communication module 102 further includes:
determining that the first short-range wireless communication module 102 has successfully received the data when a response message sent by the first short-range wireless communication module 102 is received; and
determining that the first short-range wireless communication module 102 has not successfully received the data when a communication timeout message sent by the first short-range wireless communication module 102 is received.

In the embodiment, the first control module 101 transmits the first data (such as apparatus state, instruction information) to the first short-range wireless communication module 102 through the communication interface, and the first short-range wireless communication module 102 is ready to encode and send the first data. After receiving the data, the first short-range wireless communication module 102 will cache, parse the data and prepare to perform encoding, packaging and radio frequency modulation, etc. After completing the data parsing and confirming the correct format, a response message is actively sent back to the first control module 101 to feedback the data reception state. This response message is usually in short frame format, after receiving the response message, the first control module 101 parses the response message. If the message content meets the conditions for successful reception, it detects that the first short-range wireless communication module 102 has successfully received the sent data. When a communication timeout message sent by the first short-range wireless communication module 102 is received, it is determined that the first short-range wireless communication module 102 has not successfully received data. The re-transmission mechanism can be triggered or an error prompt can be reported.

As an example of sent data, the data format sent by the first control module 101 to the first short-range wireless communication module 102 is shown in the following table:

| Data header | Data direction | User data byte1-16 | Checksum |
|---|---|---|---|
| 1 Byte | 1 Byte | 16 Byte | 1 Byte |
| 0XAA | | | Cumulative sum |

In the embodiment, the data header: fixed byte 0XAA, the data direction: 0X00 from the first control module to the first short-range wireless communication module; the User data: fixed 16 bytes, content customized by the user; the checksum: the cumulative sum of all previous data, including data headers, data directions, and user data.

As an example of a data response, the format of the response data sent by the first short-range wireless communication module 102 to the first control module 101 is shown in the following table:

| Data header | Data direction | User data byte1-16 | Checksum |
|---|---|---|---|
| 1 Byte | 1 Byte | 2 Byte | 1 Byte |
| 0XAA | | | Cumulative sum |

In the embodiment, the data header: fixed byte 0XAA, the data direction: 0X01 from the first short-range wireless communication module to the first control module; the User data: fixed 2 bytes, 0X0000 indicates communication completion, and 0X0001 indicates communication timeout failure; the checksum: the cumulative sum of all previous data, including data headers, data directions, and response byte.

The technical effect of the present embodiment lies in that: By introducing the response mechanism of the first short-range wireless communication module 102, the first control module 101 has effectively confirmed the data transmission state, which helps to improve the reliability and security of data exchange, avoid control errors or abnormal apparatus state caused by data loss, abnormality or communication failure, and the stability of the overall system is enhanced.

As an embodiment, data communication is performed between the first short-range wireless communication module 102 and the second atomization apparatus 20, which further includes:
decoding a second data packet frame through the first short-range wireless communication module 10 to obtain second data when the first short-range wireless communication module 102 receives the second data packet frame sent by the second atomization apparatus 20.

In the embodiment, after the second atomization apparatus 20 completes the encoding and packaging of its own control data, it transmits the encoded second data packet frame to the first atomization apparatus 10 in the form of a 13.56 MHz radio frequency signal through the first short-range wireless communication module 102 of the second atomization apparatus 20. The first short-range wireless communication module 102 of the first atomization apparatus 10 receives the radio frequency signal through the antenna and identifies the valid data frame; the received data format is usually a frame structure that complies with the ISO/IEC 15693 protocol, this data is a physical layer signal that has undergone modulation and encoding processing. The first short-range wireless communication module 102 performs decoding processing; the demodulation operations is firstly conducted to restore the radio frequency signal to a digital signal, the decoding is then carried out to restore the encoded bit stream to the original second data; simultaneously parse the protocol frame structure, extract the content of the valid data area, and complete the full data extraction. After decoding is completed, the first short-range wireless communication module 102 will send the second data obtained to the first control module 101 of the first atomization apparatus 10 through the communication interface. The first control module 101 performs subsequent operations based on this, such as display, synchronization, and control logic response, etc.

The technical effect of the present embodiment lies in that: By setting up the first short-range wireless communication module 102 to decode and restore the data signals from the second atomization apparatus 20, the first atomization apparatus 10 can accurately obtain and use the data provided by the second atomization apparatus 20, achieving two-way communication, synchronous control or parameter interaction, thereby enhancing the collaborative ability between apparatuses and improving the intelligent experience and interaction efficiency.

As an embodiment, the second data packet frame includes a second frame start segment, a second data segment, and a second frame end segment, and the step of decoding the second data packet frame through the first short-range wireless communication module to obtain the second data includes:
causing the first short-range wireless communication module 102 to obtain a modulation type and an encoding type based on the second frame start segment, to decode the second data segment based on the modulation type and the encoding type to obtain the second data, and to stop decoding based on the second frame end segment.

In the embodiment, the second frame start segment marks the starting of the data frame and carries the prompt information of modulation and encoding at the same time; the second data segment carries the data content to be transmitted (such as instructions, information, etc.); the second frame end segment marks the end of the data frame, preventing misdecoding or data extension. The first short-range wireless communication module 102 is caused to obtain the modulation type and the encoding type representation based on the second frame start segment, and the decoding begins with the parsing of the frame start segment (SOF). By analyzing the timing structure of the frame start segment, determine the modulation type (such as ASK10% or ASK100%) and encoding type (such as 256-in-1 or 4-in-1) used by the transmitting terminal. The second data segment is decoded based on the modulation type and the encoding type to obtain the second data representation, and the data segment is parsed bit by bit (or byte by byte) using the modulation and encoding rules identified in the previous step. For example, in the encoding type of 4-in-1, 18.88 μs is the unit time, and whether modulation occurs within the corresponding time period indicates different data values. After decoding, the original digital data is restored, that is, the second data. Stopping decoding based on the second frame end segment indicates that when the frame end segment is detected, the decoding of the current data frame will be terminated to prevent further parsing of invalid or incorrect data. EOF is usually composed of encoding violations, such as: no modulation for a long time, or modulation modes with illegal timing.

The technical effect of the present embodiment lies in that: by successively identifying the frame start segment, data segment and frame end segment during the decoding process, and determining the modulation type and the encoding type based on the frame start segment, it ensures that the short-range wireless communication module can adapt to the data frame format of different modulation/encoding methods, the accurate decoding of the data segment is achieved. Meanwhile, by promptly stopping decoding through the frame end segment, misdecoding is avoided, which enhances the stability of the decoding process and the reliability of data processing, and improves the compatibility and intelligence of the system for communication with diverse apparatuses.

As an embodiment, after decoding the second data segment based on the modulation type and the encoding type to obtain the second data, which further includes:

Executing the second control instruction when the second data includes the second control instruction.

In the embodiment, the second data is the valid service data obtained by demodulation and decoding through the first short-range wireless communication module 102, which may include apparatus state information, user parameters, pairing information or control instructions, etc. After receiving the second data, the first control module 101 first performs format detection and content parsing on the data content. If it is found that the data contains a second control instruction segment (such as instruction code, operation identifier, parameter bit, etc.), it is determined that the data is instruction data. The second control instruction may include: turning on/off the functional module; setting apparatus parameters; synchronizing a certain state; initiating specific application logic (such as starting pairing, resetting binding, etc.). The first control module 101 calls the corresponding local control logic or hardware operation program according to the instruction type to complete the execution of the instruction. If the instruction is legal and the parameters are valid, the preset process will be executed. If the instruction is illegal or abnormal, an error code can be returned or the instruction can be ignored.

The technical effect of the present embodiment lies in that: By supporting the recognition and execution of control instructions in the second data, the first atomization apparatus 10 can achieve remote control of functions, state synchronization or behavior coordination with the second atomization apparatus 20, significantly enhancing the interactivity and intelligence level between the apparatuses. It is suitable for dual-apparatus mutual control scenes and offers a good user experience and system scalability.

The following is a detailed description of the embodiment through a specific workflow:

The short-range wireless communication solution adopted by the present application is based on a non-contact identification chip (such as CM1A08-1K) that complies with the ISO/IEC 15693 international standard. This chip supports long-distance read-write communication in the 13.56 MHz frequency band and features anti-collision, support for multiple tags, and on-chip EEPROM storage, etc. It is applicable to point-to-point data interaction among small intelligent apparatus such as atomization apparatus. With the appropriate antenna (data and energy are transmitted wirelessly), its effective operating range can reach 100 cm, it has anti-collision function and can handle multiple tags simultaneously. The on-chip EEPROM storage space is divided into 32 pages (blocks) in the user area, with each page being 32 bits. In addition, 64 bits are unique serial numbers and 32 bits are used for special functions (such as AFI, DSFID, etc.).

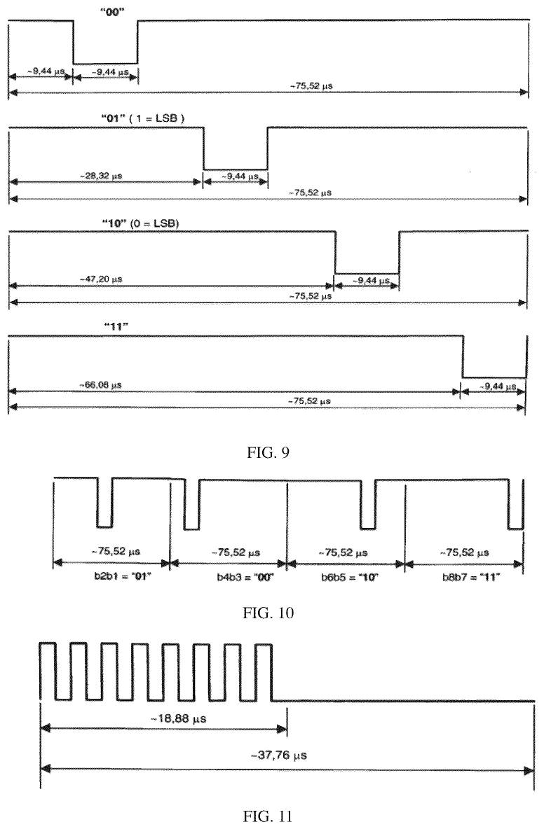

In the communication system, the first short-range wireless communication modules 102 of the first atomization apparatus 10 and the second atomization apparatus 20 respectively undertake the functions of the master apparatus (VCD) and the secondary apparatus (VICC). The basic principle of communication includes the following steps:
1. Activation and connection establishment stage: the master apparatus VCD periodically emits a radio frequency electromagnetic field (RF field) through its antenna to activate the nearby secondary apparatus VICC. When the secondary apparatus VICC is activated, it enters the monitoring state and is ready to receive the command frame sent by the master apparatus VCD.
2. Command sending and response stage: the master apparatus VCD sends a data frame to the secondary apparatus VICC. This data frame adopts ASK modulation and uses pulse position modulation for data encoding. In terms of frame structure, a data frame consists of the frame start segment (SOF), data content, and frame end segment (EOF) to ensure the integrity of the communication frame and protocol synchronization. As shown in FIG. 9, the encoding can be selected in a 4-in-1 encoding mode. As shown in FIG. 10, the transmitted data position is at the front, and the data is E1=(11100001) b=225. In order to facilitate synchronization and be protocol-independent, frames are separated by the frame start segment (SOF) and the frame end segment (EOF), and encoding violations are used to achieve this functionality. ISO/IEC retains unused items for future use. After sending a frame of data to the VCD, the VICC should be prepared to receive the frame of data from the VCD within 300 μs. The VICC should be prepared to receive one frame of data within 1 ms when the energy field is activated.
3. Data reception and feedback stage: after the secondary apparatus VICC receives the data from the master apparatus VCD, it acquires valid information through demodulation and decoding processing, and then feeds back the response data to the VCD of the master device on the sub-carrier through load modulation. The response signal adopts Manchester coding mode, and the communication timing sequence is based on the high data rate from the secondary apparatus VICC to the master apparatus VCD. The VICC should be capable of communicating with the VCD through the inductively coupled region, where the loaded carrier frequency can generate a sub-carrier with a frequency of fs. This sub-carrier should be capable of generating by switching the load in the VICC. Measure according to the description of the test method, the load modulation amplitude should be at least 10 mV, and the data is encoded using the Manchester encoding method. All times refer to the high data rate from VICC to VCD. For low data rates, the same sub-carrier frequency or frequency is used. Therefore, the number of pulses and the time should be multiplied by 4.

The data format at the receiving terminal is as follows:

As shown in FIG. 11, logic 0 begins with 8 pulses at a frequency of fc/32 (approximately 423.75 KHZ), followed by an unmodulated time of 256/fc (approximately 18.88 μs).

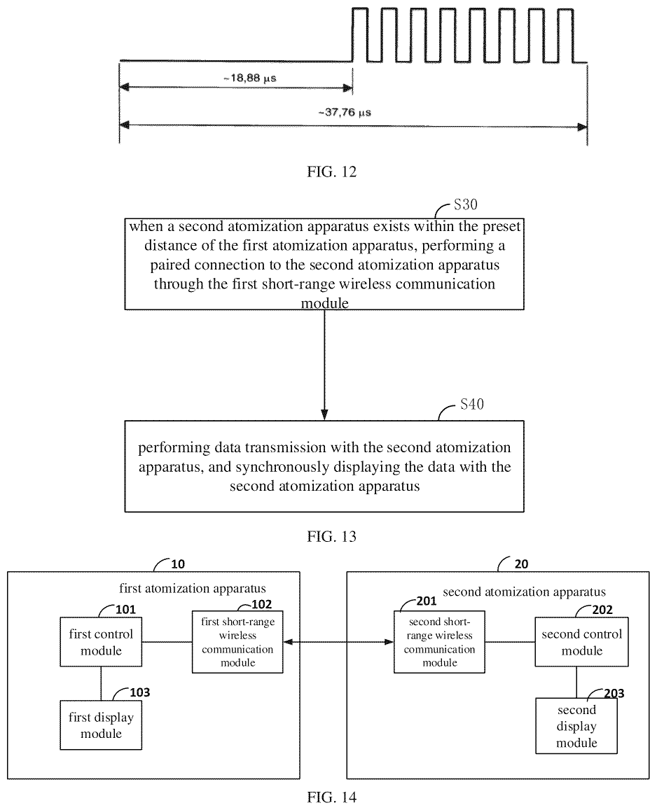

As shown in FIG. 12, logic 1 begins with an unmodulated time of 256/fc (approximately 18.88 μs), followed by 8 pulses with a frequency of fc/32 (approximately 423.75 KHZ).

As an example of decoding, in the data transmission of the short-range wireless communication module, the data is modulated using ASK and two modulation depths (10% and 100%) are adopted. The decoding process involves detecting carrier variations of different modulation depths and converting them back into binary data. The first modulation type (10% modulation):the carrier amplitude only drops by 10%, and minor signal changes can still be detected. The second modulation type (100% modulation):the carrier completely disappears (carrier-free time), used for explicit start of frame (SOF), end of frame (EOF), and data encoding. Logic 0 is to first send 8 pulses at a frequency of 423.75 kHz (fc/32), followed by a carrier-free time of 18.88 μs (256/fc). Logic 1 involves first sending a carrier-free time of 18.88 μs (256/fc), followed by 8 pulses at a frequency of 423.75 kHz (fc/32). The decoding process lies in detecting the variation patterns of the carrier signal and matching the predefined logic 0 and logic 1 modes. The specific steps are as follows: Use a bandpass filter (BPF) to extract the sub-carrier component with a frequency of 423.75 kHz (fc/32), and identify the amplitude variation of the signal through envelope detection to obtain the modulation depth information. Before data transmission, the receiving terminal needs to detect SOF (Start of Frame) to determine the starting point of the data stream. SOF may use 100% modulation (completely carrier-free) and 4-in-1 encoding modes as markers for signal synchronization. After the decoder detects a long period of carrier-free (second modulation type), it enters the data receiving mode. According to the encoding mode, if a 423.75 kHz carrier (8 pulses) is detected first, and then a 18.88 μs carrier-free is detected, it is determined to be logic 0. If a 18.88 μs carrier-free is detected first, and then a 423.75 kHz carrier (8 pulses) is detected, it is determined to be logic 1. If it is 10% modulation (the first modulation type), it indicates normal data transmission, and 0 or 1 can be determined according to the above logic. If it is 100% modulation (the second modulation type), it might be SOF (Start of Frame) or EOF (end of frame). Suppose the following signal sequence is received: (SOF)→423.75 kHz (8 pulses)→18.88 μs carrier-free→18.88 μs carrier-free→423.75 kHz (8 pulses)→EOF. The decoding process is as follows: 1. SOF (100% modulation, carrier-free for a long time) is detected, and the data receiving mode is entered. 2. Parsing the first bit: 423.75 kHz (8 pulses)→18.88 μs carrier-free→logic 0. 3. Analyzing the second bit: 18.88 μs carrier-free→423.75 kHz (8 pulses)→logic 1. 4. When EOF (100% modulation, carrier-free) is detected, the data frame is end. The decoding result is: 01. During the data exchange process, the communication delay is controlled at the microsecond level. For example, after the apparatus VICC receives a data frame, it should complete the response preparation within 300 μs. The frame structure is unified to the SOF+data+EOF format, which helps to improve synchronization, fault tolerance and system robustness. For the case of low data rate, the relevant time parameters are extended according to the sub-carrier multiple relationship.

Through the above process design, the present application can achieve low-power consumption, rapid response, contactless and pail-free data interaction among atomization apparatuses, enhance user experience and simplify operation processes, and has good practicability and promotion value.

### Embodiment 2

The embodiment provides a method for data transmission, as shown in FIG. 13. The method for data transmission includes:

Step S30, when a second atomization apparatus 20 exists within the preset distance of the first atomization apparatus 10, performing a paired connection to the second atomization apparatus 20 through the first short-range wireless communication module 102.

Step S40, performing data transmission with the second atomization apparatus 20, and synchronously displaying the data with the second atomization apparatus 20.

In the embodiment, in the step S30, the first control module 101 periodically or in real time detects whether there is a second atomization apparatus 20 in a connected state around the first control module 101. The detection method can actively send a broadcast signal through the first short-range wireless communication module 102, or by detecting whether it receives a broadcast signal sent by other atomization apparatuses. After receiving the response, the first control module 101 initiates the pairing process and completes the connection establishment with the second atomization apparatus 20. This pairing process can adopt encryption algorithms to ensure communication security.

In the embodiment, in the step S40, after the pairing connection is completed, the first control module 101 conducts unidirectional or bidirectional data transmission with the second atomization apparatus 20 through the first short-range wireless communication module 102. The unidirectional transmission can be the transmission of display data from the first atomization apparatus 10 to the second atomization apparatus 20, or from the second atomization apparatus 20 to the first atomization apparatus 10. The transmitted data may include but are not limited to atomization parameters, remaining power level, usage duration, animation display state, user configurations, etc. In order to achieve bidirectional synchronous display, the first control module 101 updates the local display interface based on the received synchronous data and simultaneously sends the current display data to the second atomization apparatus 20, ensuring that the display contents of the two apparatuses remain consistent. For example, when a user adjusts the power or animation effect on the first atomization apparatus 10, this setting can be synchronized to the second atomization apparatus 20, such that the displayed content of the second atomization apparatus 20 is consistent with that of the first atomization apparatus 10, thereby achieving interaction visual feedback.

The technical effect of the embodiment lies in that: by introducing a short-range wireless communication module into the first atomization apparatus 10, it can automatically detect and pair with the nearby second atomization apparatus 20, so as to achieve data transmission and synchronous display between the two atomization apparatuses, effectively enhancing the collaborative ability among multiple apparatuses and the user interaction experience. By synchronously displaying interface information or usage state, the operation process of the user is simplified, and the intelligence and social interaction functions of the apparatus is enhanced by supporting contactless operation.

As an embodiment, a first short-range wireless communication module 102 is paired and connected with a second atomization apparatus 20, including:

The field signal is sent to the second atomization apparatus 20 through the first short-range wireless communication module 102, and the second atomization apparatus 20 is used to receive the on-site signal and then provide a feedback response signal. When the response signal sent by the second atomization apparatus 20 is received, the pairing with the second atomization apparatus 20 is completed.

In this step, the first control module 101 controls the first short-range wireless communication module 102 to emit a set of electromagnetic signals, that is, field signals, for apparatus discovery at regular intervals or under trigger conditions. This field signal is used to wake up or detect within a certain range whether there are other apparatuses with pairing capabilities. When the second atomization apparatus 20 is within the preset wireless communication range and in the response mode, the short-range wireless communication module of the second atomization apparatus 20 will receive the field signal and actively return a response signal to the first atomization apparatus 10. After receiving the response signal, the first control module 101 determines the existence and communication feasibility of the second atomization apparatus 20, and then performs the pairing process. A successful pairing usually indicates that both parties have completed the necessary identity verification, key negotiation (such as using a pairing code or encryption algorithm), and established a secure communication channel to ensure the correctness and confidentiality of subsequent data transmission. A successful pairing may include the establishment of a physical connection, the completion of authentication, or the successful matching of communication protocols, depending on the system implementation strategy configuration.

The technical effect of the embodiment lies in that: by sending the field signal to the second atomization apparatus 20 and completing the pairing connection based on the response signal, the embodiment realizes the automatic identification and rapid pairing between apparatuses, the convenience and interaction efficiency of apparatus connection are effectively improved.

As an embodiment, as shown in FIG. 14, the first control module 101 and the first display module 103 are electrically connected. The second atomization apparatus 20 includes a second control module 201, a second short-range wireless communication module 202, and a second display module 203. The step of performing data transmission with the second atomization apparatus 20, and synchronously displaying the data with the second atomization apparatus 20 includes:
displaying the first data through the first display module 103, and sending the first data to the second short-range wireless communication module 202 through the first short-range wireless communication module 102, so that the second control module 201 displays the first data through the second display module 203.

In the embodiment, the first display module 103 is a display unit disposed on the first atomization apparatus 10, which is used to present the usage state, control information or visual animations and other data of the current apparatus to the user. This module can take the form of an OLED screen, a LED digital tube, a touch display screen, etc. The first display module 103 is controlled by the first control module 101 and is used to update the display content in real time according to the system operation state or user operation, such as power level, remaining battery power level, usage duration, animation effect, etc. The second atomization apparatus 20 is the target apparatus paired with the first atomization apparatus 10, and the second control module 201 is used to manage the operation logic of the apparatus and process the received data instructions. The second short-range wireless communication module 202 is used to receive wireless data from the first apparatus and communicate with the second control module 201. The second display module 203 is used to visually present the received data content to the user, the display effect of the second display module 203 is consistent with or corresponding to that of the first display module 103, and it is used to achieve synchronous display.

This step describes the data synchronization and display process, which specifically includes the following operations: the first control module 101 displays the first data through the first display module 103, such as the currently selected gear, temperature, animated graphics, etc. Meanwhile, the first control module 101 transmits the first data to the second atomization apparatus 20 through the first short-range wireless communication module 102. After the second atomization apparatus 20 receives the data, the second control module 201 of the second atomization apparatus 20 parses the data and controls the second display module 203 to display the parsed data. Ultimately, the two atomization apparatuses visually synchronously display the same first data, so as to achieve a real-time linkage effect. In the embodiment, the first atomization apparatus 10 serves as the main control party, the display content of the first atomization apparatus 10 is not limited to local display but can also be synchronously broadcast to the paired atomization apparatuses, so as to achieve unified visual feedback or collaborative state display among multiple atomization apparatuses.

The technical effect of the present embodiment lies in that: by synchronously transmitting the display data of the first atomization apparatus 10 to the second atomization apparatus 20 and consistently presenting the display data on the display modules of the two atomization apparatuses, the coordination when using multiple apparatuses and the intelligent experience perceived by users can be significantly enhanced. This is particularly suitable for scenes such as dual-apparatus linkage and interaction between couple apparatuses, the interactivity and differentiated competitiveness of the product are strengthened.

As an embodiment, the step of causing the second control module 201 to display the first data through the second display module 203 includes:
comparing, through the second control module 201, a timestamp in the first data with a first local timestamp, and updating the display data to cause display data of the second atomization apparatus 20 to be consistent with that of the first atomization apparatus 10 when the timestamp in the first data is later than the first local timestamp; and the first local timestamp corresponds to a time of a current display content of the second atomization apparatus 20.

In the embodiment, in order to ensure the accuracy and timeliness of data synchronization between the first atomization apparatus 10 and the second atomization apparatus 20, a timestamp comparison mechanism is adopted to determine whether the display content of the second atomization apparatus 20 needs to be updated. When the first control module 101 generates and sends the first data, it will attach a timestamp indicating the generation moment of the data (such as standard UTC time, apparatus local time, relative time count value, etc.) to the data to identify the timeliness of the data. After receiving the first data, the second control module 201 extracts the attached timestamp from the second control module 201 and compares the attached timestamp with the local timestamp currently stored. If the timestamp in the received first data is later than (i.e., updated or even later than) the local timestamp, it indicates that the data is updated data. At this point, the second control module 201 will update the local display content, display the latest first data through the second display module 203, and simultaneously update the local timestamp to the latest timestamp. If the timestamp of the received data is earlier than or equal to the local timestamp, it indicates that the data may be duplicate or delayed in arrival. At this point, in order to prevent old data from overwriting new content, the second control module 201 will ignore this data and not update the displayed content, ensuring that the current displayed content always remains up-to-date.

The technical effect of the embodiment lies in that: by introducing a timestamp comparison mechanism, which can effectively avoid the problems of display asynchronization or information rollback caused by network delay, repeated broadcasting or asynchronous transmission, thereby ensuring that the first atomization apparatus 10 and the second atomization apparatus 20 always maintain data consistency in the multi-apparatus linkage scene, and improving the reliability of the system and user experience.

As an embodiment, the step of performing the paired connection with the second atomization apparatus 20 through the first short-range wireless communication module 102 includes:
receiving a field signal sent by the second atomization apparatus 20 through the first short-range wireless communication module 102; receiving an activation signal sent by the first short-range wireless communication module 102; controlling the first atomization apparatus 10 to enter an activated state from a dormant state based on the activation signal; and sending, in a case where the first atomization apparatus 10 is in the activated state, a response signal to the second atomization apparatus 20 through the first short-range wireless communication module 102, and the response signal is configured to indicate establishing a communication connection between the first atomization apparatus 10 and the second atomization apparatus 20.

In the embodiment, by default, the first short-range wireless communication module 102 of the first atomization apparatus 10 is in a low-power dormant mode, retaining only the receiving function. When the second atomization apparatus 20 is in the paired active mode, the second short-range wireless communication module 202 of the second atomization apparatus 20 will periodically send the field signal to detect whether there are pairable apparatuses around the second atomization apparatus 20. After detecting the on-site signal, the first short-range wireless communication module 102 determines that the signal is a valid pairing request and then receives the activation signal sent by the second atomization apparatus 20. The activation signal is used to wake up the first atomization apparatus 10, switching the first atomization apparatus 10 from the dormant state to the activated state and preparing to enter the communication interaction process. When the first control module 101 successfully switches from the dormant state to the activated state, the first control module 101 drives the first short-range wireless communication module 102 to send a response signal to the second atomization apparatus 20, indicating that the first atomization apparatus 10 has completed the preparation and begun paired communication.

The technical effect of the present embodiment lies in that: by combining passive monitoring with active wake-up, the standby power consumption of the first atomization apparatus 10 is effectively reduced. At the same time, it ensures that it can be quickly awakened and a pairing connection established when needed, which not only guarantees the response speed but also improves the overall energy efficiency and user experience of the system.

As an embodiment, the first control module is connected to a first display module; and the step of performing data transmission with the second atomization apparatus 20 and the synchronously displaying the data with the second atomization apparatus 20 includes:
receiving second data sent by the second atomization apparatus 20 through the first short-range wireless communication module 102; and synchronously displaying the second data with the second atomization apparatus 20 through the first display module 103.

In the embodiment, after the first short-range wireless communication module 102 is in the communication connection state, it can receive the second data sent by the second atomization apparatus 20. The second data may include the working state, usage parameters, animation effects, current configuration, etc. of the second atomization apparatus 20, which are used for linked display on the first atomization apparatus 10. After receiving the second data, the first control module 101 parses the display content contained therein and controls the connected first display module 103 to update the information, ensuring that the displayed content is consistent with that on the second atomization apparatus 20. For example, when the power level or animation display state of the second atomization apparatus 20 changes, the second control module 201 sends this state to the first atomization apparatus 10 in the form of second data. After receiving the second data, the first atomization apparatus 10 immediately updates its own display interface, thereby achieving synchronization and consistency in visual feedback between the two apparatuses.

The technical effect of the embodiment lies in that: this step achieves data synchronization and display linkage from the second atomization apparatus 20 to the first atomization apparatus 10, enabling bidirectional display synchronization between the two apparatuses. This enhances the interaction flexibility of the system and user experience consistency, making it particularly suitable for dual-apparatus scenes with peer-to-peer interaction requirements (such as couple atomization apparatuses, shared apparatuses, etc.), and the sense of collaboration and the level of intelligence of the product are enhanced.

As an embodiment, the step of synchronously displaying the second data through the first display module 103 and the second atomization apparatus 20 includes:
comparing a timestamp in the second data with a second local timestamp, and updating displayed data to cause display data of the second atomization apparatus 20 to be consistent with that of the first atomization apparatus 10 when the timestamp in the second data is later than the second local timestamp; and the second local timestamp corresponds to a time of a current display content on the first atomization apparatus 10.

In the embodiment, in order to ensure that the first atomization apparatus 10 can correctly synchronously display the second data with the second atomization apparatus 20, a timestamp comparison mechanism is adopted to determine whether the display content needs to be updated. After the first control module 101 receives the second data sent by the second atomization apparatus 20 through the first short-range wireless communication module 102, the first control module 101 will extract the attached timestamp information from this data. This timestamp is used to identify the generation time of the second data. The first control module 101 compares the timestamp in the second data with the second local timestamp recorded internally by the current apparatus. This second local timestamp indicates the data time corresponding to the current display content of the first atomization apparatus 10. When the timestamp in the second data is later than (i.e., updated or even later than) the second local timestamp, it indicates that the received data is newer. At this point, the first control module 101 will control the first display module 103 to update the display content so that the display content of the first atomization apparatus 10 is consistent with that of the second atomization apparatus 20, and simultaneously update the second local timestamp to this latest timestamp. If the timestamp in the second data is earlier than or equal to the second local timestamp, the first control module 101 will determine that the data is duplicate or delayed and will not process it to prevent the old data from overwriting the newly displayed content.

The technical effect of this implementation mode lies in that: by adopting a timestamp comparison mechanism, the first atomization apparatus 10 can intelligently determine the timeliness of the second data, avoiding display errors caused by delayed or redundant data, the accuracy and timeliness of display synchronization between the two apparatuses are effectively ensured, and the stability of interaction linkage and the consistency of user experience are enhanced.

As an embodiment, the first control module 101 is connected to the first display module 103, and the second atomization apparatus 20 includes the second control module 201, the second short-range wireless communication module 202, and the second display module 203; the step of performing data transmission with the second atomization apparatus 20, and synchronously displaying the data with the second atomization apparatus 20 includes:
displaying third data through the first display module 103 while simultaneously displaying fourth data sent from the second atomization apparatus 20; and sending the third data to the second short-range wireless communication module 202 through the first short-range wireless communication module 102, causing the second control module 201 to simultaneously display both the third data and the fourth data through the second display module 203.

In the embodiment, in order to enhance the interactivity and visual linkage experience between the first atomization apparatus 10 and the second atomization apparatus 20, it supports the simultaneous display of data content from both apparatuses and achieves bidirectional synchronization, specifically including the following steps: the third data is the local data content generated by the first atomization apparatus 10, such as the atomization gear, battery level, usage time, animation style, etc. of the atomization apparatus. The first control module 101 presents the third data to the user through the first display module 103. Meanwhile, the second atomization apparatus 20 generates the fourth data (such as its own working state, configuration parameters or user identification, etc.) through the second control module 201 of the second atomization apparatus 20, and sends the fourth data to the first atomization apparatus 10 through the second short-range wireless communication module 202. After receiving the fourth data, the first control module 101 also displays the fourth data on the first display module 103, enabling the first atomization apparatus 10 to simultaneously display local data and data from remote apparatuses. In order to achieve bidirectional synchronization, the first control module 101 will also send the third data to the second short-range wireless communication module 202 of the second atomization apparatus 20 through the first short-range wireless communication module 102. After receiving the third data, the second control module 201 displays the third data together with the fourth data generated locally through the second display module 203. The display modules of both atomization apparatuses simultaneously display the third data and the fourth data, achieving content intercommunication and two-way visualization. For example, two apparatuses can respectively display the usage state of their own and each other apparatuses, creating a collaborative or interaction usage scene (such as showing power or ICONS between couple apparatuses), enhancing the product interesting and the emotional connection between users.

The technical effect of the embodiment lies in that: by achieving bidirectional transmission and synchronous display of the third data and the fourth data between two apparatuses, the system can realize real-time interaction, information sharing and bidirectional display, significantly enhancing the perceptual connection between users and the intelligent interaction experience of the product. It is particularly suitable for scenes such as couple sharing apparatuses, parent-child interaction apparatuses or multi-user collaborative apparatuses.

As an embodiment, the step of simultaneously displaying the fourth data sent by the second atomization apparatus 20 includes:
comparing a timestamp in the fourth data with a second local timestamp, and updating a display data to cause the display data of the first atomization apparatus 10 to be consistent with that of the second atomization apparatus 20 when the timestamp in the fourth data is later than the second local timestamp; and the second local timestamp corresponds to a time of a current display content of the first atomization apparatus 10.

As an embodiment, in order to ensure that the fourth data displayed by the first atomization apparatus 10 (i.e., the data sent by the second atomization apparatus 20) is always up-to-date and consistent with the second atomization apparatus 20, the system introduces a timestamp comparison mechanism. This mechanism is used to determine whether to update the display content of the fourth data. The specific steps are as follows: when the first control module 101 receives the fourth data sent by the second atomization apparatus 20 through the first short-range wireless communication module 102, it will extract the attached timestamp information from the data. This timestamp indicates the time when the fourth data was generated in the second atomization apparatus 20. The first control module 101 maintains a second local timestamp of a local record, which is used to represent the time version of the fourth data currently displayed in the first display module 103. If the timestamp in the fourth data is later than (i.e., updated to) the second local timestamp, it indicates that the fourth data is a newer version. At this point, the first control module 101 will update the display content through the first display module 103 to show the latest fourth data, and at the same time update the second local timestamp to this timestamp. If the timestamp in the fourth data is earlier than or equal to the second local timestamp, it indicates that the data is outdated or duplicate. In order to prevent the old data from overwriting the newly displayed content, the first control module 101 will ignore this data and not perform display updates.

The technical effect of the embodiment lies in that: by introducing a timestamp comparison mechanism before display updates, it can effectively avoid display errors or content rollback caused by data transmission delay or repeated sending, ensuring that the first atomization apparatus 10 always displays the latest data content synchronized with the second atomization apparatus 20; it has enhanced the accuracy and reliability of display synchronization, especially suitable for dual-apparatus interaction scenes that require high real-time performance and display consistency.

As an embodiment, the step of causing the second control module 201 to simultaneously display the third data and the fourth data through the second display module 203 includes:
displaying, through the second control module 201, the fourth data through the second display module 203, and comparing a timestamp in the third data with a first local timestamp, updating display data to cause display data of the second atomization apparatus 20 to be consistent with that of the first atomization apparatus 10 when the timestamp in the third data is later than the first local timestamp; and the first local timestamp corresponds to a time of a current display content of the second atomization apparatus 20.

In the embodiment, in order to achieve bidirectional display synchronization between the first atomization apparatus 10 and the second atomization apparatus 20, when the second control module 201 controls the second display module 203 to display data, the following method is adopted: the second control module 201 first controls the second display module 203 to display the locally generated fourth data (such as the power level, battery state, icon, etc. of the second device) of the second display module 203, ensuring that its own state is visualized in the display interface. Meanwhile, the second control module 201 receives the third data (such as the state information of the first device, interaction parameters, etc.) from the first atomization apparatus 10 through the second short-range wireless communication module 202. This third data is accompanied by a timestamp of the generation time. The second control module 201 compares the timestamp in the third data with the first local timestamp of the local record, the first local timestamp represents the time version of the third data currently displayed on the second display module 203 (i.e., the data from the first apparatus). If the timestamp in the third data is later than the first local timestamp, it indicates that the third data is the latest version. At this time, the second control module 201 will update the data part related to the first apparatus in the second display module 203, that is, it will replace the original data with the third data and synchronously update the first local timestamp. If the timestamp is earlier than or equal to the current first local timestamp, it indicates that the data is outdated or duplicate, and no update will be performed to prevent old data from overwriting new content. The second display module 203 displays the local fourth data together with the latest third data from the first apparatus, so as to achieve bidirectional display synchronization.

The technical effect of the embodiment lies in that: by introducing a judgment mechanism for the timestamp of the third data in the second atomization apparatus 20, it can effectively prevent display rollback or information errors caused by old data, ensuring that the information of the first apparatus displayed by the second d apparatus is always the latest, achieving dual-terminal consistency, interaction reliability and system stability. This mechanism has significant application value in scenes such as multi-apparatus collaborative use, user identity binding, or remote interaction.

As an embodiment, the step of synchronously displaying data with the second atomization apparatus 20 includes:
synchronously displaying flavor parameters, power level information, and usage records with the second atomization apparatus 20, in which the flavor parameters refer to a type of atomization liquid currently used, a flavor name, a concentration level, or output power configuration of both the first atomization apparatus 10 and the second atomization apparatus 20, the power level information refer to the current power level states of both the first atomization apparatus 10 and the second atomization apparatus 20, and the usage records refer to data related to usage behaviors of both the first atomization apparatus 10 and the second atomization apparatus 20.

In the embodiment, in order to enhance the data interoperability and user experience consistency between the first atomization apparatus 10 and the second atomization apparatus 20, after the first control module 101 establishes a communication connection with the second atomization apparatus 20 through the short-range wireless communication module, the following contents can be synchronously displayed: the flavor parameters refer to the set values related to the user smoking experience, such as the type of atomization liquid currently used, the flavor name, the concentration level, or the output power configuration, etc. By transmitting this parameter from the second atomization apparatus 20 to the first atomization apparatus 10, users can view or compare the flavor configuration of the two apparatuses in real time on the first display module 103, and the personalization and interactivity are enhanced. The battery power information refers to the current battery power state of the first atomization apparatus 10 or the second atomization apparatus 20, including the remaining power percentage, and battery voltage, etc. After this information is synchronized to the first apparatus, the first control module 101 controls the first display module 103 to display this information, allowing users to simultaneously monitor the battery state of two apparatuses on one apparatus, facilitating the determination of whether charging or replacement is needed. The usage records refer to data related to the usage behavior of the apparatus, including total suction times, last usage time, daily/weekly usage statistics, etc. After these data are synchronized to the first atomization apparatus 10, which can help users track the usage habits, conduct health assessments, or compare interactions (such as the frequency of mutual viewing and usage between couple apparatuses, etc.), enhancing the playability and stickiness of the apparatus.

The technical effect of the embodiment lies in that: by synchronously displaying flavor parameters, battery information and usage records, the first atomization apparatus 10 can not only achieve information sharing with the second atomization apparatus 20, but also provide a complete interaction experience on a single interface. This multi-dimensional and multi-parameter data synchronization mechanism significantly enhances the sense of interaction among apparatuses and comprehensive perception of the users to the apparatus state, which is particularly suitable for application scenes that require two-way display, state monitoring, or social interaction.

As an embodiment, the step of synchronously displaying data with the second atomization apparatus 20 further includes:
synchronously displaying the animation effect with the second atomization apparatus 20.

In the embodiment, in order to further enhance the visual consistency and interactivity of the user experience, the first control module 101 can also synchronously display animation effects with the second atomization apparatus 20, specifically including the following contents: the animation effects may include but are not limited to breathing light flashing, dynamic simulation of atomization process, heartbeat rhythm animation, festival-themed animation, user identity icon animation, etc. These animations can be preset in the firmware of the atomization apparatus or dynamically generated by the control module based on real-time data. When the second atomization apparatus 20 starts to display a specific animation effect (such as the “halo diffusion” animation triggered when smoking, or the “heartbeat synchronization” animation in couple mode), the second control module 201 of the second atomization apparatus 20 will send the current animation status and its parameters (such as type, start time, duration, playback progress, etc.) to the first atomization apparatus 10 through the second short-range wireless communication module 202. After receiving the animation data, the first control module 101 parses the animation data and controls the first display module 103 to play the animation effect synchronously along the same timeline and parameters, ensuring that the visual movements of the two apparatuses are exactly the same. In order to ensure that the animation playback is completely synchronized, the system can calibrate the starting point and playback rhythm of the animation through a timestamp mechanism or a unified trigger signal, thereby avoiding visual desynchronization.

The technical effect of the embodiment lies in that: by synchronously displaying the animation effect with the second atomization apparatus 20, the first atomization apparatus 10 can achieve highly consistent dynamic feedback with the second atomization apparatus 20 at the visual level, enhancing the interaction atmosphere among multiple apparatuses and the interesting of the product. It is particularly suitable for usage scenes such as couple sharing devices, social interaction apparatuses, and multi-person linkage modes. This visual linkage solution not only enhances the immersion of user experience but also provides a rich creative space for brand design.

As an embodiment, after the first atomization apparatus 10 and the second atomization apparatus 20 complete the short-range wireless pairing connection, the first atomization apparatus 10 and the second atomization apparatus 20 can automatically call the specific animation effect in the preset emotional animation library according to the current usage state, so as to achieve interlinked display.

The emotional animation library includes but is not limited to the following animation types:

Heartbeat Synchronization animation: display interfaces of the two apparatuses present a heart-shaped pattern with a consistent rhythm, which is used in the resonance mode for couple users.

Handshake light effect animation: when two apparatuses approach each other for pairing, the screen displays a gradually brightening animation at both ends, simulating the ritualistic feeling of a “handshake connection”.

Smoke concentration change animation: as the frequency of the smoking or the intensity of the suction of the apparatus changes, the density and flow speed of the smoke pattern displayed on the screen change, enhancing the visual expressiveness.

Breathing light synchronization animation: when the apparatus is in standby mode, a soft halo flickers to simulate the breathing rhythm; after successful pairing, the light effects of the two apparatuses are consistent.

After the user performs the inhalation operation on the first atomization apparatus 10, the first control module 101 will generate animation instruction data based on parameters such as inhalation intensity, frequency, and the current animation mode. This animation instruction data includes fields such as animation type identification, color, duration, rhythm curve, and timestamp, etc. Then, the first short-range wireless communication module 102 sends the animation instruction data in real time to the second short-range wireless communication module 202 of the second atomization apparatus 20. After receiving this instruction, the second control module 201 will play the corresponding animation on the second display module 203, keeping the display effects of the two apparatuses dynamically consistent. In order to ensure the synchronization of animation playback, the animation instruction data contains standardized timestamp information. The second control module 201 can correct the delay of animation playback by comparing with the local timestamp, ensuring that the animation effect rhythm of the two apparatuses is unified and the form is harmonious in the visual perception of the user.

The technical effect of the embodiment lies in that: it is possible to share and synchronously play dynamic visual effects with emotional color between two apparatuses through the emotional animation library and the linked dynamic display mechanism provided in the embodiment. This not only enhances the interesting and interactivity when multiple apparatuses are collaborating, but also meets the emotional expression and immersive experience needs ofusers such as couples and friends, and increases the social value and user stickiness of the apparatuses.

As an embodiment, the first atomization apparatus 10 not only realizes automatic pairing and data synchronization with the second atomization apparatus 20 through the short-range wireless communication module 102, but also introduces a user-active interaction trigger mechanism, supporting multiple trigger methods based on gesture recognition and voice recognition, thereby initiating data synchronization and animation linkage.

The first atomization apparatus 10 integrates a acceleration sensor and/or a gyroscope module. The first control module 101 can collect and analyze signals from these sensors to determine whether the user has performed the following actions:

Double-click or tap the apparatus: it is determined as a “Request Synchronization” command, triggering the short-range broadcast connection process with the second atomization apparatus 20.

Quickly shake the apparatus once: it is used to activate emotional animations (such as heartbeat, smoke linkage).

Horizontal rotation of 180°: entering specific interaction modes, such as switching between couple interaction interfaces and synchronously comparing usage data, etc.

For example, when a user taps the body of the first atomization apparatus 10 twice, the first control module 101 recognizes this gesture and controls the first short-range wireless communication module 102 to send a pairing broadcast signal. Once the pairing is successful, the current animation or display parameters is automatically synchronized to the second atomization apparatus 20.

The first atomization apparatus 10 is integrated with a voice recognition module supporting local voice command parsing. Users can trigger the following functions by issuing oral commands such as “Synchronize”, “Display Animation”, “Connect couple”, etc.: initiating a pairing connection with the second apparatus; specifying the type of synchronized data (such as only synchronizing flavor parameters and not synchronizing usage records); activating the animation module and selecting the animation type (for example, say “Heartbeat” to start the heartbeat animation). The voice input is collected by the built-in microphone and then transmitted to the first control module 101. It is combined with the local voice recognition algorithm for intent recognition and instruction extraction. The recognition results are then executed as synchronous instructions. In order to prevent false triggering or background noise interference, the system can be set up with a keyword wake-up mechanism or a user confirmation mechanism.

The technical effect of the embodiment lies in that: users are supported to trigger data synchronization and animation linkage between apparatuses through natural physical actions (such as knocking, swinging) or voice commands, the traditional button control and passive waiting mechanism are eliminated to achieve a more immersive, intelligent and human-machine friendly operation mode. This interaction method is particularly suitable for mobile scenes, couple interaction and contactless control requirements, significantly enhancing the market appeal of the product.

As an embodiment, the embodiment provides a method for data transmission based on a permission control mechanism, which is applicable during the linkage process between the first atomization apparatus 10 and the second atomization apparatus 20, to achieve selective sharing and display of different types of data and enhance the ability to protect user privacy.

The first atomization apparatus 10 is provided with a permission setting module, which is executed by the first control module 101 and is used to configure the permissions for the data synchronization content. Users can select different data synchronization levels through the device display interface, mobile App or voice interaction. The permissions include but are not limited to the following types: only allowing the synchronization display of apparatus state, such as power level and connection state; allowing synchronization including flavor parameters, battery information, and animation effects; the synchronization of sensitive data such as records, usage frequency, and animation playback history being prohibited; specific animation data being transmitted in encrypted form and can only be decoded and displayed when communicating with the “bound paired device”, and other apparatuses cannot parse the animation content.

When the first control module 101 is ready to send synchronization data to the second atomization apparatus 20, it will attach a permission identification field in the data packet, the field indicates which synchronization level the data belongs to. The field may include: data types (such as animation, flavor, battery level); access level (such as public, restricted, private); decoding requirements (whether to bind authentication, whether to encrypt transmission); timestamp and validity period information (such as temporary authorization for 1 hour). After the second atomization apparatus 20 receives the synchronous data, the second control module 201 of the second atomization apparatus 20 will parse the permission identifier based on the local permission policy and decide whether to receive, display or reject the relevant data. For example, if the received data type is usage records but the local area is in privacy mode, it can be directly ignored; if the received animation is encrypted and has not been paired and bound with the first apparatus, it will prompt that the permission is insufficient and the animation content will not be displayed.

The technical effect of the embodiment lies in that: by introducing a permission setting mechanism and a data classification synchronization strategy, the embodiment can effectively achieve hierarchical sharing and controlled access of different data, which solves the problem of excessive exposure of user information in the synchronization function of traditional atomization apparatus; especially in scenes such as couples, close contact with strangers, and multiple people sharing apparatuses, it can significantly enhance the security, trustworthiness, and user privacy protection experience of the apparatuses, and has extremely high application value and commercial implementation potential.

### Embodiment 3

First, some of the terms used in the embodiments of the present application are explained and clarified to facilitate the understanding of those skilled in the art.

The Near Field Communication (NFC) module is a short-range high-frequency wireless communication technology module that can achieve functions such as data exchange between devices that support NFC.

The interaction instruction information is a type of data information sent by one apparatus to another apparatus during the interaction process between apparatuses to convey specific operational requirements, intentions, or state changes, etc.

The atomization apparatus is a small electronic device that can convert liquid substances into mist particles that can be inhaled.

The above is a brief introduction to the terms involved in the embodiments of the present application, which will not be further repeated below.

The present application provides an example of an interaction control method, as an example rather than a limitation, which can be applied to or run in an atomization apparatus. It is understandable that atomization apparatus converts liquid substances (such as drug solutions, etc.) into tiny particles suspended in the air through specific technical means, such as heating, ultrasonic vibration, and pressure changes, to form aerosols.

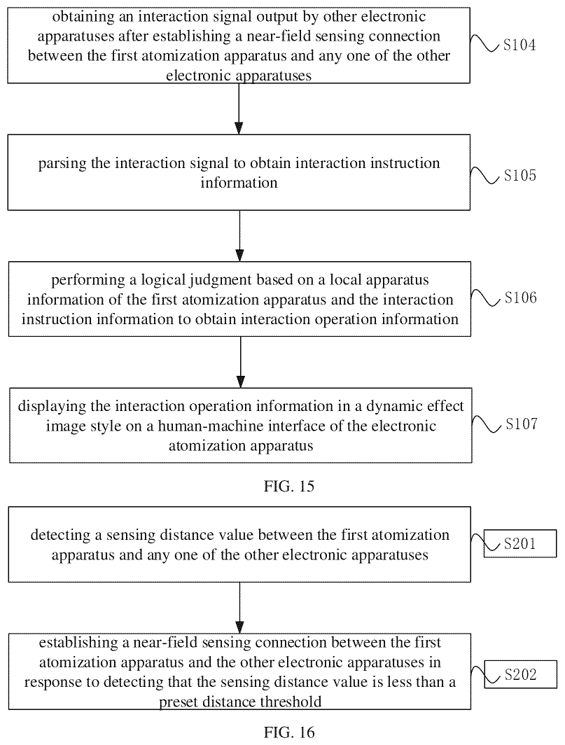

As shown in FIG. 15, which shows a schematic flowchart of a method for data transmission provided in the present application, and the method includes:

S104, obtaining an interaction signal output by other electronic apparatuses after establishing a near-field sensing connection between the first atomization apparatus and any one of the other electronic apparatuses.

S105, parsing the interaction signal to obtain interaction instruction information.

S106, performing a logical judgment based on a local apparatus information of the first atomization apparatus and the interaction instruction information to obtain interaction operation information, and the interaction operation information comprises at least one selected from a group consisting of an interaction scene, an interaction mode, an interaction state, an interaction duration, and an interaction prompt.

S107, displaying the interaction operation information in a dynamic effect image style on a human-machine interface of the first atomization apparatus.

In the example of the present application, the atomization apparatus (hereinafter referred to as the local apparatuses) and other electronic apparatuses all have near-field communication capabilities. As examples rather than limitations, other electronic apparatuses (hereinafter referred to as the opposing apparatus) can also be atomization apparatuses or other apparatuses that support similar interactions, such as smart phones, smart watches, etc.

In the example of the present application, both the first atomization apparatus and other electronic apparatuses are equipped with near-field communication modules (such as NFC modules, Bluetooth modules, etc., which can achieve communication within the near-field range), as well as antennas that are matched with the near-field communication modules. When the first atomization apparatus and other electronic apparatuses approach each other to the effective sensing distance (usually determined by the preset distance threshold, for example, the effective sensing distance value can be within 0-10 cm), the near-field communication modules of the first atomization apparatus and other electronic apparatuses start to detect the signals emitted by the opposing apparatus through antennas in an attempt to establish a near-field sensing connection.

Taking the near-field communication module as the NFC communication module as an example, when any one of the other electronic apparatuses approaches the first atomization apparatus, the antenna of the NFC communication module senses the change in the magnetic field emitted by the NFC antenna of the opposing apparatus. Through the principle of electromagnetic induction coupling, the two apparatuses start to communicate and shake hands and mutually identify the relevant information (such as device ID identifiers, etc.) of each other. If the identification is successful and other preset conditions are satisfied (such as the device being in the interaction state, etc.), the near-field induction connection between the first atomization apparatus and any one of the other electronic apparatuses is successfully established. Moreover, the first atomization apparatus is set according to the preset parameters such as receiving frequency and bandwidth to continuously obtain radio frequency signals from other electronic apparatuses, and demodulate, filter and other processes the received radio frequency signals to convert them into interaction signals in the form of digital signals.

In the example of the present application, the first atomization apparatus is pre-designed and stores the preset interaction protocol and preset coding rules related to the apparatus interaction. Therefore, the first atomization apparatus can adopt preset interaction protocols and preset coding rules to parse the above interaction signals and obtain interaction instruction information, such as “Adding friends”, “Sharing Experience”, “Inviting Games”, “Social Interaction”, “Device Collaboration”, “Share configuration”, etc.

For example, the above-mentioned protocols and rules stipulate the specific format of the interaction signal as well as the meanings and encoding methods of each part. For example, it is stipulated that the interaction signal consists of a header identifier, instruction content and verification portion, and the specific encoding formats of the header identifiers corresponding to different types of interaction signals, as well as the specific encoding formats of each parameter in the instruction content (such as the encoding of different battle modes like “time-limited battle” and “points Battle” in battle games, the encoding method of the ID of the opposing apparatus, etc.) are clearly defined.

Optionally, in the example of the present application, the first atomization apparatus acquires local apparatus information through various built-in sensors and storage modules, etc.

For example, the current power level value of the first atomization apparatus is obtained through a power level sensor, which is presented in the form of a percentage, etc., to determine whether the local apparatuses has sufficient power to perform subsequent possible interaction operations, such as some power-consuming game interactions, etc.

For example, the current atomization parameters of the first atomization apparatus, including an atomization concentration, an atomization flavor, an atomization duration, etc., can be obtained through the storage configuration module. It should be understood that when the current atomization parameters involve interactions such as sharing configuration with the opposing apparatus, the current atomization parameters can be used to determine whether they can be matched or coordinated with the configuration of the opposing apparatus.

For example, the current operating state of the apparatus can be obtained through the state monitoring module, such as normal operating state, an abnormal operating state, and firmware upgrade in progress, etc. If the local apparatus is in an abnormal operating state or undergoing firmware upgrade, it may affect the response capability to interaction instruction information, and this needs to be taken into account during logical judgment.

In social interaction scenes, if an interaction command message indicating “Invite game battle” is received, and the power level of the local apparatus is higher than a certain threshold (such as 30%), and the current atomization parameters are within a reasonable range (such as the atomization concentration not exceeding a certain preset value to avoid affecting the interaction game effect), and the apparatus is not in an abnormal operating state such as undergoing firmware upgrade or troubleshooting, it will be determined that the game interaction invitation can be accepted. Otherwise, it will be determined that the game interaction invitation is rejected.

In another example, if the received interaction instruction information indicates “sharing configuration”, and if the current atomization parameters of the local apparatus do not differ much from the requirements in the received sharing configuration instruction (a specific allowable range of differences can be preset), then directly adjust the configuration of the local apparatuses according to the instruction, and generate corresponding dynamic effect display images to show the adjustment or change of the configuration. If the current atomization parameters of the local apparatuses differ significantly from the requirements in the received sharing configuration instruction, the user will be prompted to confirm further before deciding whether to adjust the apparatus configuration.

Further, in the example of the present application, the first atomization apparatus simultaneously inputs the obtained local apparatus information and the parsed interaction instruction information into the logic judgment module (this module can be the built-in software program of the apparatus or the logic processing unit in the chip, etc.). The logic judgment module conduct a comprehensive and integrated analysis and processing of these two sets of information in accordance with the preset logic judgment rules. For example, for each received interaction instruction, it is checked one by one whether the conditions of the local apparatus meet the requirements for executing the interaction instruction to determine the interaction operation information as shown in one of the followings: the interaction scene, the interaction mode, the interaction state, the interaction duration, and the interaction prompt.

In one example, if it is determined that the first atomization apparatus accepts the “Invite game battle” instruction, the interaction operation information may include: entering the battle preparation state and adjusting the display animation effect of the human-machine interaction UI interface to the battle related style (such as showing the battle countdown, comparing the battery levels of both apparatuses, etc.). For example, the controller sets the battle related parameters (such as setting the initial atomization concentration according to the requirements of the opposing apparatus, etc.). At this point, the interaction scene is a “game battle scene”, the interaction mode is “Time-limited game battle” (assuming the battle mode specified in the game battle invitation command is time-limited battle), the interaction state is “Prepare for Game Battle”, and the interaction duration can be set according to the battle mode (for example, for time-limited battle, there is a specific time-limited duration), and the interaction prompt can be “Accepted battle invitation and Ready to start the battle.”

For example, in another example, if it is determined that the first atomization apparatus refuses the “Inviting game battle” command, the interaction operation information may include: the interaction scene is “game battle scene”, the interaction mode is “Time-limited Game Battle” (assuming the battle mode specified in the game battle invitation command is time-limited battle), the interaction state is “Reject Battle Invitation”, the interaction duration is “None” (because the game battle state has not been entered), and the interaction prompt is “low power level or poor apparatus state, unable to accept battle invitation”.

In the software system or storage unit of the first atomization apparatus, various dynamic effect image styles for different interaction operation information scenes are pre-designed and stored. These styles are designed for different interaction scenes, interaction modes, interaction states, etc. For example:

In one example, for the “game battle scene”, the first atomization apparatus is pre-designed with ICONS of both apparatuses displayed in the center of the screen. The flashing frequency of the ICONS is adjusted according to the battle countdown, the comparison bar of the battery levels of both apparatuses is displayed below. The color of the power level bar gradually changes according to the power level and other dynamic effect image styles, etc.

In another example, for the “sharing configuration scene”, the first atomization apparatus is pre-designed with dynamic update charts on the screen that display the current atomization parameters of both parties (such as atomization concentration, atomization flavor, etc.), dynamic effect image styles such as different colors and dynamic arrows indicating the changes of parameters, and so on.

Based on the specific interaction operation information obtained through logical judgment, retrieve the corresponding dynamic effect image style from the storage module. For example, if the interaction operation information shows “accept the battle invitation and get ready to start the battle”, then retrieve the dynamic effect image style corresponding to the “Game battle scene”. Then, the display driver program and other related software and hardware components that control the human-machine interaction interface of the first atomization apparatus will display the retrieved dynamic effect image style in the predetermined way. For example, it is displayed according to the pre-designed rules such as the flashing frequency of ICONS and the color change of the power level bar, enabling users to intuitively see the specific situation represented by the interaction operation information on the human-computer interaction interface, thereby achieving a good human-computer interaction experience.

In one possible implementation, as shown in FIG. 16, which shows a schematic flowchart of an optional method for data transmission provided by the present application. The above method further includes:

S201, detecting a sensing distance value between the first atomization apparatus and any one of the other electronic apparatuses, and both the first atomization apparatus and the other electronic apparatuses are provided with: a near-field communication module and an antenna used in conjunction with the near-field communication module.

S202, establishing a near-field sensing connection between the first atomization apparatus and the other electronic apparatuses in response to detecting that the sensing distance value is less than a preset distance threshold.

Optionally, the setting of the preset distance threshold specifically takes into account multiple factors, such as the effective communication distance range of the near-field communication module (different modules can have different effective ranges, for example, the NFC communication module is generally effective within 10 cm), the convenience of interaction being desired in practical applications (if it is hoped that users can interact without deliberately bringing the device very close, the preset distance threshold can be set relatively larger), and avoiding accidental connection triggering (if the threshold is set too small, it might be due to the fact that the first atomization apparatus frequently establishes and disconnects after a slight shake, which affects the user experience), etc.

Since the first atomization apparatus and other electronic apparatuses interacting with the first atomization apparatus are all equipped with near-field communication modules (such as NFC communication modules, Bluetooth modules, etc., which can achieve communication within the near-field range) as well as corresponding antennas. During the operation of the near-field communication module, its signal strength changes with the variation of the distance from the opposing apparatus. Based on this characteristic, the sensing distance value between the local apparatuses and the opposing apparatus can be indirectly estimated by monitoring the changes in signal strength.

Taking the near-field communication module as the NFC communication module as an example, when the opposing apparatus and the local apparatus approach each other, the local apparatus detects that the magnetic field strength emitted by the antenna of the opposing apparatus will increase as the distance decreases (within a certain range). By setting up a signal strength monitoring circuit in the NFC communication module of the local apparatus, it is capable of obtaining in real time the intensity information of the magnetic field emitted by the antenna of the opposing apparatus that is currently received.

As an example, first, within the near-field communication module of the first atomization apparatus (assuming an NFC communication module as an example), there is a dedicated sensor or circuit section for detecting signal strength, which samples and measures the received signal strength at a certain frequency (such as at regular time intervals, For example, 100 milliseconds).

Then, the signal strength values obtained from each measurement are compared with the standard signal strength value tables corresponding to different distances that have been pre-calculated through experiments or theoretical calculations. For example, in a laboratory environment, the signal strength value range corresponding to the normal working state of the NFC communication module at different distances such as Ocm, 2 cm, 5 cm, 8 cm, and 10 cm has been measured, to form a standard signal strength value table. When the actual measured signal strength value falls within the range of the signal strength value corresponding to a certain distance, the sensing distance value between the current first atomization apparatus and other electronic apparatuses can be roughly obtained.

According to the specific application scenes of the first atomization apparatus and the performance characteristics of the near-field communication module, a suitable distance threshold is preset. When the detected sensing distance value is less than the preset distance threshold, the near-field communication module of the first atomization apparatus and other electronic apparatuses initiates the connection establishment process. For example, in cases where short-range interaction mainly relies on the NFC communication module and a convenient and fast interaction process is desired, the preset distance threshold can be set to 10 cm. This means that when the detected sensing distance value with other electronic apparatuses is less than 10 cm, it is considered that the two apparatuses are close enough to attempt to establish a near-field sensing connection for subsequent interaction operations.

Further taking the near-field communication module as the NFC communication module as an example, first, the NFC communication modules of both apparatuses send and receive some specific connection requests and confirmation signals again through the antenna. For example, one apparatus sends a connection request signal containing basic information such as its own apparatus ID. After receiving the connection request signal containing basic information, the other apparatus parses the signal. If it confirms that the opposing apparatus is interaction and is willing to interact with the local apparatus (which may involve checking the current state of the apparatus, such as whether it is in an interaction state, whether the battery is fully charged, etc.), then send a signal confirming the connection back to the opposing apparatus. After receiving the confirmation connection signal from each other, the two apparatuses officially establish a near-field induction connection and can start subsequent interaction operations such as obtaining interaction signals and parsing instructions.

Through the above-mentioned optional implementation methods, the detection of the sensing distance values between the first atomization apparatus and other electronic apparatuses is achieved, and a near-field sensing connection is established when the distance conditions are satisfied to facilitate subsequent interaction control.

In one possible implementation, the detection of the sensing distance value between the first atomization apparatus mentioned above and any one of the other electronic apparatuses, including:

The sensing distance value between the first atomization apparatus and any one of the other electronic apparatuses is detected through the near-field communication module in the above-mentioned first atomization apparatus, where the near-field communication module includes a Bluetooth communication module and/or a NFC communication module.

Optionally, in one example, taking the near-field communication module to be the Bluetooth communication module as an example. Since the wireless signal strength emitted by the Bluetooth communication module during operation gradually decreases as the distance from the receiving apparatus increases. Based on this characteristic, the sensing distance value between the first atomization apparatus and other electronic apparatuses can be estimated by measuring the received Bluetooth signal strength and combining the received Bluetooth signal strength with the known Bluetooth signal propagation model and related parameters.

For example, in the free-space propagation model, the strength of the Bluetooth signal is inversely proportional to the square of the distance. However, the actual application scenes are often rather complex, and there may be obstacles, interference sources, etc. Therefore, empirical propagation models that are more in line with the actual situation are usually adopted. These models are derived from a large number of actual tests and data statistical analysis, and can more accurately reflect the relationship between Bluetooth signal strength and distance in different environments.

In addition, in the Bluetooth communication module, a dedicated circuit or sensor for measuring the received Bluetooth signal strength can be equipped. The received Bluetooth signal strength can be sampled and measured at a certain frequency (for example, at regular time intervals, such as 50 milliseconds) to obtain the real-time signal strength value. The Bluetooth signal strength value measured each time is compared with the pre-determined Bluetooth signal propagation model and related parameters (such as the transmission power of the Bluetooth module and antenna gain, etc.). By substituting the actual measured signal strength values into the corresponding formulas of the propagation model, the sensing distance values between the first atomization apparatus and other electronic apparatuses can be estimated through calculation.

Optionally, in another example, taking the near-field communication module to be the NFC communication module as an example, the NFC communication module realizes near-field communication by relying on the principle of electromagnetic induction coupling. When two apparatuses equipped with NFC modules approach each other, the antennas of the two apparatuses interact through magnetic fields, and the intensity of the magnetic field changes with the distance. Within a certain distance range, the closer the distance, the stronger the magnetic field intensity. Based on this characteristic, it can be used to detect the sensing distance value.

In the NFC communication module of the first atomization apparatus, there is a sensor or circuit specifically designed to monitor the magnetic field strength around the antenna, and used for continuously monitoring changes in magnetic field strength and sampling and measuring the magnetic field strength at a certain frequency (such as every certain time interval, such as 100 milliseconds) to obtain real-time magnetic field strength values. By comparing the magnetic field strength values obtained from each measurement with the standard magnetic field strength values obtained through experiments or theoretical analysis at different distances in advance. For example, a standard table of magnetic field strength values has been formed by measuring the corresponding range of magnetic field strength values under normal working conditions at different distances of 0 cm, 2 cm, 5 cm, 8 cm, 10 cm, etc. When the actual measured magnetic field strength falls within the range of magnetic field strength values on a certain date, the current induction distance between the first atomization apparatus and other electronic apparatuses can be roughly estimated.

In practical applications, the first atomization apparatus can, based on its own design and requirements, independently use a Bluetooth communication module or an NFC communication module to detect the sensing distance value, or flexibly switch between these two modules in different scenes to achieve more accurate and efficient detection of the sensing distance value. This further provides an accurate distance judgment basis for establishing near-field sensing connections and subsequent interaction operations.

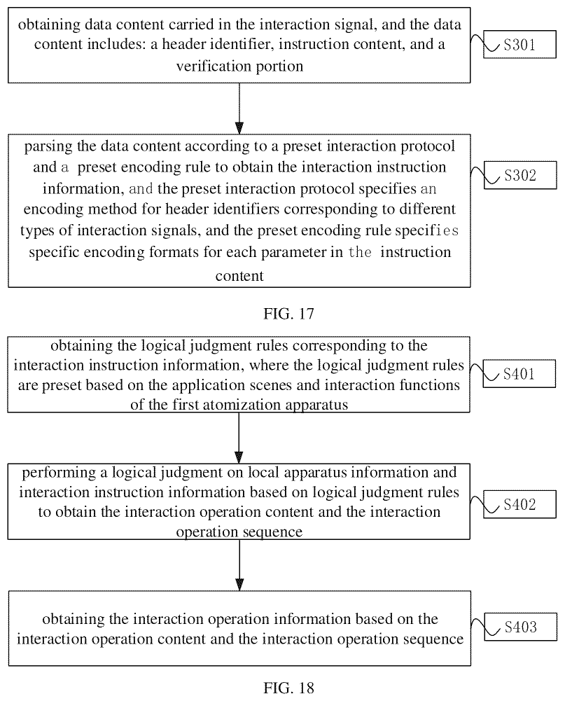

In one possible implementation, as shown in FIG. 17, which shows a schematic flowchart of an optional method for data transmission provided by the present application. The step of parsing interaction signal to obtain the interaction instruction information includes:

S301, obtaining data content carried in the interaction signal, and the data content includes: a header identifier, instruction content, and a verification portion.

S302, parsing the data content according to a preset interaction protocol and a preset encoding rule to obtain the interaction instruction information, and the preset interaction protocol specifies an encoding method for header identifiers corresponding to different types of interaction signals, and the preset encoding rule specifies specific encoding formats for each parameter in the instruction content.

Firstly, the first atomization apparatus receives interaction signals output by other electronic apparatuses through its built-in near-field communication module (such as NFC module or Bluetooth module, etc., depending on the specific communication method used to receive interaction signals) and the accompanying antenna. During the receiving process, this interaction signal may be interfered with by the surrounding environment, resulting in certain noise or deformation of the signal.

Therefore, after receiving the interaction signal, the interaction signal can be processed in advance. For example, filtering operations can be performed on the interaction signal to remove high-frequency or low-frequency interference noise, so that the signal is more accurate. The interaction signals is amplified to ensure that the signal strength reaches a level that can be effectively identified in the subsequent processing steps, and the interaction signals are shaped to convert irregular signal waveforms into standard waveforms that are easier to be processed, etc.

Furthermore, the data content of the preprocessed interaction signal can be extracted according to the established signal format. For example, the data content carried by the interaction signal includes the header identifier, the instruction content and the verification portion. Usually, these data portions are arranged in a certain order in the signal and can be distinguished by specific delimiters or markers. For example, the header identifier portion occupies the first few bits (such as the first 8 bits), followed by the instruction content portion (occupying the middle few bits, with the specific number of bits depending on different instruction types and parameter configuration), and finally the verification portion (occupying the last few bits, such as the last 16 bits). By identifying these delimiters or markers and based on the pre-determined lengths of each portion, the three data contents of the header identifier, instruction content and verification portion can be accurately extracted from the interaction signal.

Furthermore, in an example of the present application, the data content is parsed based on the preset interaction protocol and preset encoding rules to obtain the interaction instruction information. First, pay attention to the extracted header identifier portion. The preset interaction protocol stipulates the encoding methods of the header identifiers corresponding to different types of interaction signals.

For example, the first atomization apparatus pre-stores a header identifier code table, which details various possible interaction types (such as “inviting game battle”, “sharing configuration”, “checking the state of the opposing apparatus”, etc.) and their corresponding header identifier codes. For example, the header identifier code for “inviting game battle” can be the hexadecimal “0x11”, and the header identifier code for “Sharing configuration” can be “0x22”, etc. The first atomization apparatus will compare the header identifier extracted from the interaction signal with this code table. By finding the matching code, the specific interaction type represented by the interaction signal can be determined. For example, if the extracted header identifier is encoded as “0x11”, it can be determined that this interaction signal is an interaction signal used to issue a battle invitation.

Then, after determining the type of the interaction signal, the instruction content portion is parsed. The preset encoding rule stipulates the specific encoding format for each parameter in the instruction content.

Different types of interaction have different parameters contained in their instruction contents. Take “Inviting game battles” as an example. The instruction content content can include parameters such as the ID and the battle mode (such as time-limited battles, points-based battles, etc.) of the inviting party's apparatus. For the ID of the apparatus, there can be specific encoding formats, such as using hexadecimal encoding, and it is stipulated that the first few bits represent a certain attribute of the apparatus, and the last few bits represent another attribute, etc. For the battle mode, there are also corresponding encoding methods. For example, “Time-limited battle” is encoded as binary “01”, and “points-based battles” is encoded as “10”, etc.

According to these specific encoding formats, each parameter in the instruction content portion is decoded one by one to clarify the specific meaning of each parameter. For example, by decoding, it is known exactly which apparatus the ID of the inviting party's apparatus is and which battle mode is adopted in this battle, that is, the complete instruction content information can be obtained.

Finally, the verification portion is used to verify the entire parsing process. It should be understood that the function of the verification portion is to ensure that the interaction instruction information obtained through parsing is accurate and reliable. Optionally, the verification method is usually based on a pre-determined verification algorithm (which is also a part of the preset interaction protocol), to calculate the extracted data content such as the header identifier and instruction content, and obtain a verification value. Then, this verification value is compared with the verification value directly extracted from the verification portion of the interaction signal. If the two verification values are equal, it indicates that the parsing process is correct and the obtained interaction instruction information is reliable, which can be used for subsequent logical judgments and other operations. If the two verification values are not equal, it indicates that an error may have occurred during the parsing process. At this point, it is necessary to re-obtain and parse the interaction signal, or prompt the user that there is a signal transmission problem, etc.

Through the above method steps, the data content carried in the interaction signal can be accurately parsed according to the preset interaction protocol and preset coding rules, thereby obtaining complete interaction instruction information, which is convenient for subsequent logical judgment, generation of interaction operation information and other operations based on these instruction information.

In one possible implementation, the above-mentioned method also includes obtaining the local apparatus information of the above-mentioned first atomization apparatus through at least one of the following ways:
obtaining a current power level value of the first atomization apparatus through a power level sensor of the first atomization apparatus.
obtaining a current atomization parameter of the first atomization apparatus through a storage configuration module of the first atomization apparatus, and the current atomization parameter comprises at least one of followings: an atomization concentration, an atomization flavor, and an atomization duration.
obtaining a current operation state of the first atomization apparatus through a state monitoring module of the first atomization apparatus, and the current operation state comprises at least one of followings: a normal operation state, an abnormal operation state, and a firmware upgrade in progress.

In an optional example, the first atomization apparatus is equipped with a power level sensor inside to monitor the power level state. For example, by detecting parameters such as the voltage and current of the battery, and the remaining power level of the battery can be calculated based on the specific electrical characteristic curves of the battery (different types of batteries have their corresponding voltage-power level, current-power level, and other relationship curves).

For example, the voltage of a lithium-ion battery shows a certain variation pattern under different power level states. When the battery is fully charged, the voltage is within a relatively high and stable range. As the battery is consumed, the voltage gradually drops. The power level sensor can monitor the changes in the voltage in real time and convert the monitored voltage value into the corresponding percentage of power level value based on the voltage-power level correspondence table of the lithium-ion battery pre-stored in the apparatus (which is derived from extensive tests and data analysis based on the standard electrical characteristics of the battery), thereby obtaining the current power level value of the first atomization apparatus.

In another optional example, the storage configuration module of the first atomization apparatus is mainly used to store various configuration parameters of the apparatus by the user, such as the current atomization parameters. When users set parameters such as the atomization concentration, the atomization flavor, and the atomization duration through the human-machine interaction interface of the apparatus (such as by pressing buttons, touch screens, etc.), the first atomization apparatus stores these configuration values in the storage configuration module. For example, when a user adjusts the atomization concentration through the slider on the touch screen, the first atomization apparatus records the specific concentration value selected by the user (which can be expressed in digital form, such as a concentration value of 3 mg/ml, etc.) at the corresponding storage location in the storage configuration module.

In order to obtain the current atomization parameters, the relevant software program or control chip of the first atomization apparatus reads these parameter values from the storage configuration module at regular intervals (for example, at certain time intervals, such as 10 seconds). For the atomization concentration, directly read the concentration value recorded in the storage location. For atomization flavors, it is possible to read a code value representing the flavor (different flavors correspond to different codes, such as strawberry flavor being encoded as 01, mint flavor as 02, etc.), and then convert it into a specific flavor name based on the pre-stored flavor code table. For the atomization duration, the duration value recorded in the storage location is also read (for example, if the atomization duration is set to 5 minutes, the value read will be 5).

In another optional example, the state monitoring module of the first atomization apparatus is composed of multiple sensors and related monitoring circuits, which is used to comprehensively monitor the operating state of the apparatus. For example, it can include temperature sensors to monitor the temperature conditions of key components (such as atomization cores, etc.) inside the apparatus. It can also include some circuit condition monitors to detect whether the apparatus circuit is working properly and whether there are any abnormal conditions such as short circuits or open circuits.

For example, a temperature sensor monitors the temperature of the atomization core in real time. When the temperature of the atomization core exceeds a certain safety threshold (which is determined based on the design of the apparatus and the material properties, such as the temperature is set at 80° C.), it indicates that the apparatus is in an abnormal operating state. The state monitoring module constantly detects parameters such as current and voltage in the circuit. If it detects sudden interruption of current or abnormal fluctuations in voltage, it can also determine that there may be a problem with the first atomization apparatus.

The state monitoring module in the first atomization apparatus can be used to comprehensively analyze the information collected by various sensors and monitoring circuits. For example, if the temperature detected by the temperature sensor is within the normal range (such as below 80° C.), and the state monitoring module detects that the circuit is working properly, it can be determined that the first atomization apparatus is in a normal operating state. If the temperature detected by the temperature sensor exceeds the safety threshold, or if the state monitoring module detects abnormal conditions in the circuit (such as short circuit, open circuit, etc.), it can be determined that the first atomization apparatus is in an abnormal operating state.

Additionally, when the first atomization apparatus is undergoing firmware upgrade, a specific upgrade state identifier (which can be a binary value stored at a specific location, such as 0 indicating no upgrade and 1 indicating upgrade in progress) is set inside the first atomization apparatus. The state monitoring module reads this identifier value to determine whether the first atomization apparatus is undergoing firmware upgrade.

Through these different implementation methods, the first atomization apparatus can accurately obtain local apparatus information, including the current power level value, current atomization parameters, and current operating state, etc., so as to facilitate subsequent logical judgments and generation of interaction operation information based on interaction instruction information.

In one possible implementation, as shown in FIG. 18, which shows a schematic flowchart of an optional method for data transmission provided by the present application. Based on the local apparatus information of the first atomization apparatus and the interaction instruction information mentioned above, logical judgment is made to obtain the interaction operation information, including:

S401, obtaining the logical judgment rules corresponding to the interaction instruction information, where the logical judgment rules are preset based on the application scenes and interaction functions of the first atomization apparatus.

S402, performing a logical judgment on local apparatus information and interaction instruction information based on logical judgment rules to obtain the interaction operation content and the interaction operation sequence.

S403, obtaining the interaction operation information based on the interaction operation content and the interaction operation sequence.

Optionally, in one example, during the development of the first atomization apparatus, a series of comprehensive and reasonable logical judgment rules are preset based on its expected application scenes (such as social interaction scenes, apparatus collaboration scenes, etc.) and the interaction functions to be realized (such as game interaction functions, game battle functions, sharing configuration functions, etc.).

For example, in a social interaction scene, if the interaction function of “inviting game battles” is set up, the corresponding logical judgment rule could be: if the power level of the local apparatus is higher than a certain threshold (such as 30%), the current atomization parameters are within a reasonable range (such as the atomization concentration not exceeding a certain set value to avoid affecting the interaction game effect), and the apparatus is not in a special state (such as undergoing firmware upgrade, troubleshooting, etc.), then it is determined that the first atomization apparatus can accept the game battle invitation, otherwise, it is determined as a rejection of the game battle invitation.

For example, in a social interaction scene, for the sharing configuration function, the corresponding logical judgment rule could be: if the current atomization parameters of the local apparatus do not differ much from the requirements in the received sharing configuration instructions (a specific allowable range of difference can be set), then directly adjust the configuration of the local apparatus according to the instructions and generate the corresponding dynamic effect display image to reflect the changes in the configuration. If the differences are significant, the user will be prompted to confirm further before deciding whether to adjust the configuration.

Optionally, these preset logical judgment rules are stored in the storage unit (such as flash memory, etc.) of the first atomization apparatus, and an effective indexing mechanism is established to enable the rapid identification of the corresponding logical judgment rules based on the received interaction instruction information. For example, an index directory can be established based on the type of interaction instructions (such as “Inviting game battle”, “Sharing configuration”, etc.). After receiving a specific interaction instruction information, by looking up this index directory, the corresponding logical judgment rule can be quickly located, thus preparing for subsequent logical judgment operations.

Based on the logical judgment rules to perform the logical judgment on the local apparatus information and the interaction instruction information to obtain the interaction operation content and the interaction operation sequence. For example, the local apparatus information of the first atomization apparatus obtained (including the current power level value, current atomization parameters, current operating state, etc.) are firstly integrated with the parsed interaction instruction information (such as the specific parameters of the apparatus ID of the inviting party and battle mode in the “Inviting Game Battle” instruction) as the input data of the logical judgment module. This logic judgment module can be the built-in software program of the apparatus or the logic processing unit in the chip, etc., which is used to conduct a comprehensive and integrated analysis of these input data in accordance with the preset logic judgment rules.

For each received interaction instruction, the logical judgment module checks one by one whether the conditions of the local apparatuses meet the requirements for executing the interaction instruction in accordance with the corresponding logical judgment rules. Taking the “Inviting Game Battle” instruction as an example. If the logical judgment rule requires the power level of the local apparatus to be higher than 30%, the logical judgment module checks whether the current obtained power level of the local apparatus is indeed higher than 30%. If the logical judgment rule also requires that the current atomization parameters be within a reasonable range, further test whether the atomization concentration, atomization flavor and other parameters in the current atomization parameters meet the set reasonable range requirements.

The specific content of interaction operations is determined based on the results of logical judgment. For example, if it is determined that the first atomization apparatus accepts the “Inviting game battle” instruction, the interaction operation content can include: entering the battle preparation state, adjusting the screen UI display animation to the battle-related style (such as showing the battle countdown, comparing the power levels of both apparatuses, etc.), and setting battle-related parameters (such as setting the initial atomization concentration according to the requirements of the inviting party apparatus, etc.).

At the same time, the sequence of interaction operations can also be clearly defined. In the above optional examples, the optional operation sequence is: the screen UI display animation effect is firstly adjusted so that users can promptly see the battle-related prompt information; then the battle-related parameters is set to ensure that the first atomization apparatus enters the battle preparation state in the correct sequence.

Finally, the determined interaction operation content and interaction operation sequence are organized to form a complete interaction operation information, and the complete interaction operation information is output to the relevant modules (such as the human-machine interaction interface display module, apparatus control module, etc.) of the first atomization apparatus, so that subsequent corresponding operations can be carried out based on these interaction operation information, such as displaying the interaction operation information in a dynamic effect image style on the human-machine interaction interface, or performing the relevant configuration and control operations of the apparatus in the operation sequence, etc.

Through the above method steps, logical judgments can be performed based on the local apparatus information and interaction instruction information of the first atomization apparatus, thereby obtaining complete interaction operation information and laying the foundation for effective interaction between apparatuses and the improvement of user experience.

In one possible implementation, the step of obtaining of the interaction signals output by the other electronic apparatuses mentioned above includes:
obtaining, through the signal receiving circuit connected to the near-field communication module in the first atomization apparatus mentioned above, the interaction signals output by the other electronic apparatuses mentioned above according to the preset signal receiving frequency and bandwidth.

Inside the first atomization apparatus, there is a close physical connection between the near-field communication module (such as the NFC communication module, Bluetooth module, and other modules used to achieve near-field communication functions) and the dedicated signal receiving circuit. This connection ensures that the weak radio frequency signals received by the near-field communication module can be smoothly transmitted to the signal receiving circuit for subsequent processing.

For example, the output pins of the near-field communication module are connected to the input pins of the signal receiving circuit through wires on the printed circuit board (PCB). It should be understood that this connection method needs to ensure the stability and low loss of signal transmission. Usually, appropriate wiring techniques and high-quality wire materials are adopted to reduce signal attenuation and interference during transmission.

In the example of the present application, the preset signal receiving frequency is determined based on the near-field communication technology standard adopted and the specific interaction requirements of the first atomization apparatus. Different near-field communication technologies (such as NFC communication modules and Bluetooth) have their own typical operating frequency ranges. The setting of bandwidth takes into account factors such as the spectral characteristics of the interaction signal and the amount of signal information to be received. For example, a wider bandwidth can receive signals with more frequency components, thereby capturing more abundant information, but it may also introduce more noise and interference. A narrower bandwidth, on the contrary, although it has a slightly stronger anti-interference ability, may also miss some signal information.

For example, in the application scene of the NFC communication module of the first atomization apparatus, if the main purpose is to conduct simple instruction interactions (such as inviting game battles, sharing configuration, etc.), a relatively narrower bandwidth, like around 1 MHz, can be set, because the spectrum of these instruction signals is relatively concentrated around 13.56 MHz and the amount of information is relatively limited. However, if more detailed apparatus state information (such as the power level and atomization parameters, etc. of the opposing apparatus) needs to be received, it may be necessary to appropriately expand the bandwidth, for example, the bandwidth is set to 2 MHz to 3 MHz, to ensure that these information-rich signals can be received completely.

Once the near-field communication module is connected to the signal receiving circuit and the signal receiving frequency and bandwidth are preset, the signal receiving circuit starts to work according to the set parameters, for example, continuously monitoring the RF signals within the corresponding frequency and bandwidth range in the surrounding environment. When other electronic apparatuses emit interaction signals (which are within the preset frequency and bandwidth range), the signal receiving circuit receives these interaction signals through its antenna (an antenna shared with the near-field communication module or an antenna specially configured for the signal receiving circuit).

For example, when the first atomization apparatus approaches another electronic apparatus that also has near-field communication capabilities to a certain distance (such as within the effective communication range of the NFC communication module), the interaction signal emitted by the another apparatus is captured by the signal receiving circuit of the first atomization apparatus and then enters the next signal processing stage. Such as filtering, amplification, demodulation and other processing to convert it into a digital signal form that can be further understood and processed by the apparatus.

Through the above methods, the first atomization apparatus can effectively obtain the interaction signals output by other electronic apparatuses through the signal receiving circuit connected to the near-field communication module, in accordance with the preset signal receiving frequency and bandwidth, providing a basis for subsequent operations such as analysis and logical judgment.

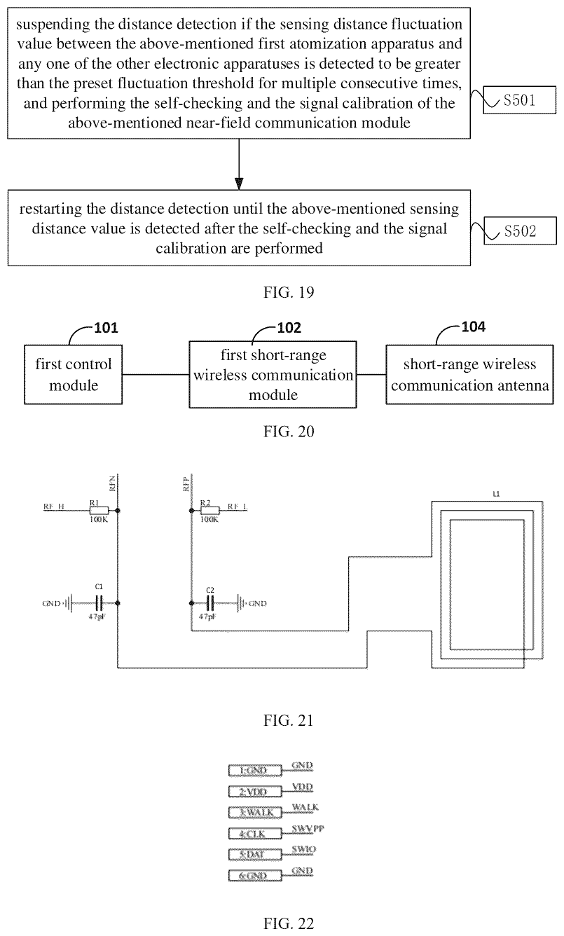

In one possible implementation, as shown in FIG. 19, which shows a schematic flowchart of an optional method for data transmission provided by the present application, the step of detecting the sensing distance value between the above-mentioned first atomization apparatus and any one of the other electronic apparatuses includes:

S501, suspending the distance detection if the sensing distance fluctuation value between the above-mentioned first atomization apparatus and any one of the other electronic apparatuses is detected to be greater than the preset fluctuation threshold for multiple consecutive times, and performing the self-checking and the signal calibration of the above-mentioned near-field communication module.

S502, restarting the distance detection until the above-mentioned sensing distance value is detected after the self-checking and the signal calibration are performed.

In the relevant configuration of the near-field communication module of the first atomization apparatus, a suitable preset fluctuation threshold is preset. For example, the preset fluctuation threshold is determined based on the precision requirements of the apparatus, actual application scenes, and the characteristics of the near-field communication module, etc.

For example, in one example, for the first atomization apparatus that mainly relies on the NFC communication module for short-range interaction, if it is desired to maintain relatively high accuracy in distance detection, the preset fluctuation threshold can be set to a smaller value, such as ±2 cm (indicating that a fluctuation range of the sensing distance within 2 cm above or below is acceptable). For some situations where the requirement for distance accuracy is not particularly high, or in scenes where there are many environmental interference factors that make distance detection itself somewhat uncertain, the threshold can be set slightly higher, such as ±5 cm.

When the sensing distance value between the first atomization apparatus and other electronic apparatuses is detected through a near-field communication module (such as an NFC communication module or a Bluetooth module, etc.) (as mentioned earlier, the distance can be detected based on changes in signal strength or magnetic field strength, etc.), the first atomization apparatus continuously samples and measures the sensing distance value according to a certain frequency (for example, at regular time intervals, for example, 100 milliseconds).

After each measurement of a sensing distance value, the difference between the current measured sensing distance value and the previous measured sensing distance value is calculated. This difference is the sensing distance fluctuation value. Then compare this fluctuation value with the preset fluctuation threshold. If the detected fluctuation value of the sensing distance is greater than the preset fluctuation threshold for multiple consecutive times (for example, five consecutive times), it indicates that there is a relatively obvious unstable situation in the distance detection. Therefore, once it is determined that the consecutive multiple detected fluctuation values of the sensing distance exceed the preset fluctuation threshold, the first atomization apparatus immediately suspend the ongoing distance detection operation to avoid continuing to obtain inaccurate data under unstable distance detection conditions, and also to free up time and resources for subsequent self-check and calibration operations.

For example, in the control program of the first atomization apparatus, a flag bit is set to indicate the state of distance detection. When the above fluctuation conditions are satisfied, this flag bit is set to the pause state, thereby temporarily suspending the operation of the circuits and programs related to distance detection and preventing the sampling and measurement of new distance values.

After the distance detection is suspended, the first atomization apparatus initiates the self-checking program of the near-field communication module, the self-checking program checks each key component and function of the near-field communication module. Taking the NFC communication module as an example. The self-checking program can check the working state of the NFC communication module, including checking whether the chip is powered normally and whether there is overheating, etc. The connection of the antenna can also be checked to see if the antenna is loose or damaged, etc. At the same time, it will also check whether other circuit components related to communication with the NFC communication module, such as filter capacitors and amplification circuits, are working properly. Through the above checks, it is possible to initially determine whether there are any hardware issues with the near-field communication module.

In addition to self-checking, the signal of the near-field communication module is also calibrated. For example, for a Bluetooth module that detects distance based on signal strength, calibration can involve operations such as resetting the transmission power of the Bluetooth module and adjusting the receiving sensitivity, to cause the measurement of signal strength more accurate and thereby indirectly improve the accuracy of distance detection. For example, for an NFC communication module that detects distance based on magnetic field strength, signal calibration can involve adjusting the sensitivity of the sensor used in the NFC communication module to monitor magnetic field strength, or re-calibrating the correspondence between magnetic field strength and distance (as environmental factors may cause changes in this correspondence in practical applications), so as to more accurately determine the sensing distance value based on the magnetic field intensity.

After completing the self-checking and signal calibration of the near-field communication module, the first atomization apparatus restored the flag bit related to distance detection from the paused state to the normal working state, preparing to resume the distance detection operation. At the same time, the parameters (such as the transmission power of the Bluetooth module, the sensitivity of the NFC communication module sensor, etc.) that were adjusted during the self-checking and calibration process are initialized to ensure that these parameters are in an appropriate state when the detection is restarted.

After restarting the distance detection, the first atomization apparatus continues to sample and measure the sensing distance values between the first atomization apparatus and other electronic apparatuses according to the previously set detection frequency and method (such as based on signal strength or magnetic field strength, etc.). Continue this detection process until a sensing distance value that meets the requirements is obtained (i.e., the sensing distance fluctuation value detected multiple times in a row no longer exceeds the preset fluctuation threshold). The final sensing distance value obtained will serve as the basis for subsequent operations such as determining whether to establish a near-field sensing connection.

Through the above method steps, the near-field communication module can be self-checked and signal calibrated when there are obvious fluctuations and instability in the sensing distance detection, to ensure that the sensing distance values between the first atomization apparatus and other electronic apparatuses can be accurately detected in the future, thereby providing a reliable distance judgment basis for the effective interaction between apparatuses.

It should be understood that the sequence numbers of each step in the above embodiments do not imply the order of execution. The execution sequence of each process should be determined by its function and internal logic, and should not constitute any limitation on the implementation process of the embodiments of the present application.

### Embodiment 4

In the embodiment, the first short-range wireless communication module is used to detect whether a second atomization apparatus exists within the preset distance range as described in step S20, including:
when the first short-range wireless communication module is in an active mode, controlling the first short-range wireless communication module to transmit an electromagnetic field signal at a preset cycle to detect whether the second atomization apparatus is existed.
when the first short-range wireless communication module is in a passive mode, controlling the first short-range wireless communication module to stop transmitting the electromagnetic field signal and to enter a monitoring state, and the first short-range wireless communication module is activated when the electromagnetic field signal is detected.

### Embodiment 5

The Embodiment 5 provides a device for data transmission, the device for data transmission includes a first control module and a first short-range wireless communication module; the first control module detects whether a second atomization apparatus exists within a preset distance range through the first short-range wireless communication module; if the first short-range wireless communication module determines that the second atomization apparatus exists within the preset distance range, the first control module conducts data transmission with the second atomization apparatus through the first short-range wireless communication module.

### Embodiment 6

The Embodiment 6 provides a device for data transmission, which includes a first control module and a first short-range wireless communication module; When a second atomization apparatus exists within the preset distance, the first control module is paired and connected to the second atomization apparatus through the first short-range wireless communication module, conducts data transmission with the second atomization apparatus, and synchronously displays the data with the second atomization apparatus.

### Embodiment 7

The first embodiment provides a device for data transmission of an atomization apparatus, as shown in FIG. 20, including:
a short-range wireless communication antenna 104, configured for receiving and transmitting an electromagnetic field signal;
the first short-range wireless communication module 102 is connected to the short-range wireless communication antenna 104 for exchanging data with the target atomization apparatus;
the first control module 101 connected to the first short-range wireless communication module 102 is configured for controlling the first short-range wireless communication module 102 to switch between an active mode and a passive mode;
when the first control module 101 controls the short-range wireless communication module 102 to be in the active mode, the first control module 101 controls the short-range wireless communication module 102 to transmit the electromagnetic field signal at a preset cycle to detect whether a target atomization apparatus is existed;
when the first control module 101 controls the short-range wireless communication module 102 to be in the passive mode, the first control module 101 controls the short-range wireless communication module 102 to stop transmitting the electromagnetic field signal and enter a monitoring state, and the first control module 101 is activated when the electromagnetic field signal is detected.

In the embodiment, the short-range wireless communication antenna 104 is used to receive and transmit electromagnetic field signals, serving as the front-end interface for electromagnetic information interaction between the apparatus and the external environment, and can receive wireless signals transmitted by other apparatuses and send the generated signals outward. The first short-range wireless communication module 102 is connected to the short-range wireless communication antenna 104, which is used for data exchange with the target atomization apparatus through the short-range wireless communication antenna 104. This module can support the short-range wireless communication protocol of NFC to complete data transmission and reception. The communication module has two working states: the active mode and the passive mode. The first control module 101 can dynamically schedule the working state of the communication module based on user operation instructions, system setting parameters or detection results. Specifically, when the first control module 101 controls the first short-range wireless communication module 102 to be in active mode, the first control module 101 controls the first short-range wireless communication module 102 to emit electromagnetic field signals according to the preset cycle for active scanning and detection of whether there are target atomization apparatuses nearby. If a response from the target apparatus is detected, a point-to-point data link can be further established to achieve operations such as identity recognition, parameter synchronization or interaction control, etc. When the first control module 101 controls the first short-range wireless communication module 102 to be in passive mode, the first control module 101 controls the first short-range wireless communication module 102 to stop transmitting electromagnetic field signals and enter the monitoring state, and the first control module 101 only receives electromagnetic field signals sent from the outside. When electromagnetic field signals from other apparatuses are detected, the communication module is activated and responds to the corresponding signal content, achieving low-power standby and rapid wake-up.

The working process of the embodiment includes:
1. Power-on and initialization stage of the apparatus: when the atomization apparatus is powered on or activated by the user, the first control module 101 starts up and initializes the first short-range wireless communication module 102 and the short-range wireless communication antenna 104 to ensure that the communication system is in a standby state.
2. Mode determining and switching stage: the first control module 101 determines whether the current mode should be in the active mode or the passive mode based on the configuration of the atomization apparatus (such as whether it is the main control device) or external trigger conditions (such as user key pressing, changes in apparatus state), and issues control instructions to switch the working state of the communication module.
3. Device search stage in the active mode: the first control module 101 sets the first short-range wireless communication module 102 to be the active mode; the first short-range wireless communication module 102 transmits electromagnetic field signals (such as NFC request signals or BLE broadcast packets) via the antenna at a preset period (e.g., every 200 ms). If no response from other apparatuses is detected within a certain time window, continue broadcasting. Once a response signal (such as an NFC reply request) sent by the target atomization apparatus is detected, a communication link is established immediately.
4. Establishing communication connection and data exchange stage: the first control module 101 coordinates the first short-range wireless communication module 102 to conduct a secure handshake with the second atomization apparatus; both apparatuses exchange identity information, remaining power level, flavor parameters, usage times and other data through an encrypted channel. If the second atomization apparatus supports apparatus interlocking control, it can also transmit synchronous operation instructions, such as simultaneously starting atomization or sharing user-set gears.
5. Monitoring and response stage in passive mode: the first control module 101 sets the first short-range wireless communication module 102 to be in the passive mode. At this time, the first short-range wireless communication module 102 stops transmitting any signals and enters a low-power monitoring state, and only receives the electromagnetic field signals emitted from the outside through the antenna. Once an active signal (such as a pairing request) from other apparatuses is detected, the first short-range wireless communication module 102 is immediately activated and sends an interrupt signal to the first control module 101. The first control module 101 instructs the communication module to enter the response state and conducts communication connection and data exchange in accordance with the predetermined protocol.
6. Communication completion and mode recovery stage: when the data exchange is completed or the communication times out, the first control module 101 can automatically revert to the passive monitoring mode based on the apparatus policy to reduce power consumption.

The technical effect of the embodiment lies in that: by setting the first control module 101 to control the first short-range wireless communication module 102 to dynamically switch between the active mode and the passive mode, it can not only achieve automatic discovery and data interaction between apparatuses, but also enter the low-power monitoring mode in the non-communication state, to reduce energy consumption. Through this interaction communication device, the atomization apparatus can achieve identity recognition, parameter synchronization and collaborative control, enhancing the intelligence level of the equipment and the user interaction experience.

As an embodiment, the first control module 101 is used to set the first short-range wireless communication module 102 to be in the passive mode when the first preset trigger condition is met, where the first preset trigger condition includes: it is detected that the communication with the target atomization apparatus is detected, the electromagnetic field signal is not detected within the preset time, the atomization apparatus is in an idle state, or the power level of the battery of the atomization apparatus is lower than the preset threshold.

In the present application, the first control module 101 is used to set the first short-range wireless communication module 102 to be in the passive mode when the first preset trigger condition is met, in order to reduce system power consumption and extend apparatus battery life. The first preset trigger condition includes but is not limited to any one of the following situations: the short-range wireless communication process has been completed, external electromagnetic field signal has not been detected within the preset time window, the atomization apparatus is currently in an idle communication state, or the remaining power level of the battery of the apparatus is detected to be lower than the preset threshold.
1. Communication is completed, when the atomization apparatus has completed data exchange with the target atomization apparatus, such as identity recognition, flavor synchronization or usage record sharing, etc., the communication task is temporarily ended. Maintaining the active mode at this point will cause unnecessary energy consumption. The first control module 101 switches the first short-range wireless communication module 102 to be in the passive mode and enters the monitoring state, thereby saving power.
2. If the electromagnetic field signal is not detected within the preset time, and no electromagnetic field signal emitted by any external atomization apparatus is detected within a preset scanning period (such as 5 seconds, 10 seconds, etc.), it indicates that there may be no communicable targets nearby. The first control module 101 determines that the current communication is invalid, in order to avoid continuous idling, it disables the transmission function and switches to be in the passive mode, only monitors for external activation signals.
3. The atomization apparatus is in an idle state, when the atomization apparatus has not been operated by the user for a long time or has not triggered communication tasks (such as the inhalation detection not being triggered, no user interaction), it enters an idle state. After the first control module 101 recognizes this state, it pauses the active scanning and enters the passive monitoring state to reduce resource occupation and extend battery life.
4. If the power level of the battery of the atomization apparatus is lower than the preset threshold and it is detected that the remaining power level of the battery of the atomization apparatus has dropped below a certain set safety threshold (for example, 20%), basic functions such as atomization output can be prioritized. Due to the high power consumption of the wireless communication module, the active mode will accelerate power consumption. The first control module 101 automatically shuts down the high-energy-consuming transmission function, places the communication module in the passive mode, and only retains the receiving capability to ensure that the equipment can still passively respond to external activation signals under low power conditions.

When the first control module 101 determines that any one of the above conditions is satisfied, it immediately issues a control instruction, causing the first short-range wireless communication module 102 to stop transmitting electromagnetic field signals and switch to a passive monitoring state. In this state, the communication module operates at low power consumption and is only activated when an external electromagnetic field signal is received, thereby achieving intelligent energy-saving management of the atomization apparatus during the inactive stage.

The technical effect of the present embodiment lies in that: by setting the first preset trigger condition, the first short-range wireless communication module 102 is switched to be in the passive mode, which effectively reduces the overall power consumption of the apparatus and extends the battery life. At the same time, the passive monitoring capability is retained to ensure that the apparatus can still respond promptly to external activation signals in a low-power state, achieving an effective balance between communication performance and energy efficiency management.

As an embodiment, the first control module 101 is used to set the first short-range wireless communication module 102 to be in the active mode when the second preset trigger condition is satisfied; where the second preset trigger condition includes: user inhalation, button pressing operation, timed wake-up event or start broadcasting.

In the embodiment, the first control module 101 is also used to set the first short-range wireless communication module 102 to be in the active mode when the second preset trigger condition is satisfied; so as to initiate apparatus identification or data interaction operations in a timely manner. The second preset trigger condition includes but is not limited to any of the following situations: the user inhalation behavior is detected, the user performs a button pressing operation, a timed wake-up event occurs, or the system command is triggered to start broadcasting.

When the user inhalation is detected, the first control module 101 recognizes that the atomization apparatus is about to start atomization work and may need to be linked with other apparatuses (such as synchronizing state or parameters). Therefore, it immediately switches the communication module to be in the active mode and initiates apparatus scanning and pairing. When the user performs the button pressing operation (such as mode switching, manual pairing, etc.), the first control module 101 considers that the user has an active interaction need and also triggers the first short-range wireless communication module 102 to enter the active mode, so as to quickly establish a communication connection. When the preset timed wake-up event is reached (such as automatically scanning surrounding apparatus every 30 seconds), the first control module 101 will also activate the communication module to perform short-term active broadcasting, which is used to periodically discover the target apparatus. In some scenes, the system can preset instructions to trigger the start of broadcasting. For example, after the atomization apparatus is powered on, it automatically attempts to connect and paired apparatus. At this time, the first control module 101 initiates the active transmission function of the communication module based on the preset logic.

The technical effect of the embodiment lies in that: by setting a second preset trigger condition, the first short-range wireless communication module 102 is switched to be in the active mode, enabling the apparatus to promptly initiate communication requests and achieve rapid identification and connection to other target apparatuses; This implementation mode effectively enhances the response speed and communication efficiency of the atomization apparatus at critical interaction moments, and improves the user experience and intelligence level.

As an embodiment mode, when the first short-range wireless communication module 102 is in the active mode, if the first control module 101 detects the response signal of the target atomization apparatus, it will control the first short-range wireless communication module 102 to enter the data exchange state.

In the embodiment, when the first short-range wireless communication module 102 is in the active mode, the first control module 101 controls this communication module to send electromagnetic field signals according to the preset cycle, which is used to actively detect whether there are target atomization apparatuses nearby. When the first control module 101 detects the response signal sent by the target atomization apparatus and determines that both parties have the conditions to establish communication, it immediately controls the first short-range wireless communication module 102 to switch from the broadcast state to the data exchange state. In the data exchange state, the first short-range wireless communication module 102 establishes a connection with the target atomization apparatus through a secure communication protocol and synchronizes information under the coordination of the first control module 101. The synchronized content may include but is not limited to apparatus identity, power level information, usage parameters, atomization gear or synchronization control instructions, etc.

The technical effect of the embodiment lies in that: by automatically switching to the data exchange state after detecting the response signal of the target atomization apparatus when the first short-range wireless communication module 102 is in the active mode, rapid connection and efficient communication between apparatuses can be achieved. This implementation mode enhances the real-time performance and stability of interaction between apparatuses, supports functions such as identity recognition, parameter synchronization, and interlocking control, and improves the intelligent collaborative capabilities of apparatuses and the user experience.

As an embodiment mode, the first short-range wireless communication module 102 is in the passive mode, and when the first short-range wireless communication module 102 is activated to output a wake-up signal to the first control module 101.

In the embodiment, when the first short-range wireless communication module 102 is in the passive mode, the first short-range wireless communication module 102 stops transmitting electromagnetic field signals and only monitors for external electromagnetic field signals through the short-range wireless communication antenna 104. In the passive mode, the first short-range wireless communication module 102 maintains a low-power operation state to receive broadcasts or pairing requests from other atomization apparatuses. When an effective electromagnetic field signal from an external atomization apparatus is detected (such as a connection request from the target atomization apparatus), the first short-range wireless communication module 102 is activated and immediately outputs a wake-up signal to the first control module 101. After receiving the wake-up signal, the first control module 101 determines whether to proceed with the communication process based on the current state of the atomization apparatus, such as switching to the active mode or directly entering the data exchange state.

The technical effect of the present embodiment lies in that: when the first short-range wireless communication module 102 is in the passive mode, it is automatically activated upon detecting an external electromagnetic field signal and outputs a wake-up signal to the first control module 101, and a rapid response of the atomization apparatus to external communication requests under low power consumption conditions is achieved. This implementation effectively enhances the energy efficiency management capability of the system, ensuring that the atomization apparatus can still participate in communication in a timely manner without frequent active scanning, and takes into account both power consumption control and real-time communication performance.

As an embodiment, as shown in FIG. 21, the short-range wireless communication antenna 104 includes an induction coil L1, a first capacitor C1 and a second capacitor C2. The first terminal of the induction coil L1 is connected to the first terminal of the first capacitor C1, the second terminal of the first capacitor C1 is grounded, and the second terminal of the induction coil L1 is connected to the first terminal of the second capacitor C2, and the second terminal of the second capacitor C2 is grounded.

In the embodiment, the short-range wireless communication antenna 104 adopts a matching network composed of an induction coil L1 and two sets of capacitors. The induction coil L1 serves as the antenna for receiving and transmitting short-range wireless signals (such as NFC or radio magnetic field signals). The first capacitor C1 is connected to one terminal of the induction coil L1 and grounded at the other terminal, so as to form an LC resonant branch. The second capacitor C2 is connected to the other terminal of the induction coil L1 and is also grounded, so as to form another resonant branch as well. This symmetrical or parallel capacitor structure helps tune the resonant frequency of the induction coil L1, enabling the entire antenna loop to reach the optimal resonant state at the target communication frequency (such as 13.56 MHz), the signal reception sensitivity and transmission efficiency are enhanced while suppressing high-frequency losses and improving communication quality.

As an embodiment, the induction coil L1 includes a multi-turn rectangular coil, in which the wire width of each turn of the rectangular coil is consistent, the spacing between adjacent coils of the rectangular coil is consistent, and the corner of the rectangular coil adopts an arc transition structure.

In the embodiment, the induction coil L1 is a multi-turn rectangular coil structure and is used to achieve the transmission and reception of short-range electromagnetic field signals. The rectangular coil are formed by arranging several turns of wire along a preset path. Each turn of the coils maintains structural symmetry and electrical consistency with one another to enhance the signal coupling efficiency and resonant characteristics. Specifically, the wire width of each turn in the rectangular coil is consistent to ensure uniform current distribution across all turns and reduce AC loss. The spacing between adjacent coils of the rectangular coil is consistent, which is used to maintain stable inductive coupling and increase the Q value. Moreover, at each corner of the rectangular coil, an arc transition structure is adopted to avoid electromagnetic concentration, wire stress concentration and signal distortion caused by sharp corners, thereby enhancing electrical performance and structural reliability.

The technical effect of the present embodiment lies in that: by adopting a multi-turn rectangular induction coil structure, the widths of each turn of the wire are consistent, the spacing between adjacent coils is consistent, and the arc transition design is adopted at the corner, the electromagnetic coupling efficiency and resonant stability of the coil are improved. This implementation mode effectively reduces the skin effect and electromagnetic interference, enhances the signal strength and anti-interference ability of the communication module, and is conducive to achieving efficient and stable short-range wireless communication.

In the embodiment, the short-range wireless communication antenna 104 of the atomization apparatus adopts a coil antenna structure and is used for transmitting and receiving electromagnetic field signals at a frequency of 13.56 MHz through near-field coupling. The antenna structure is designed with multi-turn coils, presenting an overall regular circular or rectangular wiring shape. It adopts an equal-width and equal-distance wiring method to ensure the consistency of impedance in the antenna circuit and the uniformity of electromagnetic field distribution. In the embodiment, the wire width of the antenna wire is determined comprehensively based on the requirements of both the transmitting and receiving antennas. It is recommended that the wire width be approximately 0.3 mm, which is suitable for dual-function antenna modules that serve both as transmitting and receiving apparatuses. In order to achieve stable signal coupling, the effective working distance of the antenna is approximately 5 cm, and its signal coverage range is basically equivalent to the diameter of the antenna. The equivalent inductance L of an antenna is determined by parameters such as the number of coil turns, wire length and shape factor, etc. Preferably, the equivalent inductance value of the antenna design is controlled between 1 μH and 2 μH to enable the selection of standard capacitance tuning capacitors and achieve resonant matching at a frequency of 13.56 MHz.

The specific antenna inductance estimation can be preliminarily calculated using the following empirical formula: where L (nH) is the estimated antenna inductance, L1 (cm) is the length of one antenna loop, and D1 is the width of the PCB coil wire; K is the shape factor of the antenna (k=1.07 for circular antennas, k=1.47 for square antennas); N is the number of turns; Ln is natural logarithmic function.

In order to enhance the simulation accuracy, high-frequency electromagnetic simulation software (such as HFSS or CST) can be used to precisely model the coil structure, optimizing its inductance value and Q value to meet the coupling strength and communication distance required for near-field communication. In terms of PCB routing, the routing of the antenna area should follow the following principles:
1. Copper must not be laid on the top and bottom layers of the antenna area, and large copper planes should also be avoided around the antenna to prevent electromagnetic field leakage and parasitic current interference.
2. The NFC chip should be placed as close as possible to the antenna routing area to minimize the inductance and impedance introduced by the connection wires.
3. The corners of all PCB traces should be designed as arc structures to reduce EMC radiation interference.
4. The closed loop signal wires, power wires or ground wires must not be laid in the antenna area and its edges. Moreover, large areas of metal structures or metal coatings shall not be arranged inside the antenna coil to avoid triggering magnetic eddy current effects and causing energy loss.

S. The antenna adopts a reverse winding method (that is, the winding direction is opposite rather than the same) to enhance the mutual coupling ability of magnetic fluxes and improve the anti-interference ability.

Through the above-mentioned antenna structure and wiring design, the first short-range wireless communication module 102 can achieve stable and reliable short-range communication within a limited space range, to meet the performance requirements for rapid connection and data exchange between atomization apparatuses.

As an embodiment, the first short-range wireless communication module 102 includes a short-range wireless communication chip and a short-range wireless communication connection socket. The short-range wireless communication chip is connected to the first control module 101 through the short-range wireless communication connection socket.

In the embodiment, the first short-range wireless communication module 102 includes a short-range wireless communication chip and a short-range wireless communication connection socket. The short-range wireless communication chip is used to complete the functions of sending, receiving and protocol processing of short-range electromagnetic field signals, and the short-range wireless communication chip is the core component for achieving short-range communication. The short-range wireless communication chip is connected to the first control module 101 through the short-range wireless communication connection socket. The connection socket is used to provide an electrical connection path and fix the chip structure, enabling the short-range wireless communication chip to stably interact with the first control module 101 for data and instruction transmission.

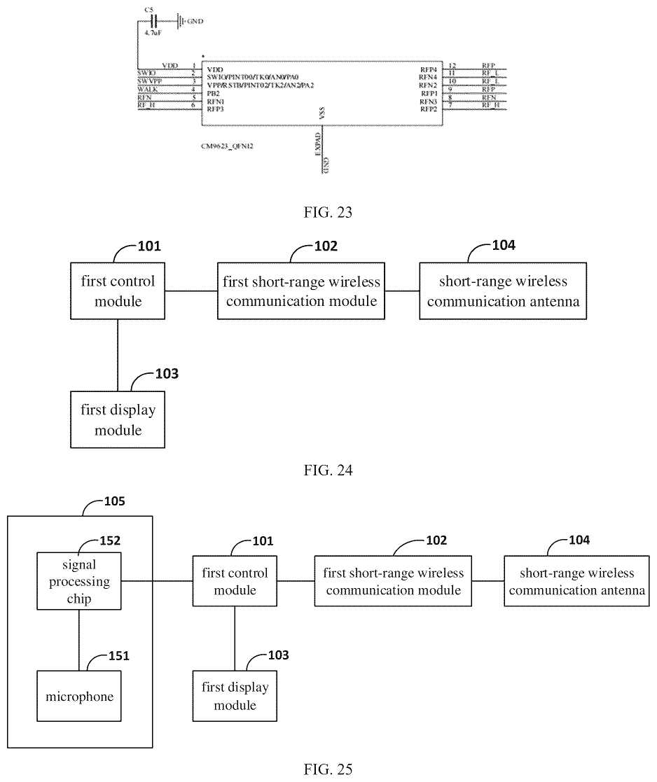

As shown in FIGS. 5, 6, 22 to 23, the MCU is connected to the NFC chip through connection socket J1. The MCU outputs the wake-up signal N_WALK, communication clock N_CLK and communication data N_DAT through the connection socket J1, and is powered, awakened and communicated through the connection socket J1. The positive power supply of 5V is supplied to the battery voltage through a 1K pull-up resistor on the host. The N_DAT is connected to the serial port transmitting terminal TXD (PA0) of the MCU, the N_CLK is connected to the serial port receiving terminal RXD (PF1) of the MCU, and the N_WALK is connected to PF0. The NFC modules of the two products send field signals in a timed 1-second wake-up mode. If no field signal is detected, they continue to be in the dormant mode. When the two modules are far apart to exceed the communication distance by 5 cm, and the field signals sent by each other cannot be received, the two modules quickly enter dormant mode. The timed wake-up is to reduce power consumption. If the two modules are within a receiving distance of 5 cm and module A receives the field signal from module B, the two modules enter the working state, that is, the N_WALK of the two modules outputs a high-level signal to respectively wake up the MCU of their respective hosts to enter the working state. The MCU of product A sends data to the NFC chip through the communication serial port. After receiving the data, the NFC chip will send a string of data back to the MCU of the host to indicate that the data has been received. At this point, the MCU of the host becomes a state waiting to receive data.

### Embodiment 8

The present embodiment 8 provides an atomization apparatus, including: the device for data transmission provided in Embodiment 7.

As an embodiment, as shown in FIG. 24, the atomization apparatus includes a first display module 103 in communication connection with a first control module 101 and is used to display the state information provided by the first control module 101. In the embodiment, the state information includes at least one of a power level of the atomization apparatus, an atomization mode, a short-range wireless communication state, a data exchange state, or target atomization apparatus information.

In the embodiment, the atomization apparatus integrates a first display module 103, the first display module 103 is in communication with the control module 101. Its main function is to visually display the operating state of the apparatus to the user, enhancing interactivity and operational convenience. The control module 101, as the core of the system, is responsible for real-time monitoring and management of the apparatus state, and sends data including the following information to the first display module 103: a power level of the apparatus, which is used to prompt the user of the remaining battery power and determine whether charging is needed; an atomization mode, displaying the power level, gear, flavor configuration, etc of the current atomization output; a short-range wireless communication state, showing whether NFC or Bluetooth is in the searching, pairing or connection state; a data exchange state, indicating whether data synchronization with other apparatuses is currently underway; target apparatus information, displaying the identification information or interaction data results of the opposing apparatus when successfully connected to other apparatuses.

The first display module 103 can adopt display screens of types such as OLED, LED or LCD, etc., and is equipped with corresponding drive circuits to achieve dynamic refreshing and multi-state switching. When the first control module 101 detects changes in the apparatus state, such as a drop in power level, the user switching the atomization mode, or completing communication pairing with the target apparatus, the first control module 101 sends the relevant state data to the first display module 103. Based on this, the first display module 103 updates the screen content to present the latest state to the user.

As an embodiment, the first display module 103 shows the “Searching” icon when the short-range wireless communication is in the active mode, and displays the target apparatus identifier or the data synchronization completion identifier when entering the data exchange state.

In the embodiment, the first display module 103 communicates with the first short-range wireless communication module 102 and the first control module 101, and is used to dynamically update the display content based on the working state of the communication modules. Specifically, when the first short-range wireless communication module 102 is in the active mode, that is, the apparatus is initiating a searching process to identify other target atomization apparatuses, the first control module 101 controls the first display module 103 to display the “Searching” icon, which is used to prompt the user that the current apparatus is performing a pairing or connection operation. When the first control module 101 detects that the apparatus has successfully established a communication connection with the target atomization apparatus and entered the data exchange state, it controls the first display module 103 to display the identification information of the target apparatus (such as the apparatus name or number), or display graphic or text prompts such as “Synchronization completed” or “Connection successful” to inform the user of the data synchronization state between the apparatuses.

Through this display process, users can understand the current communication progress and connection state of the apparatus in real time, which is conductive for operation confirmation and improvement of user experience, especially suitable for identification and management in multi-apparatus linkage scenes.

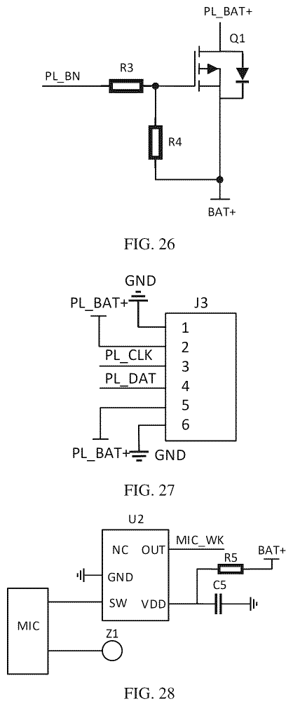

As an example, as shown in FIGS. 26 and 27, when the MCU receives the action that requires the screen to light up, it will output the PL_EN high-level signal to turn on the PMOS transistor Q1. The host supplies power to the display module through the connection socket J3 to light up the screen, and controls the display logic through the two serial port signals PL_CLK and PL_DAT.

As an embodiment, as shown in FIG. 25, the atomization apparatus also includes a silicon microphone detection circuit 105, the silicon microphone detection circuit 105 includes a silicon microphone 151 and a signal processing chip 152. The silicon microphone 151 is connected to the signal processing chip 152, and the signal processing chip 152 is connected to the first control module 101. The silicon microphone 151 is used to sense the pressure changes caused by the user inhalation. The signal processing chip 152 is used to convert the pressure changes into capacitance change signals and output digital or analog control signals to the first control module 101. The first control module 101 is used to activate the first display module 103 and cause the first short-range wireless communication module 102 to be in the active mode after the control signal is received.

In the embodiment, the silicon microphone 151 adopts MEMS silicon microphone 151 to sense air pressure fluctuations, especially the airflow disturbance caused by the user inhalation. The signal processing chip 152 converts the pressure fluctuation signal detected by the silicon microphone into a detection signal representing the inhalation event. This chip can output digital pulses (such as level flips) or analog voltage changes. After receiving the control signal from the signal processing chip 152, the first control module 101 determines that the user has an inhalation operation and immediately activates the relevant functions, including lighting up the first display module 103 and switching the first short-range wireless communication module 102 to be in the active mode to enter the search state.

As an example, as shown in FIG. 28, when the apparatus is turned on, the user has an inhalation action; when the silicon microphone MIC receives the signal that the capacitance value increases due to air pressure triggering, the silicon microphone IC U2 uses the SW pin as the input terminal of the sampling signal, senses the signal that the capacitance between the microphone head diaphragms increases, and then processes the signal to convert it into a control signal, the control signal outputs a high-level signal as MIC_WK through the OUT pin to the IO port of the MCU. Upon receiving this signal, the MCU lights up the first display module 103.

The technical solution provides a silicon microphone detection circuit to sense the air pressure changes caused by the user inhalation using the silicon microphone 151, and the air pressure changes are converted into a control signal through the signal processing chip 152, so as to achieve precise identification of the user inhalation behavior; after receiving this control signal, the first control module 101 can automatically activate the first display module 103 and switch the first short-range wireless communication module 102 to be in the active mode, thereby achieving intelligent wake-up and communication function linkage of the apparatus, the convenience of interaction and energy efficiency management level are improved.

### Embodiment 9

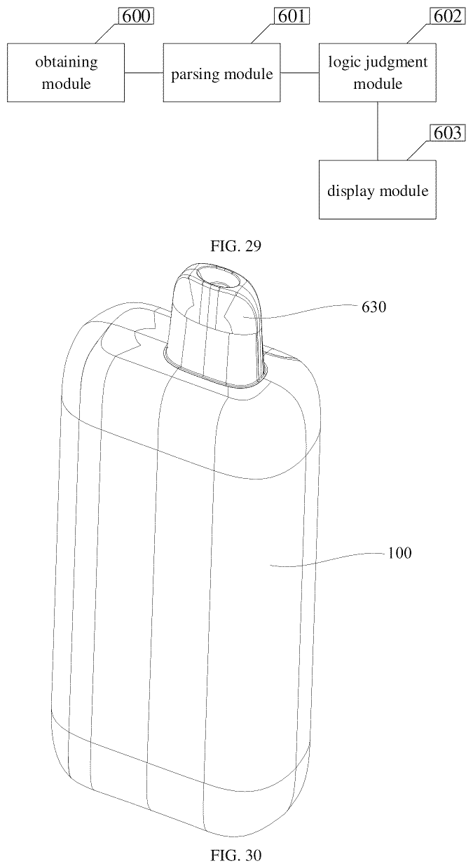

Corresponding to the method for data transmission mentioned in above embodiments, FIG. 29 is a structural schematic diagram of an atomization apparatus provided in the embodiments of the present application, which can be realized by software, hardware or a combination of both. As shown in FIG. 29, the atomization apparatus includes:
an obtaining module 600, configured for obtaining an interaction signal output by other electronic apparatuses after establishing a near-field sensing connection between the atomization apparatus and any one of the other electronic apparatuses;
a parsing module 601, configured for parsing the interaction signal to obtain interaction instruction information;
a logic judgment module 602, configured for performing a logical judgment based on local apparatus information of the first atomization apparatus and the interaction instruction information to obtain interaction operation information, where the interaction operation information comprise at least one of followings: an interaction scene, an interaction mode, an interaction state, an interaction duration, and an interaction prompt; and
a display module 603, configured for displaying the interaction operation information in a form of a dynamic effect image on a human-machine interaction interface of the atomization apparatus.

It is understandable that atomization apparatus converts liquid substances (such as drug solutions, etc.) into tiny particles suspended in the air through specific technical means, such as heating, ultrasonic vibration, and pressure changes, to form aerosols.

In the example of the present application, the atomization apparatus (hereinafter referred to as the local apparatuses) and other electronic apparatuses all have near-field communication capabilities. As examples rather than limitations, other electronic apparatuses (hereinafter referred to as the opposing apparatus) can also be atomization apparatuses or other apparatuses that support similar interactions, such as smart phones, smart watches, etc.

Optionally, the obtaining module undertakes the important task of receiving interaction signals output by other electronic apparatuses after the atomization apparatus establishes a near-field induction connection with other electronic apparatuses. In addition, the obtaining module is closely connected to the near-field communication module in the atomization apparatus. When a near-field sensing connection with other electronic apparatuses is successfully established through a near-field communication module (such as an NFC communication module or a Bluetooth module, etc.), the obtaining module begins to work.

For example, interaction signals are received through a signal receiving circuit connected to the near-field communication module (which is set according to the preset signal receiving frequency and bandwidth, as described previously). For example, if NFC is used for near-field induction connection, the obtaining module, with the help of the signal receiving circuit that comes with the NFC communication module, operates at a receiving frequency of approximately 13.56 MHz (which is fine-tuned according to the NFC standard) and an appropriate bandwidth (such as around 1 MHz, depending on the specific amount of interaction information), so as to continuously monitor and receive interaction signals sent from other electronic apparatuses through the NFC module.

In an example, the received interaction signal is initially in the form of a radio frequency signal. Subsequently, through a series of processing operations by the signal receiving circuit, such as filtering, amplification, and demodulation, etc., it is converted into a digital signal form so that the subsequent parsing module can directly process the digital signal. The parsing module mainly conducts in-depth analysis of the interaction signals received by the obtaining module and extracts valuable interaction instruction information from them. These instruction messages will clearly inform the atomization apparatus of the specific operations it needs to perform or the interaction state it is in, etc.

Firstly, the parsing module is aware of and relies on the preset interaction protocols and preset encoding rules, which detail the specific format of the interaction signal as well as the meanings and encoding methods of each part. After receiving the interaction signal in the form of a digital signal from the obtaining module, the parsing module splits it according to the rules and extracts the data content contained therein respectively, such as the header identifier, instruction content and verification portion.

Then, for the header identifier portion, by comparing the header identifier portion with the pre-stored header identifier encoding tables corresponding to various interaction types, the specific interaction type represented by the interaction signal (such as “Inviting Game Battle”, “Sharing configuration”, etc.) is determined.

Then, for the instruction content portion, based on the preset encoding rules, each parameter contained therein (such as the parameters of different battle modes like “time-limited battle” and “Points Battle” in the battle mode, the apparatus ID of the inviting party, etc.) is parsed one by one, thereby obtaining the complete interaction instruction information.

Finally, the entire parsing process is verified using the verification portion. If the verification is successful, it indicates that the interaction instruction information obtained through parsing is reliable. If the verification fails, it may be necessary to re-obtain and parse the interaction signal, or prompt the user that there is a signal transmission problem, etc.

In the example of the present application, the logical judgment module conducts a comprehensive and integrated logical analysis based on the local apparatus information of the atomization apparatus and the interaction instruction information obtained by the parsing module to determine the final interaction operation information. This logical judgment module pre-stores a series of logical judgment rules set based on the application scenes (such as social interaction, apparatus collaboration, etc.) and interaction functions (such as battles, sharing configuration, etc.) of the atomization apparatus.

The logic judgment module acquires local apparatus information from each related component of the atomization apparatus. For example, the current power level value is obtained through the power level sensor, the current atomization parameters (including atomization concentration, atomization flavor, atomization duration, etc.) are obtained through the storage configuration module, and the current operating state (such as normal operating state, abnormal operating state, firmware upgrade in progress, etc.) is obtained through the state monitoring module.

Then, the local apparatus information obtained and the interaction instruction information sent by the parsing module are simultaneously used as input data and analyzed one by one according to the pre-stored logical judgment rules. Taking the “Inviting Game Battle” instruction as an example, if the logical judgment rule requires that the power level of the local apparatus is higher than 30%, the current atomization parameters are within a reasonable range, and the apparatus is not in a special state (such as undergoing firmware upgrade, troubleshooting, etc.), then the atomization apparatus can accept the game battle invitation. Otherwise, it will be judged as a rejection of the game battle invitation. Based on the results of this logical judgment, determine the specific interaction operation information, such as entering the battle preparation state, adjusting the screen UI display animations to battle-related styles, setting battle-related parameters, etc. At the same time, various contents such as the interaction scene, interaction mode, interaction state, interaction duration, and interaction prompts, etc. are clearly defined.

The display module is used to present the interaction operation information obtained by the logical judgment module to the user intuitively in the form of dynamic effect images on the human-machine interaction interface of the atomization apparatus. Through vivid and lifelike dynamic effect images, users can clearly understand the current interaction state of the apparatus and subsequent operation prompts, etc.

An optional specific implementation: in the software system or storage unit of the atomization apparatus, various dynamic effect image styles for different interaction operation information scenes are pre-designed and stored. These styles are designed for different interaction scenes, interaction modes, interaction states, etc.

For example, for the “battle scene”, the atomization apparatus is pre-designed with ICONS of apparatuses of both parties devices displayed in the center of the screen. The flashing frequency of the ICONS is adjusted according to the battle countdown; comparison of the power level bars of both apparatuses is shown below, and the color of the power level bar gradually changes according to the power level and other dynamic effect image styles. For the “sharing configuration” scene, a dynamic update chart is designed to display the current atomization parameters of both parties (such as atomization concentration, focal length, atomization duration, etc.) on the screen, and dynamic effect image styles such as different colors and dynamic arrows are used to indicate the changes in parameters.

After the logic judgment module determines the specific interaction operation information, the control display module retrieves the corresponding dynamic effect image style from the storage based on this information, and displays the retrieved dynamic effect image style in the predetermined way through the display driver program and other related software and hardware components of the human-machine interaction interface of the atomization apparatus. This enables users to intuitively see the specific situation represented by the interaction operation information on the human-computer interaction interface, thereby achieving a good human-computer interaction experience.

In one possible implementation, the above-mentioned atomization apparatus also includes:
a near-field communication module, configured for detecting a sensing distance value between the atomization apparatus and any one of the other electronic apparatuses; and for establishing a near-field sensing connection between the atomization apparatus and the other electronic apparatuses in response to detecting that the sensing distance value is less than a preset distance threshold; where both the atomization apparatus and the other electronic apparatuses are provided with: a near-field communication module and an antenna used in conjunction with the near-field communication module.

In the example of the present application, the near-field communication module in the atomization apparatus is a core component for achieving short-range interaction between apparatuses, typically consisting of a chip, an antenna, and related circuit parts. The chip is used to process communication signals, such as encoding, decoding, modulation, demodulation and other operations. The antenna is used to transmit and receive radio frequency signals, achieving electromagnetic induction coupling with the antennas of other apparatuses, thereby completing signal transmission. The relevant circuit parts serve to connect the chip and the antenna, and performs auxiliary processing such as amplification and filtering of the signal.

The near-field communication module realizes communication within the near-field range based on specific wireless communication technologies. Taking the common NFC communication module and Bluetooth module as examples. The NFC communication module utilizes the principle of electromagnetic induction coupling. When two atomization apparatuses approach each other, their antennas interact through magnetic fields to achieve data transmission at a relatively short distance (generally within 10 cm). The Bluetooth module communicates by transmitting and receiving wireless signals in the 2.4 GHz frequency band. Its effective communication range may be longer than that of NFC, but it can also achieve interaction between apparatuses in the near-field range (such as within a few meters).

When an NFC communication module is used as the near-field communication method, the near-field communication module can detect the sensing distance value between the antenna and other electronic apparatuses by monitoring the changes in the magnetic field strength around the antenna. During the process when two apparatuses equipped with NFC communication modules approach each other, the magnetic field intensity emitted by their antennas increases as the distance decreases (within a certain range).

The sensor or circuit section in the near-field communication module continuously monitors the changes in the magnetic field intensity and samples and measures the magnetic field intensity at a certain frequency (for example, every 100 milliseconds) to obtain the real-time magnetic field intensity value. Then, the magnetic field intensity values measured each time are compared with the standard magnetic field intensity value tables obtained through experiments or theoretical analysis in advance, corresponding to different distances. For example, the range of magnetic field intensity values corresponding to the apparatuses equipped with NFC communication modules under normal working conditions at different distances such as Ocm, 2 cm, 5 cm, 8 cm, and 10 cm has been determined, forming a standard magnetic field intensity value table. When the actual measured magnetic field intensity value falls within the range of magnetic field intensity values on a certain date, the sensing distance value between the current atomization apparatus and other electronic apparatuses can be roughly estimated.

In cases where a Bluetooth module is used as the near-field communication method, when the Bluetooth communication module is in operation, the strength of the wireless signal emitted by the Bluetooth communication module gradually decreases as the distance from the receiving apparatus increases. Based on this characteristic, the sensing distance value between the atomization apparatus and other electronic apparatuses can be estimated by measuring the received Bluetooth signal strength and combining the received Bluetooth signal strength with the known Bluetooth signal propagation model and related parameters.

In the Bluetooth communication module of the atomization apparatus, there is a dedicated circuit or sensor for measuring the received Bluetooth signal strength, which is used to sample and measure the received Bluetooth signal strength at a certain frequency (such as every 50 milliseconds) to obtain the real-time signal strength value. By substituting the actual measured signal strength values into the corresponding formulas of the propagation model, the sensing distance values between the atomization apparatus and other electronic apparatuses can be estimated through calculation.

The near-field communication module continuously detects the sensing distance value between the atomization apparatus and other electronic apparatuses and compares the sensing distance value with the preset distance threshold. Optionally, this preset distance threshold is preset based on the application scenes of the apparatus and the performance characteristics of the near-field communication module. For example, in cases where short-range interaction mainly relies on the NFC communication module and a convenient and fast interaction process is desired, the preset distance threshold can be set to 8 cm. This means that when the detected sensing distance value with other electronic apparatuses is less than 8 cm, it is considered that the two apparatuses are close enough to attempt to establish a near-field sensing connection for subsequent interaction operations.

When the detected sensing distance value is less than the preset distance threshold, the NFC communication modules of both apparatuses send and receive some specific connection requests and confirmation signals again through the antenna. For example, one apparatus sends a connection request signal containing basic information such as its own apparatus ID. After receiving the connection request signal, the another apparatus parses the signal. If it confirms that the another apparatus is interaction and is willing to interact with the one apparatus (this may involve checking the current state of its own apparatus, such as whether it is in an interaction state and whether the battery is fully charged, etc.), Then send a signal confirming the connection back to the another apparatus. After receiving the confirmation connection signal from each other, the two apparatuses officially establish a near-field induction connection and can start subsequent interaction operations such as obtaining interaction signals and parsing instructions.

Similarly, when the detected sensing distance value is less than the preset distance threshold, the Bluetooth device initiates the Bluetooth pairing process. Firstly, one apparatus sends a Bluetooth pairing request signal, which includes information such as its own apparatus ID. After receiving the signal, the another apparatus parses the signal to determine whether to accept the pairing request. If accepted, the two apparatuses exchange encryption keys and other information to complete the pairing process, thereby establishing a near-field induction connection. After that, subsequent interaction operations can be carried out.

Through these functions of the near-field communication module, the atomization apparatus can accurately detect the sensing distance values with other electronic apparatuses and establish a near-field sensing connection when the distance conditions are met, laying the foundation for effective interaction between the apparatuses.

In one possible implementation, the above-mentioned near-field communication module is also used to detect the sensing distance value between the above-mentioned atomization apparatus and any one of the other electronic apparatuses, where the above-mentioned near-field communication module includes: a Bluetooth communication module and/or a NFC communication module.

In the example of the present application, by setting up a Bluetooth communication module and/or an NFC communication module in the atomization apparatus as a near-field communication means, multiple options for interaction between apparatuses are provided. Different user scenes and demands can be met by choosing the appropriate communication module. For example, the NFC communication module features convenient and rapid connection establishment, making it suitable for short-range and immediate interaction requirements. For example, when two atomization apparatuses approach each other, they can quickly initiate battle invitations or share configuration and other operations without the need for a complex pairing process. As long as they are within the effective distance range (generally within 10 cm), they can automatically sense and connect.

Bluetooth communication module, on the other hand, have a relatively longer effective communication range (typically several meters or even further, depending on factors such as the Bluetooth version), is suitable for situations where interaction is required at a slightly longer distance. For example, within the same room, users can achieve this without placing two apparatuses too close to each other. However, it is still hoped that some interaction operations such as configuration sharing or checking the apparatus state of the other party can be carried out. At this time, the Bluetooth communication module can come into play.

The atomization apparatus in the example of the present application is equipped with both of these communication modules (or one of them can be selected), enabling the atomization apparatus to interact better with other electronic apparatuses of different types. Some apparatuses may only support NFC communication, while others may prefer or only support Bluetooth communication. By offering these two options, the atomization apparatus can adapt to a broader device ecosystem, enhancing the compatibility and flexibility of interaction among apparatuses.

In one example, the Bluetooth communication module detects the sensing distance value with other electronic apparatuses based on the characteristic that the wireless signal strength decays as the distance increases. When a Bluetooth device emits a wireless signal, as the distance from the receiving apparatus increases, the signal gradually weakens during the propagation process. A dedicated circuit or sensor for measuring the received Bluetooth signal strength is provided inside the Bluetooth communication module of the atomization apparatus, which is used to sample and measure the received Bluetooth signal strength at a certain frequency (such as every 50 milliseconds) to obtain the real-time signal strength value. In order to convert the measured signal strength value into the sensing distance value, it is necessary to combine the known Bluetooth signal propagation model and related parameters. These parameters include the transmission power and antenna gain, etc. of the Bluetooth module. Different versions of Bluetooth modules can correspond to different propagation models, which are usually derived from a large number of practical tests and theoretical analyses, and can accurately reflect the relationship between Bluetooth signal strength and sensing distance in different environments.

For example, given that the transmission power of the Bluetooth module is a certain power value and the antenna gain is a certain value, when the Bluetooth signal strength value at a certain moment is measured, it is substituted into the corresponding Bluetooth signal propagation model formula (such as the free-space propagation model or a modified model that is more in line with the actual situation). Through calculation, the sensing distance value between the atomization apparatus and other electronic apparatuses can be estimated.

In another example, the NFC communication module can detect the sensing distance value based on the electromagnetic induction coupling characteristic: the NFC communication module achieves near-field communication by relying on the principle of electromagnetic induction coupling, and it can also use this principle to detect the sensing distance value between the apparatus and other electronic apparatuses. When two atomization apparatuses approach each other, their antennas interact through magnetic fields, and the intensity of the magnetic field changes with the distance. Within a certain distance range, the closer the distance, the stronger the magnetic field intensity.

In the NFC communication module of the atomization apparatus, a dedicated circuit or sensor is provided to monitor the magnetic field strength around the antenna, which is used to continuously monitor the changes in the magnetic field strength and sample and measure it at a certain frequency (such as every 100 milliseconds) to obtain real-time magnetic field strength values. Then, the magnetic field intensity values measured each time are compared with the standard magnetic field intensity value tables obtained through experiments or theoretical analysis in advance, corresponding to different distances. For example, the range of magnetic field intensity values corresponding to the normal working state of the atomization apparatus at different distances such as Ocm, 2 cm, 5 cm, 8 cm, and 10 cm on the date has been determined, so as to form a standard magnetic field intensity value table. When the actual measured magnetic field intensity value falls within the range of magnetic field intensity values on a certain date, the sensing distance value between the current atomization apparatus and other electronic apparatuses can be roughly estimated.

Through the above optional implementations, by leveraging the respective characteristics of the Bluetooth communication module and/or the NFC communication module to detect the sensing distance value, the atomization apparatus can more flexibly and accurately determine the distance relationship with other electronic apparatuses, thereby better achieving the interaction connection between apparatuses and subsequent interaction operations.

In one possible implementation, the above-mentioned atomization apparatus also includes:
an parsing module, configured for obtaining data content carried in the interaction signal; and for parsing the data content according to a preset interaction protocol and a preset encoding rule to obtain the interaction instruction information.

Optionally, the data content includes: a header identifier, instruction content, and a verification portion; the preset interaction protocol specifies a encoding method for the header identifier corresponding to different types of interaction signals, and the preset encoding rule specifies specific encoding formats for each parameter in the instruction content.

In the interaction process of the atomization apparatus, the parsing module is mainly used to conduct in-depth analysis of the interaction signals received by the obtaining module. Through a series of processing steps, it extracts valuable information from the interaction signals and converts the valuable information into interaction instruction information that the atomization apparatus can understand and execute subsequent operations based on established rules.

Firstly, the parsing module works closely with the obtaining module. The obtaining module is used to receive interaction signals output from other electronic apparatuses and transmit the interaction signals to the parsing module in an appropriate form (such as digital signals that have undergone filtering, amplification, demodulation, and other processing). Since the data content carried in the interaction signal includes the header identifier, instruction content and verification portion, the parsing module will extract these data contents based on the established format and structure of the interaction signal. Generally, interaction signals are organized in a certain way. For example, the header identifier portion occupies the first few bits (such as the first 8 bits), followed by the instruction content portion (occupying the middle few bits, with the specific number of bits depending on different instruction types and parameter configuration), and finally the verification portion (occupying the last few bits, such as the last 16 bits). The parsing module accurately extracts the three data contents of the header identifier, instruction content and verification portion from the interaction signal by identifying the position and length of these parts in the signal and other features.

The data content is parsed based on the preset interaction protocol and preset encoding rules to obtain the interaction instruction information: the preset interaction protocol stipulates the encoding methods for the header identifiers corresponding to different types of interaction signals. The parsing module will pre-store a header identifier code table, which details various possible interaction types (such as “Inviting game battle”, “Sharing configuration”, “View the apparatus state of other party, etc.) and their corresponding header identifier codes.

After extracting the header identifier from the interaction signal, the parsing module compares the header identifier with this encoding table. For example, the header identifier code for “Inviting Game Battle” can be the hexadecimal “0x11”, and the header identifier code for “sharing configuration” can be “0x22”, etc. By looking up the matching code, the specific type of interaction represented by the interaction signal can be determined. For example, if the extracted header identifier is encoded as “0x11”, it can be determined that this interaction signal is an interaction signal used to issue a battle invitation.

After determining the type of the interaction signal, the instruction content portion is then parsed. The preset encoding rule stipulates the specific encoding format for each parameter in the instruction content. The parameters contained in the instructions of different types of interaction are also different. Taking “Inviting game battles” as an example, the instruction content content can include parameters such as the apparatus ID of the inviting party and the battle mode (such as time-limited battles, points-based battles, etc.). For the apparatus ID, which can be specific encoding formats, such as using hexadecimal encoding, and it is stipulated that the first few digits represent a certain attribute of the apparatus, and the last few digits represent another attribute, etc. For the battle mode, there are also corresponding encoding methods, for example, “Time-limited battle” is encoded as binary “01”, and “points Battle” is encoded as “10”, etc.

According to these specific encoding formats, decode each parameter in the instruction content portion one by one to clarify the specific meaning of each parameter. For example, by decoding, it is known which specific apparatus is corresponding to the apparatus ID of the inviting party and which battle mode is adopted in this battle, etc. In this way, complete instruction content information is obtained.

Finally, the entire parsing process is verified using the verification portion. The function of the verification portion is to ensure that the interaction instruction information obtained through parsing is accurate and reliable. For example, the verification method is usually based on a pre-determined verification algorithm (which is also a part of the preset interaction protocol), to calculate the extracted header identifier, instruction content and other data contents, and obtain a verification value. Then the verification value is compared with the verification value directly extracted from the verification portion of the interaction signal. If the two verification values are equal, it indicates that the parsing process is correct and the obtained interaction instruction information is reliable, which can be used for subsequent logical judgments and other operations. If the two verification values are not equal, it indicates that an error may have occurred during the parsing process. At this point, it may be necessary to re-obtain and parse the interaction signal, or prompt the user that there is a signal transmission problem, etc.

Through the above optional methods, the parsing module can accurately extract data content from the interaction signal and parse the data content into interaction instruction information based on the preset interaction protocol and preset coding rules, laying the foundation for the subsequent logical judgment module to perform logical judgments and generate interaction operation information based on these instruction information.

In one possible implementation, the above-mentioned atomization apparatus also includes:
a power level sensor, configured for obtaining a current power level value of the atomization apparatus.
a storage configuration module, configured for obtaining a current atomization parameter of the first atomization apparatus, where the current atomization parameter includes at least one of followings: an atomization concentration, an atomization flavor, and an atomization duration.
a state monitoring module, configured for obtaining a current operation state of the first atomization apparatus, where the current operation state includes at least one of followings: a normal operation state, an abnormal operation state, and a firmware upgrade in progress.

Optionally, in the example of the present application, the power level sensor in the atomization apparatus is mainly used to monitor and obtain the current power level value of the apparatus in real time. This current power level value is crucial for the normal operation of the atomization apparatus and decision-making when interacting with other apparatuses (such as determining whether there is sufficient power to perform certain interaction operations).

In an optional example, the first atomization apparatus is equipped with a power level sensor inside to monitor the power level state. For example, by detecting parameters such as the voltage and current of the battery, and the remaining power level of the battery can be calculated based on the specific electrical characteristic curves of the battery (different types of batteries have their corresponding voltage-power level, current-power level, and other relationship curves).

For example, the voltage of a lithium-ion battery shows a certain variation pattern under different power level states. When the battery is fully charged, the voltage is within a relatively high and stable range. As the battery is consumed, the voltage gradually drops. The power level sensor can monitor the changes in the voltage in real time and convert the monitored voltage value into the corresponding percentage of power level value based on the voltage-power level correspondence table of the lithium-ion battery pre-stored in the apparatus (which is derived from extensive tests and data analysis based on the standard electrical characteristics of the battery), thereby obtaining the current power level value of the atomization apparatus.

In another optional example, the storage configuration module of the atomization apparatus is mainly used to store various configuration parameters of the apparatus by the user, such as the current atomization parameters. When users set parameters such as the atomization concentration, the atomization flavor, and the atomization duration through the human-machine interaction interface of the apparatus (such as by pressing buttons, touch screens, etc.), the first atomization apparatus stores these configuration values in the storage configuration module. For example, when a user adjusts the atomization concentration through the slider on the touch screen, the first atomization apparatus records the specific concentration value selected by the user (which can be expressed in digital form, such as a concentration value of 3 mg/ml, etc.) at the corresponding storage location in the storage configuration module.

In order to obtain the current atomization parameters, the relevant software program or control chip of the atomization apparatus reads these parameter values from the storage configuration module at regular intervals (for example, at certain time intervals, such as 10 seconds). For the atomization concentration, directly read the concentration value recorded in the storage location. For atomization flavors, it is possible to read a code value representing the flavor (different flavors correspond to different codes, such as strawberry flavor being encoded as 01, mint flavor as 02, etc.), and then convert it into a specific flavor name based on the pre-stored flavor code table. For the atomization duration, the duration value recorded in the storage location is also read (for example, if the atomization duration is set to 5 minutes, the value read will be 5).

In another optional example, the state monitoring module of the atomization apparatus is composed of multiple sensors and related monitoring circuits, which is used to comprehensively monitor the operating state of the apparatus. For example, it can include temperature sensors to monitor the temperature conditions of key components (such as atomization cores, etc.) inside the apparatus. It can also include some circuit condition monitors to detect whether the apparatus circuit is working properly and whether there are any abnormal conditions such as short circuits or open circuits.

For example, a temperature sensor monitors the temperature of the atomization core in real time. When the temperature of the atomization core exceeds a certain safety threshold (which is determined based on the design of the apparatus and the material properties, such as the temperature is set at 80° C.), it indicates that the apparatus is in an abnormal operating state. The state monitoring module constantly detects parameters such as current and voltage in the circuit. If it detects sudden interruption of current or abnormal fluctuations in voltage, it can also determine that there may be a problem with the atomization apparatus.

The state monitoring module conducts comprehensively analyze the information collected by various sensors and monitoring circuits. For example, if the temperature detected by the temperature sensor is within the normal range (such as below 80° C.), and the state monitoring module detects that the circuit is working properly, it can be determined that the first atomization apparatus is in a normal operating state. If the temperature detected by the temperature sensor exceeds the safety threshold, or if the state monitoring module detects abnormal conditions in the circuit (such as short circuit, open circuit, etc.), it can be determined that the atomization apparatus is in an abnormal operating state.

Additionally, when the atomization apparatus is undergoing firmware upgrade, a specific upgrade state identifier (which can be a binary value stored at a specific location, such as 0 indicating no upgrade and 1 indicating upgrade in progress) is set inside the atomization apparatus. The state monitoring module reads this identifier value to determine whether the first atomization apparatus is undergoing firmware upgrade.

Through these different implementation methods, the atomization apparatus can accurately obtain local apparatus information, including the current power level value, current atomization parameters, and current operating state, etc., so as to facilitate subsequent logical judgments and generation of interaction operation information based on interaction instruction information.

In one possible implementation, the above-mentioned logical judgment module includes:
an obtaining sub-module, configured for obtaining a logical judgment rule corresponding to the interaction instruction information, where the logical judgment rule is preset based on an application scene and an interaction function of the first atomization apparatus.
a judgment sub-module, configured for performing a logical judgment on the local apparatus information and the interaction instruction information according to the logical judgment rule to obtain interaction operation content and an interaction operation sequence.
a generation sub-module, configured for obtaining the interaction operation information based on the interaction operation content and the interaction operation sequence.

Optionally, in one example, during the development of the atomization apparatus, a series of comprehensive and reasonable logical judgment rules are preset based on its expected application scenes (such as social interaction scenes, apparatus collaboration scenes, etc.) and the interaction functions to be realized (such as game interaction functions, game battle functions, sharing configuration functions, etc.).

For example, in a social interaction scene, if the interaction function of “inviting game battles” is set up, the corresponding logical judgment rule could be: if the power level of the local apparatus is higher than a certain threshold (such as 30%), the current atomization parameters are within a reasonable range (such as the atomization concentration not exceeding a certain set value to avoid affecting the interaction game effect), and the apparatus is not in a special state (such as undergoing firmware upgrade, troubleshooting, etc.), then it is determined that the game battle can accept the game battle invitation, otherwise, it is determined as a rejection of the game battle invitation.

For the sharing configuration function, the corresponding logical judgment rule could be: if the current atomization parameters of the local apparatus do not differ much from the requirements in the received sharing configuration instructions (a specific allowable range of difference can be set), then directly adjust the configuration of the local apparatus according to the instructions and generate the corresponding dynamic effect display image to reflect the changes in the configuration. If the differences are significant, the user will be prompted to confirm further before deciding whether to adjust the configuration.

Optionally, these preset logical judgment rules are stored in the storage unit (such as flash memory, etc.) of the atomization apparatus, and an effective indexing mechanism is established to enable the rapid identification of the corresponding logical judgment rules based on the received interaction instruction information. For example, an index directory can be established based on the type of interaction instructions (such as “Inviting game battle”, “Sharing configuration”, etc.). After receiving a specific interaction instruction information, by looking up this index directory, the corresponding logical judgment rule can be quickly located, thus preparing for subsequent logical judgment operations.

Based on the logical judgment rules to perform the logical judgment on the local apparatus information and the interaction instruction information to obtain the interaction operation content and the interaction operation sequence. For example, the local apparatus information of the atomization apparatus obtained (including the current power level value, current atomization parameters, current operating state, etc.) are firstly integrated with the parsed interaction instruction information (such as the specific parameters of the apparatus ID of the inviting party and battle mode in the “Inviting Game Battle” instruction) as the input data of the logical judgment module. This logic judgment module can be the built-in software program of the apparatus or the logic processing unit in the chip, etc., which is used to conduct a comprehensive and integrated analysis of these input data in accordance with the preset logic judgment rules.

For each received interaction instruction, the logical judgment module checks one by one whether the conditions of the local apparatuses meet the requirements for executing the interaction instruction in accordance with the corresponding logical judgment rules. Taking the “Inviting Game Battle” instruction as an example. If the logical judgment rule requires the power level of the local apparatus to be higher than 30%, the logical judgment module checks whether the current obtained power level of the local apparatus is indeed higher than 30%. If the logical judgment rule also requires that the current atomization parameters be within a reasonable range, further test whether the atomization concentration, atomization flavor and other parameters in the current atomization parameters meet the set reasonable range requirements.

The specific content of interaction operations is determined based on the results of logical judgment. For example, if it is determined that the atomization apparatus accepts the “Inviting game battle” instruction, the interaction operation content can include: entering the battle preparation state, adjusting the screen UI display animation to the battle-related style (such as showing the battle countdown, comparing the power levels of both apparatuses, etc.), and setting battle-related parameters (such as setting the initial atomization concentration according to the requirements of the inviting party apparatus, etc.).

At the same time, the sequence of interaction operations can also be clearly defined. In the above optional examples, the optional operation sequence is: the screen UI display animation effect is firstly adjusted so that users can promptly see the battle-related prompt information; then the battle-related parameters is set to ensure that the atomization apparatus enters the battle preparation state in the correct sequence.

Finally, the determined interaction operation content and interaction operation sequence are organized to form a complete interaction operation information, and the complete interaction operation information is output to the relevant modules (such as the human-machine interaction interface display module, apparatus control module, etc.) of the atomization apparatus, so that subsequent corresponding operations can be carried out based on these interaction operation information, such as displaying the interaction operation information in a dynamic effect image style on the human-machine interaction interface, or performing the relevant configuration and control operations of the apparatus in the operation sequence, etc.

Through the above optional implementation methods, logical judgments can be performed based on the local apparatus information and interaction instruction information of the atomization apparatus, thereby obtaining complete interaction operation information and laying the foundation for effective interaction between apparatuses and the improvement of user experience.

In one possible implementation, the above-mentioned obtaining module includes:
a signal receiving circuit, connected to the near-field communication module and configured for obtaining the interaction signal output by the other electronic apparatuses according to a preset signal receiving frequency and bandwidth.

Inside the atomization apparatus, there is a close physical connection between the near-field communication module (such as the NFC communication module, Bluetooth module, and other modules used to achieve near-field communication functions) and the dedicated signal receiving circuit. This connection ensures that the weak radio frequency signals received by the near-field communication module can be smoothly transmitted to the signal receiving circuit for subsequent processing.

For example, the output pins of the near-field communication module are connected to the input pins of the signal receiving circuit through wires on the printed circuit board (PCB). It should be understood that this connection method needs to ensure the stability and low loss of signal transmission. Usually, appropriate wiring techniques and high-quality wire materials are adopted to reduce signal attenuation and interference during transmission.

In the example of the present application, the preset signal receiving frequency is determined based on the near-field communication technology standard adopted and the specific interaction requirements of the atomization apparatus. Different near-field communication technologies (such as NFC communication modules and Bluetooth) have their own typical operating frequency ranges. The setting of bandwidth takes into account factors such as the spectral characteristics of the interaction signal and the amount of signal information to be received. For example, a wider bandwidth can receive signals with more frequency components, thereby capturing more abundant information, but it may also introduce more noise and interference. A narrower bandwidth, on the contrary, although it has a slightly stronger anti-interference ability, may also miss some signal information.

For example, in the application scene of the NFC communication module of the atomization apparatus, if the main purpose is to conduct simple instruction interactions (such as inviting game battles, sharing configuration, etc.), a relatively narrower bandwidth, like around 1 MHz, can be set, because the spectrum of these instruction signals is relatively concentrated around 13.56 MHz and the amount of information is relatively limited. However, if more detailed apparatus state information (such as the power level and atomization parameters, etc. of the opposing apparatus) needs to be received, it may be necessary to appropriately expand the bandwidth, for example, the bandwidth is set to 2 MHz to 3 MHz, to ensure that these information-rich signals can be received completely.

Once the near-field communication module is connected to the signal receiving circuit and the signal receiving frequency and bandwidth are preset, the signal receiving circuit starts to work according to the set parameters, for example, continuously monitoring the RF signals within the corresponding frequency and bandwidth range in the surrounding environment. When other electronic apparatuses emit interaction signals (which are within the preset frequency and bandwidth range), the signal receiving circuit receives these interaction signals through its antenna (an antenna shared with the near-field communication module or an antenna specially configured for the signal receiving circuit).

For example, when the atomization apparatus approaches another electronic apparatus that also has near-field communication capabilities to a certain distance (such as within the effective communication range of the NFC communication module), the interaction signal emitted by the another apparatus is captured by the signal receiving circuit of the first atomization apparatus and then enters the next signal processing stage. Such as filtering, amplification, demodulation and other processing to convert it into a digital signal form that can be further understood and processed by the apparatus.

Through the above methods, the atomization apparatus can effectively obtain the interaction signals output by other electronic apparatuses through the signal receiving circuit connected to the near-field communication module, in accordance with the preset signal receiving frequency and bandwidth, providing a basis for subsequent operations such as analysis and logical judgment.

In one possible implementation, the above-mentioned near-field communication module is specifically used for: suspending the distance detection if the sensing distance fluctuation value between the above-mentioned first atomization apparatus and any one of the other electronic apparatuses is detected to be greater than the preset fluctuation threshold for multiple consecutive times, and performing the self-checking and the signal calibration of the above-mentioned near-field communication module; and, restarting the distance detection until the above-mentioned sensing distance value is detected after the self-checking and the signal calibration are performed.

Inside the atomization apparatus, there is a close physical connection between the near-field communication module (such as the NFC communication module, Bluetooth module, and other modules used to achieve near-field communication functions) and the dedicated signal receiving circuit. This connection ensures that the weak radio frequency signals received by the near-field communication module can be smoothly transmitted to the signal receiving circuit for subsequent processing.

For example, the output pins of the near-field communication module are connected to the input pins of the signal receiving circuit through wires on the printed circuit board (PCB). It should be understood that this connection method needs to ensure the stability and low loss of signal transmission. Usually, appropriate wiring techniques and high-quality wire materials are adopted to reduce signal attenuation and interference during transmission.

In the example of the present application, the preset signal receiving frequency is determined based on the near-field communication technology standard adopted and the specific interaction requirements of the atomization apparatus. Different near-field communication technologies (such as NFC communication modules and Bluetooth) have their own typical operating frequency ranges. The setting of bandwidth takes into account factors such as the spectral characteristics of the interaction signal and the amount of signal information to be received. For example, a wider bandwidth can receive signals with more frequency components, thereby capturing more abundant information, but it may also introduce more noise and interference. A narrower bandwidth, on the contrary, although it has a slightly stronger anti-interference ability, may also miss some signal information.

For example, in the application scene of the NFC communication module of the atomization apparatus, if the main purpose is to conduct simple instruction interactions (such as inviting game battles, sharing configuration, etc.), a relatively narrower bandwidth, like around 1 MHz, can be set, because the spectrum of these instruction signals is relatively concentrated around 13.56 MHz and the amount of information is relatively limited. However, if more detailed apparatus state information (such as the power level and atomization parameters, etc. of the opposing apparatus) needs to be received, it may be necessary to appropriately expand the bandwidth, for example, the bandwidth is set to 2 MHz to 3 MHz, to ensure that these information-rich signals can be received completely.

Once the near-field communication module is connected to the signal receiving circuit and the signal receiving frequency and bandwidth are preset, the signal receiving circuit starts to work according to the set parameters, for example, continuously monitoring the RF signals within the corresponding frequency and bandwidth range in the surrounding environment. When other electronic apparatuses emit interaction signals (which are within the preset frequency and bandwidth range), the signal receiving circuit receives these interaction signals through its antenna (an antenna shared with the near-field communication module or an antenna specially configured for the signal receiving circuit).

For example, when the atomization apparatus approaches another electronic apparatus that also has near-field communication capabilities to a certain distance (such as within the effective communication range of the NFC communication module), the interaction signal emitted by the another apparatus is captured by the signal receiving circuit of the first atomization apparatus and then enters the next signal processing stage. Such as filtering, amplification, demodulation and other processing to convert it into a digital signal form that can be further understood and processed by the apparatus.

Through the above methods, the atomization apparatus can effectively obtain the interaction signals output by other electronic apparatuses through the signal receiving circuit connected to the near-field communication module, in accordance with the preset signal receiving frequency and bandwidth, providing a basis for subsequent operations such as analysis and logical judgment.

### Embodiment 10

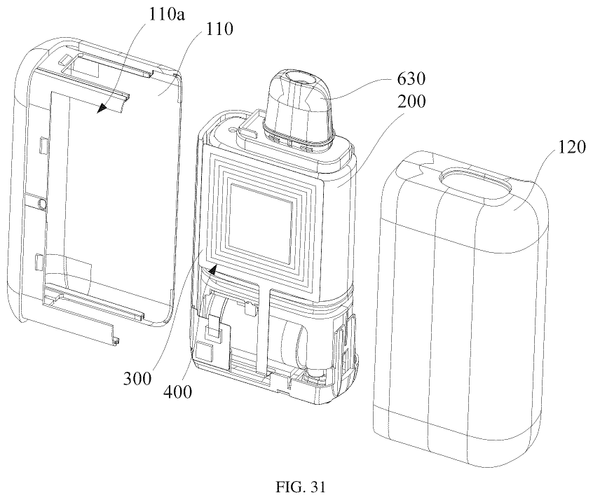

FIG. 30 is a structural schematic view of an atomization apparatus provided in an embodiment of the present application. FIG. 31 is an exploded schematic view of an atomization apparatus provided in an embodiment of the present application. As shown in FIGS. 30 and 31, the atomization apparatus includes a housing 100, a liquid reservoir 200, a flexible circuit board 300, and an antenna 400. The liquid reservoir 200 is located in the housing 100.

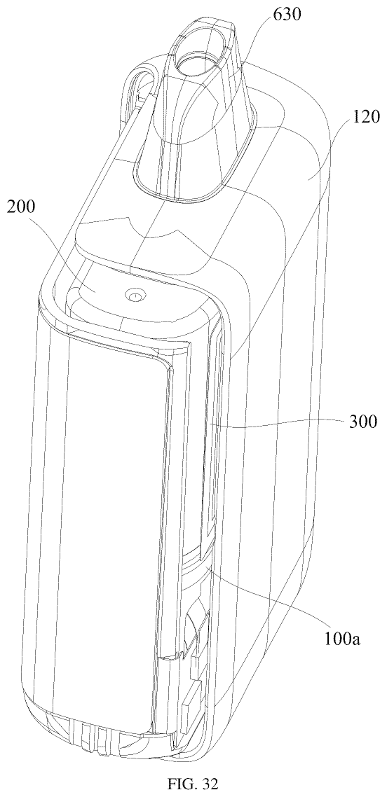

FIG. 32 is a structural schematic view of an atomization apparatus provided in an embodiment of the present application, in which at least a part of the housing 100 is omitted. As shown in FIG. 32, a gap 100a is formed between at least one side of the liquid reservoir 200 and the inner wall of the housing 100. The flexible circuit board 300 is located in the gap 100a and is arranged relatively to the surface of the housing 100. The antenna 400 is formed on the flexible circuit board 300.

By providing the gap between the liquid reservoir 200 and the housing 100 of the atomization apparatus, a flexible circuit board 300 is arranged in the gap. The liquid reservoir 200 is a relatively large structure in the atomization apparatus, with a considerable surface area. By taking advantage of the gap between the liquid reservoir 200 and the housing 100, the flexible circuit board 300 with a larger area can be arranged. The flexible circuit board 300 is thin and has a minor impact on the volume of the atomization apparatus. The antenna 400 is formed on the flexible circuit board 300. By taking advantage of the larger area of the flexible circuit board 300, a larger-sized antenna 400 can be arranged, thereby increasing the size of the antenna 400 and improving the communication quality of the atomization apparatus.

In some examples, the flexible circuit board 300 can be adhered to the surface of the liquid reservoir 200.

The interior of the liquid reservoir 200 has a cavity for storing aerosol matrix. In order to provide a larger cavity to accommodate the aerosol matrix, the liquid reservoir 200 is generally a larger structure in the atomization apparatus, capable of providing a relatively large and smooth outer surface. The flexible circuit board 300 is adhered to the surface of the liquid reservoir 200. The surface of the liquid reservoir 200 can be used to support the flexible circuit board 300, which keeps the flexible circuit board 300 flat and ensuring stable installation.

For example, the flexible circuit board 300 can be adhered to the surface of the liquid reservoir 200, thereby fixing the flexible circuit board 300 with adhesive and preventing the flexible circuit board 300 from shaking.

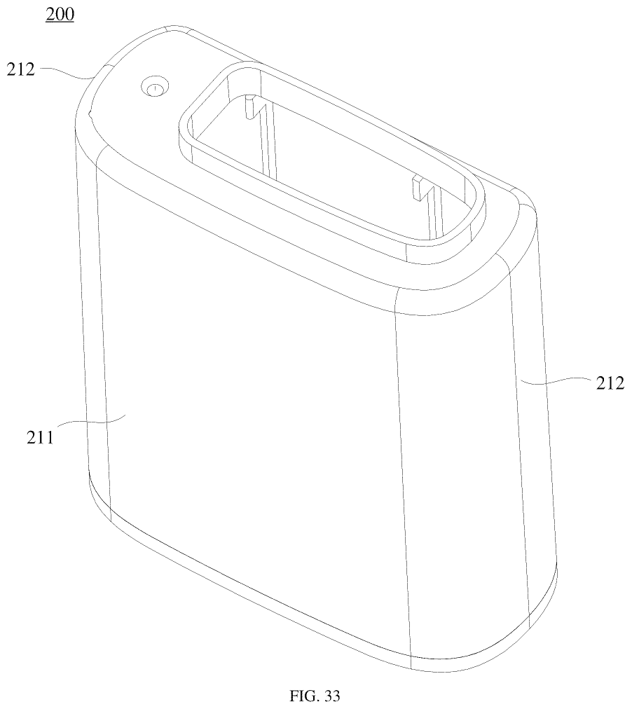

FIG. 33 is a structural schematic view of a liquid reservoir provided by an embodiment of the present application. As shown in FIG. 33, the liquid reservoir 200 includes a first side wall 211 and two second side walls 212 adjacent to the first side wall 211. The first side wall 211 and the second side walls 212 are connected in an arc. The flexible circuit board 300 is attached to the first side wall 211 and the second side walls 212.

As the adjacent side walls of the liquid reservoir 200 are connected in an arc and the surface transition is smooth, a part of the flexible circuit board 300 can be adhered to the second side walls 212 adjacent to the first side wall 211. The flexible circuit board 300 is bent smoothly without causing any damage to it. Because the second side walls 212 adjacent to the first side wall 211 can be fully utilized to arrange the flexible circuit board 300, it is conducive to arranging a larger area of the flexible circuit board 300, allowing the size of the antenna 400 to be set larger, which is beneficial to further improving the communication quality.

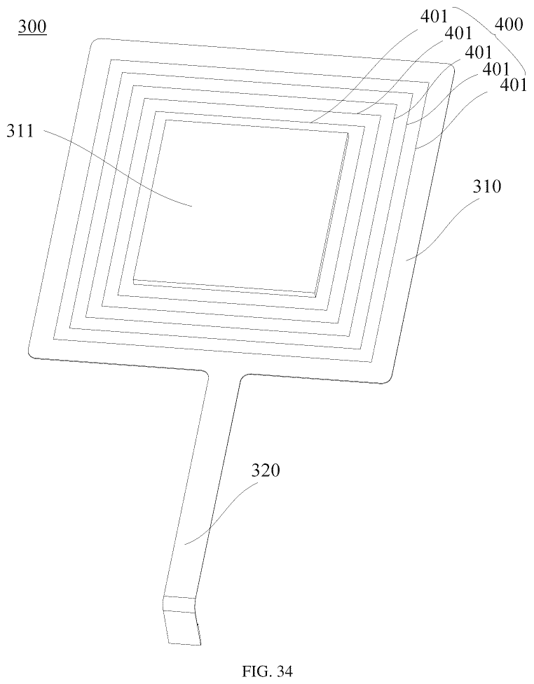

FIG. 34 is a structural schematic view of a flexible circuit board provided by an embodiment of the present application. As shown in FIG. 34, the atomization apparatus also includes an electronic device 311, which is located in the center of the flexible circuit board 300, and the antenna 400 is distributed around the electronic device 311.

The area of the flexible circuit board 300 is relatively large. Arranging only the antenna 400 may not fully utilize the area of the flexible circuit board 300. By arranging the electronic device 311 on the flexible circuit board 300, the space of the flexible circuit board 300 is further utilized. The strength of the signal radiated and the strength of the signal receiving capability of the antenna 400 are both directly proportional to the area enclosed by the antenna 400. The electronic device 311 is placed in the center of the flexible circuit board 300, and the antenna 400 is arranged in the edge area of the flexible circuit board 300. The antenna 400 is arranged around the electronic device 311, which enables the antenna 400 to enclose a larger area. This is conducive to improving the signal radiation and signal reception capabilities of the antenna 400 and further enhancing the communication quality.

As shown in FIG. 34, antenna 400 includes multiple polygonal patterns 401, the multiple polygonal patterns 401 are arranged around the electronic device 311.

As an example, the polygonal pattern 401 can be a rectangular pattern.

The polygonal pattern 401 can be a metal pattern etched on the flexible circuit board 300. Multiple polygonal patterns 401 are arranged around the electronic device 311, and these multiple polygonal patterns 401 together form the antenna 400, which can enhance the signal radiation capability and signal reception capability of the antenna 400.

By adjusting the number of polygonal patterns 401, the signal radiation capacity and signal reception capacity of antenna 400 can be adjusted, enabling the antenna 400 to meet the communication requirements of the corresponding atomization apparatus. As an example, the antenna 400 can include five polygonal patterns 401.

In some examples, multiple polygonal patterns 401 can be homothetic figures.

In some examples, the electronic device 311 includes at least one of a Bluetooth chip or a near-field communication chip, and the antenna 400 is connected to the electronic device 311.

For example, the Bluetooth chip is connected to the antenna 400 to form a Bluetooth antenna module, thereby achieving the Bluetooth communication function.

For example, the near-field communication chip is connected to the antenna 400 to form a near-field communication antenna module, thereby achieving the near-field communication function.

The specific structure included in the electronic device 311 can be set according to the communication mode to be realized, and which is not limited to the embodiments of the present application.

As shown in FIG. 31, the housing 100 includes a first shell 110 and a second shell 120 that are interlocked. For example, the first shell 110 and the second shell 120 can be detachably connected in a snap-fit manner. The liquid reservoir 200 and the flexible circuit board 300 are located in the first shell 110. The first shell 110 is provided with an avoidance opening of 110a, and at least a part of the flexible circuit board 300 is located within the avoidance opening 110a. At least a part of the second shell 120 is located at the avoidance opening 110a.

The housing 100 is arranged as the first shell 110 and the second shell 120 that can interlock with each other can facilitate the assembly of the atomization apparatus. By setting the avoidance opening 110a on the first shell 110, at least a part of the flexible circuit board 300 is arranged at the avoidance opening 110a, so that the distance between the antenna 400 and the outer surface of the housing 100 is relatively closer, which is conducive to reducing the influence of the housing 100 on the signal radiation capability and signal receiving capability of the antenna 400.

For example, both the first shell 110 and the second shell 120 can be non-metallic members. The use of non-metallic members can further reduce the impact on the antenna 400.

As an example, a side of the housing 100 at least located on a first side wall 211 of the liquid reservoir 200 is a non-metallic structure. A side of the housing 100 located on the first side wall 211 of the liquid reservoir 200 is directly opposite the flexible circuit board 300 and is relatively close, which has the greatest impact on the antenna 400, and the part is set as a non-metallic structure, while the other parts have a slightly smaller impact on the antenna 400, and some metal structures can be set according to specific needs to meet the corresponding design requirements.

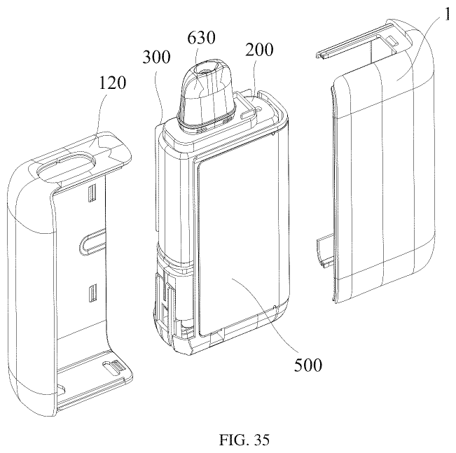

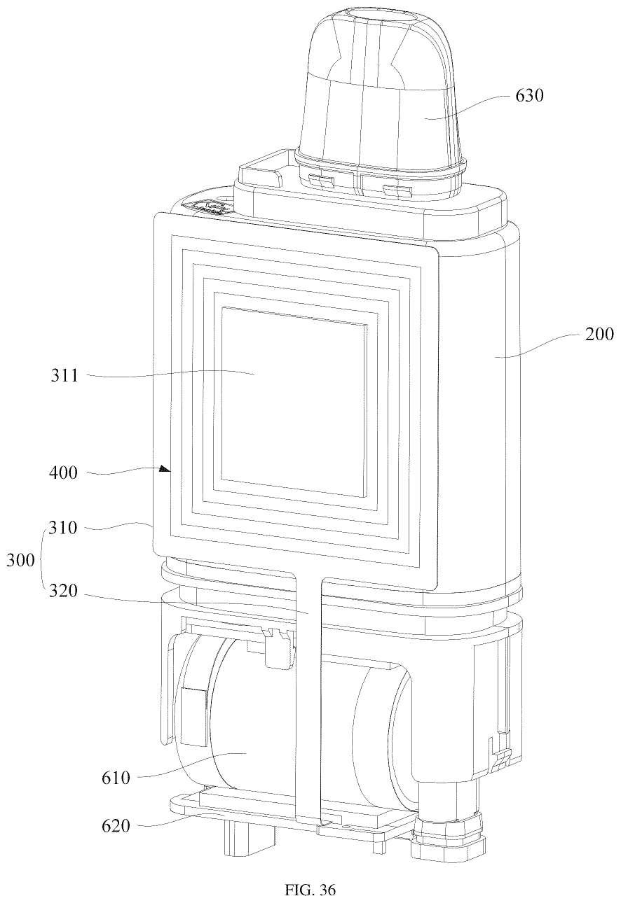

FIG. 35 is an exploded schematic view of an atomization apparatus provided in an embodiment of the present application. As shown in FIG. 35, the atomization apparatus also includes a display panel 500, which is located on the side of the liquid reservoir 200 away from the flexible circuit board 300. The display panel 500 is located between the liquid reservoir 200 and the first shell 110, which is a transparent structural component.

By arranging the display panel 500 to show some information, such as showing time, heating temperature, and the remaining amount of aerosol matrix in the liquid reservoir 200, the functions of the atomization apparatus are further enriched. Since the first housing 100 is a transparent structural component, it will not affect the display of the display panel 500. The display panel 500 is arranged on the side of the liquid reservoir 200 away from the flexible circuit board 300, so that the display panel 500 is relatively far from the flexible circuit board 300, which is conducive to reducing the mutual influence between the display panel 500 and the flexible circuit board 300. It is conducive to improving the display effect of the display panel 500, the signal radiation capacity and signal reception capacity of the antenna 400, and preventing the interference to the signal of the antenna 400.

FIG. 36 is a schematic view of the internal structure of an atomization apparatus provided in an embodiment of the present application. At least housing 100 is omitted in FIG. 36. As shown in FIG. 36, the atomization apparatus also includes a power supply assembly 610 and a printed circuit board 620. The power supply assembly 610 is located at the bottom of the liquid reservoir 200, and the printed circuit board 620 is on a side of the power supply assembly 610 away from the liquid reservoir 200. The flexible circuit board 300 is connected to the printed circuit board 620.

The power supply assembly 610 is used to supply electrical energy for the operation of the atomization apparatus. For example, the power supply assembly 610 may include a battery.

The atomization apparatus also includes a nozzle 630, which is connected to the liquid reservoir 200. The top of the liquid reservoir 200 is connected to the nozzle 630, which means that the power supply assembly 610 and the nozzle 630 are located on opposite sides of the liquid reservoir 200.

In this example, by placing the power supply assembly 610 at the bottom of the liquid reservoir 200 and the printed circuit board 620 on the side of the power supply assembly 610 away from the liquid reservoir 200, it is beneficial to increase the distance between the printed circuit board 620 and the flexible circuit board 300, thereby reducing the interference caused by the printed circuit board 620 to the antenna 400. It is conducive to enhancing the signal radiation capacity and signal reception capacity of antenna 400, and further improving the communication quality.

As shown in FIG. 36, the flexible circuit board 300 consists of the main body portion 310 and the connection portion 320. The antenna 400 is located on the main body portion 310, and the main body portion 310 is on a side of the power supply assembly 610 away from the printed circuit board 620. The connection portion 320 connects the main body portion 310 and the printed circuit board 620.

The main body portion 310 provides a relatively large area for arranging the antenna 400 and the electronic device 311. The connection portion 320 connects the main body portion 310 and the printed circuit board 620, which enables the antenna 400 to be at a greater distance from the printed circuit board 620, facilitating the reduction of interference from the printed circuit board 620 to the antenna 400.

In some examples, the orthographic projection of the main body portion 310 on the outer surface of the liquid reservoir 200 can be located within the outer surface of the liquid reservoir 200 to utilize the liquid reservoir 200 to provide better support for the main body portion 310.

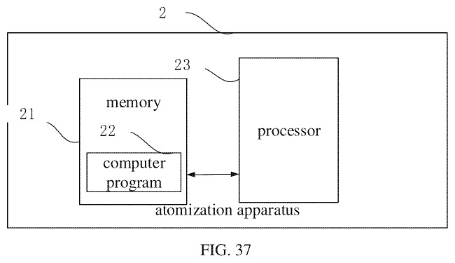

The embodiment of the present application also provides an atomization apparatus, as shown in FIG. 37, the atomization apparatus 2 includes: at least one processor 23, a memory 21, and a computer program 22 stored in the memory 21 and capable of running on at least one processor 23, when the processor 23 executes the computer program, the processor 23 implements the steps of any of the above method embodiments, or when the processor 23 executes the computer program, the processor 23 implements the functions of each module/unit of the above device embodiments.

For example, a computer program can be divided into one or more modules/units, one or more modules/units are stored in memory and executed by a processor to complete the present application. One or more modules/units can be a series of computer program instruction segments capable of performing specific functions, which are used to describe the execution process of the computer program in the atomization apparatus.

It can be understood by those skilled in the art that FIG. 37 is merely an example of an atomization apparatus and does not constitute a limitation on the atomization apparatus. It may include more or fewer components than shown in the figure, or combine certain components, or different components. For example, an atomization apparatus may also include input/output devices, network access devices, buses, etc.

The above-mentioned Processor can be CPU (Central Processing Unit), and can also be other general purpose processor, DSP (Digital Signal Processor), ASIC (Application Specific Integrated Circuit), FGPA (Field-Programmable Gate Array), or some other programmable logic devices, discrete gate or transistor logic device, discrete hardware component, etc. The general purpose processor can be a microprocessor, or alternatively, the processor can also be any conventional processor and so on.

The memory can be the internal storage unit of the atomization apparatus, such as the hard disk or memory of the atomization apparatus. The memory can also be the external storage device of the atomization apparatus, such as the plug-in hard disk equipped on the atomization apparatus, Smart Media Card (SMC), Secure Digital (SD) Card, Flash Card, etc. Furthermore, the memory can also include both the internal storage unit of the atomization apparatus and the external storage device.

It can be realized by those skilled in the art that, in combination with the units and algorithmic steps of each example described in the embodiments disclosed herein, they can be achieved through electronic hardware or a combination of computer software and electronic hardware. Whether these functions are executed in hardware or software depends on the specific application and design constraints of the technical solution. Those skilled in the art may use different methods for each specific application to achieve the described function, but such implementation should not be regarded as beyond the scope of the present application.

In the embodiments provided by the present application, it should be understood that the disclosed device/apparatus and method can be realized by other means. For example, the device/apparatus embodiments described above are merely illustrative. For example, the division of modules or units is only a logical functional division. In actual implementation, there can be other division methods, such as multiple units or components can be combined or integrated into another system, or some features can be ignored or not executed. Another point is that the coupling or direct coupling or communication connection between each other shown or discussed can be indirect coupling or communication connection through some interfaces, devices or units, and can be in the form of electrical, mechanical or others.

The units described as separate components may or may not be physically separated, and the components displayed as units may or may not be physical units, that is, they can be located in one place or distributed across multiple network units. The purpose of this embodiment scheme can be achieved by selecting some or all of the units according to actual needs.

The above embodiments are only used to illustrate the technical solution of the present application and not to limit the present application. Although the present application has been described in detail with reference to the aforementioned embodiments, it should be understood by those skilled in the art that it is still possible to modify the technical solutions recorded in the aforementioned embodiments or to make equivalent substitutions to some of the technical features. These modifications or substitutions do not deviate the essence of the corresponding technical solutions from the spirit and scope of the technical solutions of each embodiment of the present application, and should all be included within the protection scope of the present application.

What is claimed is:

1. A method for data transmission, applied to a first control module in a first atomization apparatus, wherein the first control module is connected to a first short-range wireless communication module, and the method for data transmission comprises:
detecting whether a second atomization apparatus exists within a preset distance range through the first short-range wireless communication module; and
if the second atomization apparatus is existed within the preset distance range, performing data communication with the second atomization apparatus through the first short-range wireless communication module.

2. The method for data transmission according to claim 1, wherein the first control module comprises a dormant state and an activated state, when the first control module is in the dormant state, after if the second atomization apparatus is existed within the preset distance range, the method further comprises:
receiving a wake-up signal output by the first short-range wireless communication module and switching from the dormant state to the activated state; and
wherein the first control module being in the dormant state comprises:
the first control module entering the dormant state when the first control module does not receive data sent by the first short-range wireless communication module within a preset time period.

3. The method for data transmission according to claim 1, wherein the step of detecting whether the second atomization apparatus exists within the preset distance range through the first short-range wireless communication module comprises:
periodically sending a first card-seeking signal through the first short-range wireless communication module;
determining that the second atomization apparatus exists within the preset distance range when a response signal or a second card-seeking signal sent by the second atomization apparatus is received; and
determining that the second atomization apparatus does not exist within the preset distance range when the response signal or the second card-seeking signal sent by the second atomization apparatus is not received.

4. The method for data transmission according to claim 1, wherein the step of performing the data communication with the second atomization apparatus through the first short-range wireless communication module comprises:
sending first data to the first short-range wireless communication module, causing the first short-range wireless communication module to encode the first data to obtain a first data packet frame and send the first data packet frame to the second atomization apparatus.

5. The method for data transmission according to claim 4, wherein the atomization apparatus further comprises an user interaction module, and the step of sending the first data to the first short-range wireless communication module comprises:
receiving control information output by the user interaction module and sending a first control instruction to the first short-range wireless communication module.

6. The method for data transmission according to claim 4, wherein the step of causing the first short-range wireless communication module to encode the first data to obtain the first data packet frame comprises:
causing the first short-range wireless communication module to encode the first data based on a modulation type and an encoding type to obtain the first data packet frame; and
wherein the first data packet frame comprises a first frame start segment, a first data segment, and a first frame end segment, and the step of causing the first short-range wireless communication module to encode the first data based on the modulation type and the encoding type to obtain the first data packet frame comprises:
causing the first short-range wireless communication module to set the first frame start segment based on the modulation type and the encoding type, to encode the first data according to the modulation type and the encoding type to obtain the first data segment, and to set the first frame end segment according to an encoding violation.

7. The method for data transmission according to claim 4, wherein after sending the first data to the first short-range wireless communication module, the method further comprises:
determining that the first short-range wireless communication module has successfully received the data when a response message sent by the first short-range wireless communication module is received; and
determining that the first short-range wireless communication module has not successfully received the data when a communication timeout message sent by the first short-range wireless communication module is received.

8. The method for data transmission according to claim 1, wherein the step of performing the data communication with the second atomization apparatus through the first short-range wireless communication module further comprises:
decoding a second data packet frame through the first short-range wireless communication module to obtain second data when the first short-range wireless communication module receives the second data packet frame sent by the second atomization apparatus; and
wherein the second data packet frame comprises a second frame start segment, a second data segment, and a second frame end segment, and the step of decoding the second data packet frame through the first short-range wireless communication module to obtain the second data comprises:
causing the first short-range wireless communication module to obtain a modulation type and an encoding type based on the second frame start segment, to decode the second data segment based on the modulation type and the encoding type to obtain the second data, and to stop decoding based on the second frame end segment.

9. The method for data transmission according to claim 8, wherein after decoding the second data segment based on the modulation type and the encoding type to obtain the second data, the method further comprises:
executing a second control instruction when the second data comprises the second control instruction.

10. The method for data transmission according to claim 1, wherein the step of performing the data communication with the second atomization apparatus through the first short-range wireless communication module further comprises:
performing a paired connection with the second atomization apparatus through the first short-range wireless communication module, performing data transmission with the second atomization apparatus, and synchronously displaying data with the second atomization apparatus.

11. The method for data transmission according to claim 10, wherein the step of performing the paired connection with the second atomization apparatus through the first short-range wireless communication module comprises:
receiving a field signal sent by the second atomization apparatus through the first short-range wireless communication module;
receiving an activation signal sent by the first short-range wireless communication module;
controlling the first atomization apparatus to enter an activated state from a dormant state based on the activation signal; and
sending, in a case where the first atomization apparatus is in the activated state, a response signal to the second atomization apparatus through the first short-range wireless communication module, wherein the response signal is configured to indicate establishing a communication connection between the first atomization apparatus and the second atomization apparatus.

12. The method for data transmission according to claim 11, wherein the first control module is connected to a first display module; and the step of performing data transmission with the second atomization apparatus and the synchronously displaying the data with the second atomization apparatus comprises:
receiving second data sent by the second atomization apparatus through the first short-range wireless communication module; synchronously displaying the second data with the second atomization apparatus through the first display module.

13. The method for data transmission according to claim 12, wherein the step of synchronously displaying the second data with the second atomization apparatus through the first display module comprises:
comparing a timestamp in the second data with a second local timestamp, and updating displayed data to cause display data of the second atomization apparatus to be consistent with that of the first atomization apparatus when the timestamp in the second data is later than the second local timestamp; wherein the second local timestamp corresponds to a time of a current display content on the first atomization apparatus.

14. The method for data transmission according to claim 10, wherein the first control module is connected to a first display module, and the second atomization apparatus comprises a second control module, a second short-range wireless communication module, and a second display module; the step of performing the data transmission with the second atomization apparatus and synchronously displaying data with the second atomization apparatus comprises:
displaying third data through the first display module while simultaneously displaying fourth data sent from the second atomization apparatus; and sending the third data to the second short-range wireless communication module through the first short-range wireless communication module, causing the second control module to simultaneously display both the third data and the fourth data through the second display module.

15. The method for data transmission according to claim 14, wherein the step of simultaneously displaying the fourth data sent from the second atomization apparatus comprises:
comparing a timestamp in the fourth data with a second local timestamp, and updating a display data to cause the display data of the first atomization apparatus to be consistent with that of the second atomization apparatus when the timestamp in the fourth data is later than the second local timestamp; wherein the second local timestamp corresponds to a time of a current display content of the first atomization apparatus; and
wherein the step of causing the second control module to simultaneously display the third data and the fourth data through the second display module comprises:
displaying, through the second control module, the fourth data through the second display module, and comparing a timestamp in the third data with a first local timestamp, updating display data to cause display data of the second atomization apparatus to be consistent with that of the first atomization apparatus when the timestamp in the third data is later than the first local timestamp; wherein the first local timestamp corresponds to a time of a current display content of the second atomization apparatus.

16. The method for data transmission according to claim 10, wherein the step of simultaneously displaying the data with the second atomization apparatus comprises:
synchronously displaying flavor parameters, power level information, and usage records with the second atomization apparatus, wherein the flavor parameters refer to a type of atomization liquid currently used, a flavor name, a concentration level, or output power configuration of both the first atomization apparatus and the second atomization apparatus, the power level information refer to the current power level states of both the first atomization apparatus and the second atomization apparatus, and the usage records refer to data related to usage behaviors of both the first atomization apparatus and the second atomization apparatus; and
synchronously displaying animation effects with the second atomization apparatus.

17. The method for data transmission according to claim 1, wherein the method further comprises:
obtaining an interaction signal output by other electronic apparatuses after establishing a near-field sensing connection between the first atomization apparatus and any one of the other electronic apparatuses;
parsing the interaction signal to obtain interaction instruction information;
performing a logical judgment based on a local apparatus information of the first atomization apparatus and the interaction instruction information to obtain interaction operation information, wherein the interaction operation information comprises at least one selected from a group consisting of an interaction scene, an interaction mode, an interaction state, an interaction duration, and an interaction prompt; and
displaying the interaction operation information in a dynamic effect image style on a human-machine interface of the first atomization apparatus.

18. The method for data transmission according to claim 17, wherein the method further comprises:
detecting a sensing distance value between the first atomization apparatus and any one of the other electronic apparatuses, wherein both the first atomization apparatus and the other electronic apparatuses are provided with a near-field communication module and an antenna used in conjunction with the near-field communication module; and
establishing the near-field sensing connection between the first atomization apparatus and the other electronic apparatuses in response to detecting that the sensing distance value is less than a preset distance threshold.

19. The method for data transmission according to claim 17, wherein the step of parsing the interaction signal to obtain interaction instruction information comprises:
obtaining data content carried in the interaction signal, wherein the data content comprises: a header identifier, instruction content, and a verification portion; and
parsing the data content according to a preset interaction protocol and a preset encoding rule to obtain the interaction instruction information, wherein the preset interaction protocol specifies an encoding method for header identifiers corresponding to different types of interaction signals, and the preset encoding rule specifies specific encoding formats for each parameter in the instruction content.

20. The method for data transmission according to claim 17, wherein the method further comprises obtaining local apparatus information of the first atomization apparatus through at least one of followings:
obtaining a current power level value of the first atomization apparatus through a power level sensor of the first atomization apparatus;
obtaining a current atomization parameter of the first atomization apparatus through a storage configuration module of the first atomization apparatus, wherein the current atomization parameter comprises at least one of followings: an atomization concentration, an atomization flavor, and an atomization duration; and
obtaining a current operation state of the first atomization apparatus through a state monitoring module of the first atomization apparatus, wherein the current operation state comprises at least one of followings: a normal operation state, an abnormal operation state, and a firmware upgrade in progress.

21. The method for data transmission according to claim 17, wherein the step of performing the logical judgment based on the local apparatus information of the first atomization apparatus and the interaction instruction information to obtain the interaction operation information comprises:
obtaining a logical judgment rule corresponding to the interaction instruction information, wherein the logical judgment rule is preset based on an application scene and an interaction function of the first atomization apparatus;
performing a logical judgment on the local apparatus information and the interaction instruction information according to the logical judgment rule to obtain interaction operation content and an interaction operation sequence; and
obtaining the interaction operation information based on the interaction operation content and the interaction operation sequence.

22. The method for data transmission according to claim 17, wherein the step of obtaining the interaction signal output by the other electronic apparatuses comprises:
obtaining the interaction signal output by the other electronic apparatuses through a signal receiving circuit connected to the near-field communication module in the first atomization apparatus according to a preset signal receiving frequency and bandwidth.

23. The method for data transmission according to claim 18, wherein the step of detecting the sensing distance value between the first atomization apparatus and any one of the other electronic apparatuses comprises:
if the sensing distance fluctuation value between the first atomization apparatus and any one of the other electronic apparatuses is detected to exceed a preset fluctuation threshold multiple consecutive times, then suspending distance detection and performing a self-checking and a signal calibration on the near-field communication module; and
after the self-checking and the signal calibration on the near-field communication module is performed, restarting the distance detection until the sensing distance value is obtained.

24. The method for data transmission according to claim 1, wherein the step of detecting whether the second atomization apparatus exists within the preset distance range through the first short-range wireless communication module comprises:
when the first short-range wireless communication module is in an active mode, controlling the first short-range wireless communication module to transmit an electromagnetic field signal at a preset cycle to detect whether the second atomization apparatus is existed; and
when the first short-range wireless communication module is in a passive mode, controlling the first short-range wireless communication module to stop transmitting the electromagnetic field signal and to enter a monitoring state, and wherein the first short-range wireless communication module is activated when the electromagnetic field signal is detected.

25. A device for data transmission, wherein the device for data transmission comprises a first control module and a first short-range wireless communication module;
the first control module detects whether a second atomization apparatus exists within a preset distance range through the first short-range wireless communication module;
if the first short-range wireless communication module determines that the second atomization apparatus exists within the preset distance range, the first control module is paired and connected to the second atomization apparatus through the first short-range wireless communication module, conducts data transmission with the second atomization apparatus, and synchronously displays the data with the second atomization apparatus.

26. The device for data transmission according to claim 25, wherein when a second atomization apparatus exists within the preset distance, the first control module is paired and connected with the second atomization apparatus through the first short-range wireless communication module, conducts the data transmission with the second atomization apparatus, and synchronously displays the data with the second atomization apparatus.

27. The device for data transmission according to claim 25, wherein the device further comprises:
a short-range wireless communication antenna, configured for receiving and transmitting an electromagnetic field signal;
wherein the first short-range wireless communication module is connected to the short-range wireless communication antenna for exchanging data with the second atomization apparatus through the short-range wireless communication antenna;
the first control module is configured for controlling the first short-range wireless communication module to switch between an active mode and a passive mode;
when the first control module controls the short-range wireless communication module to be in the active mode, the first control module controls the short-range wireless communication module to transmit the electromagnetic field signal at a preset cycle to detect whether a target atomization apparatus is existed;
when the first control module controls the short-range wireless communication module to be in the passive mode, the first control module controls the short-range wireless communication module to stop transmitting the electromagnetic field signal and enter a monitoring state, and activate the first control module when the electromagnetic field signal is detected.

28. The device for data transmission according to claim 27, wherein the first control module is configured to set the first short-range wireless communication module to be in the passive mode when a first preset trigger condition is satisfied, wherein the first preset trigger condition comprises:
detecting that communication with the second atomization apparatus is completed;
the electromagnetic field signal is not detected within a preset time period; and
the atomization apparatus is in an idle state, or a power level of the atomization apparatus falls below a preset threshold.

29. The device for data transmission according to claim 27, wherein the first control module is configured to set the first short-range wireless communication module to be in the active mode when a second preset trigger condition is satisfied; wherein the second preset trigger condition comprises: an user inhalation, a button operation, a scheduled wake-up event, or initiation of broadcasting is detected.

30. The device for data transmission according to claim 27, wherein when the first short-range wireless communication module is in the active mode, if the first control module detects a response signal from the second atomization apparatus, the first control module controls the first short-range wireless communication module to enter a data exchange state; and
wherein when the first short-range wireless communication module is in the passive mode and is activated, the first short-range wireless communication module outputs a wake-up signal to the first control module.

31. The device for data transmission according to claim 27, wherein the short-range wireless communication antenna comprises an induction coil, a first capacitor, and a second capacitor; a first terminal of the induction coil is connected to a first terminal of the first capacitor, a second terminal of the first capacitor is grounded, a second terminal of the induction coil is connected to a first terminal of the second capacitor, and a second terminal of the second capacitor is grounded.

32. The device for data transmission according to claim 31, wherein the induction coil comprises a multi-turn rectangular coil, wherein a wire width of each turn of the rectangular coil is consistent, a spacing between adjacent coils of the rectangular coil is consistent, and a corner of the rectangular coil employs an arc transition structure.

33. An atomization apparatus, comprising the device for data transmission according to claim 27, wherein the atomization apparatus further comprises a first display module; the first display module is in communication with the first control module and is configured to display state information provided by the first control module;
wherein the state information comprises at least one of a power level of the atomization apparatus, an atomization mode, a short-range wireless communication state, a data exchange state, or target atomization apparatus information.

34. The atomization apparatus according to claim 33, wherein the atomization apparatus further comprises a silicon microphone detection circuit, the silicon microphone detection circuit comprises a silicon microphone and a signal processing chip, the silicon microphone is connected to the signal processing chip, and the signal processing chip is connected to the control module;
the silicon microphone is configured to sense air pressure changes caused by user inhalation, the signal processing chip is configured to convert the air pressure changes into a capacitance variation signal and outputs a detection signal to the first control module, and the first control module is configured to activate the first display module and enables the first short-range wireless communication module to enter the active mode when the detection signal is detected.

35. An atomization apparatus, comprising the device for data transmission according to claim 27, wherein the atomization apparatus further comprises:
an obtaining module, configured for obtaining an interaction signal output by other electronic apparatuses after establishing a near-field sensing connection between the atomization apparatus and any one of the other electronic apparatuses;
a parsing module, configured for parsing the interaction signal to obtain interaction instruction information;
a logic judgment module, configured for performing a logical judgment based on local apparatus information of the first atomization apparatus and the interaction instruction information to obtain interaction operation information, wherein the interaction operation information comprise at least one of followings: an interaction scene, an interaction mode, an interaction state, an interaction duration, and an interaction prompt; and
a display module, configured for displaying the interaction operation information in a form of a dynamic effect image on a human-machine interaction interface of the atomization apparatus.

36. The atomization apparatus according to claim 35, wherein the atomization apparatus further comprises:
a near-field communication module, configured for detecting a sensing distance value between the atomization apparatus and any one of the other electronic apparatuses; and for establishing a near-field sensing connection between the atomization apparatus and the other electronic apparatuses in response to detecting that the sensing distance value is less than a preset distance threshold; wherein both the atomization apparatus and the other electronic apparatuses are provided with: a near-field communication module and an antenna used in conjunction with the near-field communication module.

37. The atomization apparatus according to claim 35, wherein the atomization apparatus further comprises:
an parsing module, configured for obtaining data content carried in the interaction signal; and for parsing the data content according to a preset interaction protocol and a preset encoding rule to obtain the interaction instruction information, wherein the data content comprises: a header identifier, instruction content, and a verification portion; the preset interaction protocol specifies a encoding method for header identifiers corresponding to different types of interaction signals, and the preset encoding rule specifies specific encoding formats for each parameter in the instruction content.

38. The atomization apparatus according to claim 35, wherein the atomization apparatus further comprises:
a power level sensor, configured for obtaining a current power level value of the atomization apparatus;
a storage configuration module, configured for obtaining a current atomization parameter of the first atomization apparatus, wherein the current atomization parameter comprises at least one of followings: an atomization concentration, an atomization flavor, and an atomization duration; and
a state monitoring module, configured for obtaining a current operation state of the first atomization apparatus, wherein the current operation state comprises at least one of followings: a normal operation state, an abnormal operation state, and a firmware upgrade in progress.

39. The atomization apparatus according to claim 35, wherein the logic judgment module comprises:
an obtaining sub-module, configured for obtaining a logical judgment rule corresponding to the interaction instruction information, wherein the logical judgment rule is preset based on an application scene and an interaction function of the first atomization apparatus;
a judgment sub-module, configured for performing a logical judgment on the local apparatus information and the interaction instruction information according to the logical judgment rule to obtain interaction operation content and an interaction operation sequence; and
a generation sub-module, configured for obtaining the interaction operation information based on the interaction operation content and the interaction operation sequence.

40. The atomization apparatus according to claim 36, wherein the near-field communication module is specifically configured for:
if the sensing distance fluctuation value between the first atomization apparatus and any one of the other electronic apparatuses is detected to exceed a preset fluctuation threshold multiple consecutive times, then suspending distance detection and performing a self-checking and a signal calibration on the near-field communication module; and
after the self-checking and the signal calibration on the near-field communication module is performed, restarting the distance detection until the sensing distance value is obtained.

41. An atomization apparatus, comprising the device for data transmission according to claim 27, and the atomization apparatus further comprises: a housing, a liquid reservoir, a flexible circuit board, and an antenna; the liquid reservoir is located within the housing, a gap is formed between at least one side of the liquid reservoir and an inner wall of the housing; the flexible circuit board is located within the gap and arranged opposite to a surface of the housing, and the antenna is formed on the flexible circuit board.

42. The atomization apparatus according to claim 41, wherein the flexible circuit board is adhered to a surface of the liquid reservoir; and the liquid reservoir comprises a first side wall and two second side walls adjacent to the first side wall, the first side wall and the two second side walls are connected in an arc; and the flexible circuit board is in contact with the first side wall and the two second side walls.

43. The atomization apparatus according to claim 41, further comprising an electronic apparatus located at a center of the flexible circuit board, wherein the antenna is distributed around the electronic apparatus; the electronic apparatus comprises at least one of a Bluetooth chip and a near-field communication chip; and the antenna is connected to the electronic apparatus; the antenna comprises a plurality of polygonal patterns, and the plurality of polygonal patterns are all arranged around the electronic apparatus.

44. The atomization apparatus according to claim 41, wherein the housing comprises a first shell and a second shell that interlock with each other, the liquid reservoir and the flexible circuit board are located within the first shell, the first shell is provided with an avoidance opening, at least a part of the flexible circuit board is located within the avoidance opening, and at least a part of the second shell is located at the avoidance opening.

45. The atomization apparatus according to claim 44, further comprising a display panel, wherein the display panel is located on a side of the liquid reservoir away from the flexible circuit board and located between the liquid reservoir and the first shell, and the first shell is a transparent structural component.

46. The atomization apparatus according to claim 41, further comprising a power supply assembly and a printed circuit board, wherein the power supply assembly is located at a bottom of the liquid reservoir, the printed circuit board is located on a side of the power supply assembly away from the liquid reservoir, and the flexible circuit board is connected to the printed circuit board.

47. The atomization apparatus according to claim 46, wherein the flexible circuit board comprises a main body portion and a connecting portion, the antenna is located on the main body portion, the main body portion is located on a side of the power supply assembly away from the printed circuit board, and the connecting portion connects the main body portion to the printed circuit board.

48. An atomization apparatus, comprising: at least one processor, a memory, and a computer program stored in the memory and operable on the at least one processor, wherein the processor performs the computer program to implement the method as claimed in claim 1.
